(19) United States
(12) Patent Application Publication
(10) Pub. No.: US 2014/0055583 A1
(43) Pub. Date: Feb. 27, 2014

(54) ENDOSCOPE SYSTEM

(71) Applicant: OLYMPUS CORPORATION, (US)

(72) Inventor: Shuichi Kato, Tokyo (JP)

(73) Assignee: OLYMPUS CORPORATION, Tokyo (JP)

(21) Appl. No.: 13/768,632

(22) Filed: Feb. 15, 2013

(30) Foreign Application Priority Data
Feb. 16, 2012 (JP) 2012-031948
Feb. 5, 2013 (JP) 2013-020654

(51) Int. Cl. H04N 7/01; H04N 7/18

(52) U.S. Cl. CPC H04N 7/01; H04N 7/183
USPC 348/65; 341/166; 341/137

(57) ABSTRACT

An endoscope system may include: an insertion section that is inserted into an object under examination, having an image capturing unit that successively outputs a pixel signal of a strength responsive to the amount of light of the pixel, and a time converter that converts the intensity of the pixel signal to time information representing a time interval by a time width and that transmits the converted time information; a transfer section that guides the outside of the object under examination the time information transmitted from the time converter; and an external apparatus positioned outside the object under examination, having a time interval converter that receives the time information guided by the transfer section and converts to a digital signal and outputs the intensity of the pixel signal represented by the received time information and an image processing unit that outputs an image responsive to the pixel signal.

### BACKGROUND OF THE INVENTION

1. Field of the Invention

The present invention relates to an endoscope system that is used by inserting it into an object under examination. More specifically, the present invention relates to an endoscope system that observes the inside of the object under examination by converting images captured within an object under examination to electrical signals, transmitting the images to outside the object under examination, and displaying them on a monitor. Additionally, the present invention relates to an A/D converter that converts an analog signal into time information that is a time width to convert this time information to a digital signal.

Priority is claimed on Japanese Patent Application No. 2012-031948, filed Feb. 16, 2012, and Japanese Patent Application No. 2013-020654, filed Feb. 5, 2013, the contents of which are incorporated herein by reference.

2. Description of the Related Art

All patents, patent applications, patent publications, scientific articles, and the like, which will hereinafter be cited or identified in the present application, will hereby be incorporated by reference in their entirety in order to describe more fully the state of the art to which the present invention pertains.

In a conventional endoscope system, the approach generally adopted is one in which pixel signals from image capturing elements at the distal end of an endoscope are transmitted as analog signal to a video processor of the main unit of the endoscope system. In this case, in a general endoscope, the overall length involved is several meters. For this reason, the analog pixel signals that are transferred to the video processor are influenced during transfer by external noise, and the S/N ratio (signal-to-noise ratio) may deteriorate. When the S/N ratio deteriorates, the image quality displayed by the endoscope system also deteriorates. In particular, in the case of using an endoscope system in medical treatment facilities or the like, because of the operation of equipment such as an electrocautery apparatus, noise is present at a level not existing in the normal environment, and the influence of this noise is great.

Japanese Unexamined Patent Application, First Publication No. S61-121590 discloses art for transferring pixel signals. With the art disclosed in Japanese Unexamined Patent Application, First Publication No. S61-121590, pixel signals from image capturing elements are A/D (analog/digital) converted at the distal end of the endoscope, and the pixel signals after A/D conversion are transferred within the endoscope as digital signals. Even under the influence of noise, because disturbance of the video does not occur as long as it is possible to distinguish between the high level and the low level of the converted digital pixel signals, the noise immunity can be improved.

In recent years, with the advent of improved-definition image capturing elements, there is a trend toward increasing amounts of pixel signal data, and increased transfer rates are required when transferring digitized pixel signals. For this reason, there arises the need to make the amplitude of the pixel signals converted to digital signals smaller, making it difficult even with digitalization to obtain the effect of achieving noise immunity as in the past.

Japanese Unexamined Patent Application, First Publication No. 2007-260066 discloses art for transferring pixel signals. With the art disclosed by Japanese Unexamined Patent Application, First Publication No. 2007-260066, after A/D conversion, the pixel signals are converted to optical signals (E/O converted by electrical/optical conversion) at the distal end of the endoscope, and the pixel signals after E/O conversion are transferred by an optical fiber.

In an endoscope system, the distal end of the endoscope is inserted into the object under examination. When this is done, if the electrical power consumption at the distal end of the endoscope is large, a large amount of heat is generated, and there is the possibility of damaging the object under examination. For this reason, it is important in an endoscope system to limit the electrical power consumption at the distal end of the endoscope, and reduce the amount of heat generated.

As disclosed in Japanese Unexamined Patent Application, First Publication No. S61-121590 and Japanese Unexamined Patent Application, First Publication No. 2007-260066, an endoscope that A/D converts analog pixel signals at the distal end has an A/D conversion unit provided at the distal end of the endoscope, at which there is a large amount of power consumed. For this reason, in the endoscope systems disclosed in Japanese Unexamined Patent Application, First Publication No. S61-121590 and Japanese Unexamined Patent Application, First Publication No. 2007-260066, the amount of heat generated at the distal end of the scope becomes large.

Additionally, because pixel signals are transferred by a slender cord, it is necessary in the endoscope to use the method of converting (serializing) the signals on a large number of channels obtained from the A/D conversion to signals on a small number of channels, so as to reduce the number of signal lines in the cord. The signal processing for this serialization also consumes a large amount of electrical power, and increases the generated heat.

Thus, in a conventional endoscope system, there are many factors that increase the amount of power consumed at the distal end of the endoscope. That is, there exist a large number of factors that increase the heat generated at the distal end of the endoscope.

### SUMMARY

The present invention provides an endoscope system that enables transfer of pixel signals without sacrificing the effect of noise immunity, and enables reduction of the electrical power consumption at the distal end of the endoscope.

An endoscope system may include: an insertion section that is inserted into an object under examination, having an image capturing unit that successively outputs a pixel signal of a strength responsive to the amount of light of the pixel, and a time converter that converts the intensity of the pixel signal to time information representing a time interval by a time width and that transmits the converted time information; a transfer section that guides the outside of the object under examination the time information transmitted from the time converter; and an external apparatus positioned outside the object under examination, having a time interval converter that receives the time information guided by the transfer section and converts to a digital signal and outputs the intensity of the pixel signal represented by the received time information and an image processing unit that outputs an image responsive to the pixel signal that has been converted to the digital signal by the time interval converter.

The insertion section may further include a plurality of sample-and-hold circuits that sample and hold the pixel signals output from the image capturing unit and that output the sampled and holed pixel signals, the time converter may include a plurality of time converters each corresponding to one of the plurality of sample-and-hold circuits, each of the plurality of sample-and-hold circuits may successively repeat the sampling and holding of the pixel signals successively output from the image capturing unit, each of the plurality of time converters may convert to the time information and transmit intensities of the pixel signals sampled and held by the corresponding sample-and-hold circuit, the time interval converter may be constituted by a plurality of time interval converters each corresponding to one of the plurality of time converters, each of the plurality of time interval converters may convert to a digital signal each of the intensities of the pixel signals from the corresponding time information guided by the transfer section corresponding to one of the plurality of time converters, and the image processing unit may output the image based on the pixel signals that are converted to the digital signals by the plurality of time interval converters.

The time converter may convert the intensity of one pixel signal to the plurality of time information represented by different time intervals and transmits the result, the time interval converter may include a time interval converter that converts to the digital signals the plurality of time intervals of the one pixel signal represented by each of the time information guided by the transfer section, and further comprises a selecting device that selects and outputs one digital signal from the converted digital signals related to the time intervals for which conversion succeeded within a signal processing time pre-established by the time interval converter.

The selecting device may select a converted digital signal related to the longest one of the time intervals for which conversion succeeded within the pre-established signal processing time.

The time converter may include an inverter circuit that inverts and outputs an input signal at a time responsive to the intensity of the pixel signal, and the input signal may represent the intensity of the pixel signal as a time interval, based on the time of a pre-established number of inversions by the inverter circuit.

The image processing unit may divide a given signal by the digital signal converted by the time interval converter.

The time converter may include an optical transmitting unit that converts to an optical signal the timing of the start of the time interval and the timing of the end of the time interval included in the time information, the transfer section may include an optical waveguide that transfers the optical signal transmitted by the time converter, and the time interval converter may include an optical-to-electrical converter that converts the optical signal transferred by the transfer section to an electrical signal.

The time interval converter may include: a timing detection unit that detects the timing of the start of the time interval and the timing of the end of the time interval included in the received time information, and outputs a starting signal representing the detected timing of the start of the time interval and an ending signal representing the detected timing of the end of the time interval; a clock output unit that comprises a delay circuit and an oscillator and outputs a plurality of clocks of different phases; a plurality of counting units that count the edges at which a clock output by the clock output unit changes from one state to another state and output the number of counted edges; and an adder circuit that adds the counted numbers output by each of the counting units and outputs the number of the sum resulting from the addition as the digital signal, wherein the clock output unit may start output of a plurality of clocks having different phases when a starting signal representing the timing of the start of the time interval is input, and each of the plurality of counting units may correspond to one of the plurality of clocks having different phases, count the edges of the corresponding clock up until the input of the ending signal representing the timing of the end of the time interval, and output each of the counted numbers.

The oscillator can change the frequency of the clock that is output in response to an input parameter, the time interval converter may further include a parameter adjustment unit that outputs a parameter that controls the frequency of the clock output by the oscillator, and the parameter adjustment unit, by adjusting the parameter, may adjust the frequency of the clock output by the oscillator and adjusts the timing of the edge of the clock that is output by the clock output unit.

The parameter adjustment unit may include: a plurality of second delay circuits that delay and output an input signal and that are connected in series; two second oscillators that correspond to each of the two different second delay circuits of the plurality of second delay circuits, and from the time of the input of a delayed operation starting signal representing the start of operation of the parameter adjustment unit, output a clock having a frequency responsive to the input parameter from the corresponding second delay circuit; a phase comparator circuit that compares the timing of the edges of clocks output by the two second oscillators, and outputs phase comparison information representing a time difference between the timing of the compared edges; and a parameter setting circuit that, based on the phase comparison information, calculates a parameter controlling the frequency of the clocks output by the second oscillators for the purpose of controlling so that the timing of the edges of the clocks output by the two compared second oscillators coincides, and outputs the calculated parameter as a parameter controlling the frequency of the clocks output by the oscillator and second oscillators.

The delay circuit that, in response to an input parameter, can change the delay time by which an input signal is delayed, the time interval converter may further include a parameter adjustment unit that outputs a parameter that controls a delay time when the delay circuit delays and outputs an input signal, and the parameter adjustment unit, by adjusting the parameter, may adjust the delay time when the delay circuit delays and outputs an input signal, adjust the timing of the start of the output of the clock by the oscillator or the timing of the clock that has been output by the oscillator, and adjust the timing of the edge of a clock output by the clock output unit.

The parameter adjustment unit may include: a plurality of second delay circuits that are connected in series and that delay and output an input signal by a delay time responsive to an input parameter; two second oscillators that correspond to each of the two different second delay circuits of the plurality of second delay circuits, and from the time of the input of a delayed operation starting signal representing the start of operation of the parameter adjustment unit, output clocks having the same frequency from the corresponding second delay circuit; a phase comparator circuit that compares the timing of the edges of clocks output by the two second oscillators, and outputs phase comparison information representing a time difference between the timing of the compared edges; and a parameter setting circuit that, based on the phase comparison information, calculates a parameter controlling the delay time of the second delay circuit for the purpose of controlling so that the timing of the edges of the clocks output by the two compared second oscillators coincide, and outputs the calculated parameter as a parameter controlling the delay circuit and the delay time of the second delay circuit.

The plurality of second delay circuits connected in series may include a part of a plurality of delay elements in a ring oscillator constituted by the delay elements connected in a ring configuration.

The delay circuit and the second delay circuits may be buffer circuits in which two inverting (logical negation) circuits having offset threshold voltages are connected in series.

If the buffer circuit is configured with the threshold voltage of the first inverter circuit stage set to be lower than the threshold voltage of the following inverter circuit stage, the power supply voltage of the following inverter circuit stage may be set to be lower than the power supply voltage of the first inverter circuit stage. If the buffer circuit is configured with the threshold voltage of the first inverter circuit stage is to be set to be higher than the power supply voltage of the following inverter circuit stage, the power supply voltage of the first inverter circuit stage may be set to be higher than the power supply voltage of the following inverter circuit stage.

An A/D converter may include: a transmitting unit that has a voltage/time converter converting a magnitude of an analog input signal that has been input to time information representing a time interval by a time width, outputting the results, and transmitting the time information output by the voltage/time converter; a transfer section that guides the time information transmitted from the transmitting unit to a position distanced from the transmitting unit; a receiving unit that receives the time information guided by the transfer section, has a time/digital converter converting to a digital signal and outputting the magnitude of the analog input signal represented by the received time information, and outputs the digital signal output by the time/digital converter; and a signal processing unit that performs a pre-established signal processing with respect to the digital signal output by the receiving unit so as to output as an ultimate digital signal the digital signal on which signal processing has been performed, wherein the voltage/time converter may convert the analog input signal to the time information so that, when taking Vin as the analog input signal and D as the time information to which the analog input signal has been converted, the relationship between the analog input signal Vin and the time information D becomes a first-order rational function relationship represented by the equation:

D=b/(Vin−a)

where a is an arbitrary real number, and b is an arbitrary real number other than 0, and the signal processing unit performs signal processing that divides an arbitrary digital signal other than 0 by the digital signal output by the receiving unit so as to generate a digital signal having a first-order function relationship, and outputs the generated digital signal as the ultimate digital signal.

The voltage/time converter may convert the magnitude of one analog input signal to the plurality of time information represented by different time intervals, the transmitting unit may transmit the plurality of time information converted by the voltage/time converter, the time/digital converter may include a time/digital converter that converts to each of the digital signals the plurality of time intervals of one analog input signal represented by the corresponding time information guided by the transmitting unit, and the receiving unit may select and output, from among the plurality of time information, one converted digital signal related to the time information for which the conversion has been completed within a signal processing time pre-established by the time/digital converter.

The receiving unit may select, among from the time information for which the conversion has been completed within the pre-established signal processing time, a converted digital signal related to the time information representing the longest time interval.

The voltage/time converter may include an inverter circuit that inverts and outputs an input signal at a time responsive to the magnitude of the analog input signal, and the input signal may represent the magnitude of the analog input signal as a time interval, based on the time of a pre-established number of inversions by the inverter circuit.

The transfer section may include an optical waveguide that transfers the optical signal transmitted by the transmitting unit, the transmitting unit may convert time information that is an electrical signal and transmits the optical signal, and the receiving unit may receive the optical signal transferred by the transfer section and converts the received optical signal to the time information that is an electrical signal once again.

The present invention provides an endoscope system that enables transfer of pixel signals without sacrificing the effect of noise immunity, and enables reduction of the electrical power consumption at the distal end of the endoscope.

### BRIEF DESCRIPTION OF THE DRAWINGS

The above features and advantages of the present invention will be more apparent from the following description of certain preferred embodiments taken in conjunction with the accompanying drawings, in which:

FIG. 1 is a drawing showing the constitution of an endoscope system in accordance with the first preferred embodiment of the present invention;

FIG. 2 is a block diagram showing an example of the general constitution of the constituent elements of the endoscope system in accordance with the first preferred embodiment of the present invention;

FIG. 3 is a timing diagram showing the relationship between the various signals in the endoscope system in accordance with the first preferred embodiment of the present invention;

FIG. 4 is a circuit diagram showing an example of the general constitution of the time converter provided in the endoscope system in accordance with the first preferred embodiment of the present invention;

FIG. 5 is a timing diagram showing the method of generating an optical pulse signal in the endoscope in accordance with the first preferred embodiment of the present invention;

FIG. 6 is a circuit diagram showing an example of the constitution of an inverter circuit provided in the time converter of the endoscope system in accordance with the first preferred embodiment of the present invention;

FIG. 7 is a drawing showing the relationship between the pixel signal and the converted time in the endoscope system in accordance with the first preferred embodiment of the present invention;

FIG. 8 is a drawing showing the relationship between the pixel signal after the transmitted signal is processed and the converted time in the endoscope system in accordance with the first preferred embodiment of the present invention;

FIG. 9 is a block diagram showing an example of the general constitution of the time converter provided in the endoscope system in accordance with the first preferred embodiment of the present invention;

FIG. 10 is a timing diagram showing the relationship between the clocks in the time interval converter provided in the endoscope system in accordance with the first preferred embodiment of the present invention;

FIG. 11 is a circuit diagram showing an example of the general constitution of the oscillator in the time interval converter provide in the endoscope system in accordance with the first preferred embodiment of the present invention;

FIG. 12 is a circuit diagram showing an example of the constitution of a delay circuit provided in the time interval converter of the endoscope system in accordance with the first preferred embodiment of the present invention;

FIG. 13 is a block diagram showing an example of the general constitution of the parameter adjustment circuit in the time interval converter provided in the endoscope system in accordance with the first preferred embodiment of the present invention;

FIG. 14 is a timing diagram showing the timing of the operation of the parameter adjustment circuit in the time interval converter provided in the endoscope system in accordance with the first preferred embodiment of the present invention;

FIG. 15 is a block diagram showing an example of the general constitution of the various constituent elements of an endoscope system in accordance with the second preferred embodiment of the present invention;

FIG. 16 is a timing diagram showing the relationship between the various signals in the endoscope system in accordance with the second preferred embodiment of the present invention;

FIG. 17 is a block diagram showing an example of the general constitution of the various constituent elements in an endoscope system in accordance with the third preferred embodiment of the present invention;

FIG. 18 is a circuit diagram of an example of the general constitution of a time converter provided in the endoscope system in accordance with the third preferred embodiment of the present invention;

FIG. 19 is a timing diagram showing the method of generating the optical pulse signal in the endoscope system in accordance with the third preferred embodiment of the present invention;

FIG. 20 is a diagram for explaining the method of the selecting device selecting a digital signal in the endoscope system in accordance with the third preferred embodiment of the present invention;

FIG. 21 is a block diagram showing an example of another example of the general constitution of the time interval converter provide in the inner circumferential surface in accordance with the first preferred embodiment of the present invention;

FIG. 22 is a timing diagram showing the relationship of clocks in the time interval converter that is another time interval converter provided in the endoscope system in accordance with the first preferred embodiment of the present invention;

FIG. 23 is a circuit diagram showing an example of the constitution of a delay circuit provided in the time interval converter that is another time interval converter of the endoscope system in accordance with the first preferred embodiment of the present invention;

FIG. 24 is a block diagram showing an example of the general constitution of the parameter adjustment circuit in the time interval converter, which is another time interval converter, provided in the endoscope system in accordance with the first preferred embodiment of the present invention;

FIG. 25 is a timing diagram showing the timing of the operation of the parameter adjustment circuit in the time interval converter that is another time interval converter provided in the endoscope system in accordance with the first preferred embodiment of the present invention;

FIG. 26 is a circuit diagram of an example of another constitution of the delay circuit in the time interval converter provided in the endoscope system in accordance with the first preferred embodiment of the present invention;

FIG. 27 is a block diagram showing an example of the general constitution of the A/D converter in accordance with the preferred embodiment of the present invention;

FIG. 28 is a block diagram showing an example of the general constitution of the voltage time converter 210 provided in the A/D converter 200 in accordance with the preferred embodiment of the present invention;

FIG. 29 is a timing diagram showing the method of generating an electrical pulse signal in the voltage/time converter 210 provided in the A/D converter 200 in accordance with the preferred embodiment of the present invention;

FIG. 30 is a block diagram showing another example of the general constitution of the A/D converter in accordance with the preferred embodiment of the present invention;

FIG. 31 is a block diagram of an example of the general constitution of the voltage/time converter 310 provided in the A/D converter 300 that is an A/D converter in accordance with another preferred embodiment of the present invention;

FIG. 32 is a timing diagram showing the method of generating electrical pulse signals in the voltage/time converter 310 and the serializer 320 provided in the A/D converter 300 that is an A/D converter in accordance with another preferred embodiment of the present invention; and

FIG. 33 is a timing diagram showing the method of generating the electrical pulse signal in the deserializer 360 provided in the A/D converter 300, which is an A/D converter in another preferred embodiment of the present invention.

### DETAILED DESCRIPTION OF THE PREFERRED EMBODIMENTS

The present invention will be now described herein with reference to illustrative preferred embodiments. Those skilled in the art will recognize that many alternative preferred embodiments can be accomplished using the teaching of the present invention and that the present invention is not limited to the preferred embodiments illustrated for explanatory purpose.

### First Preferred Embodiment

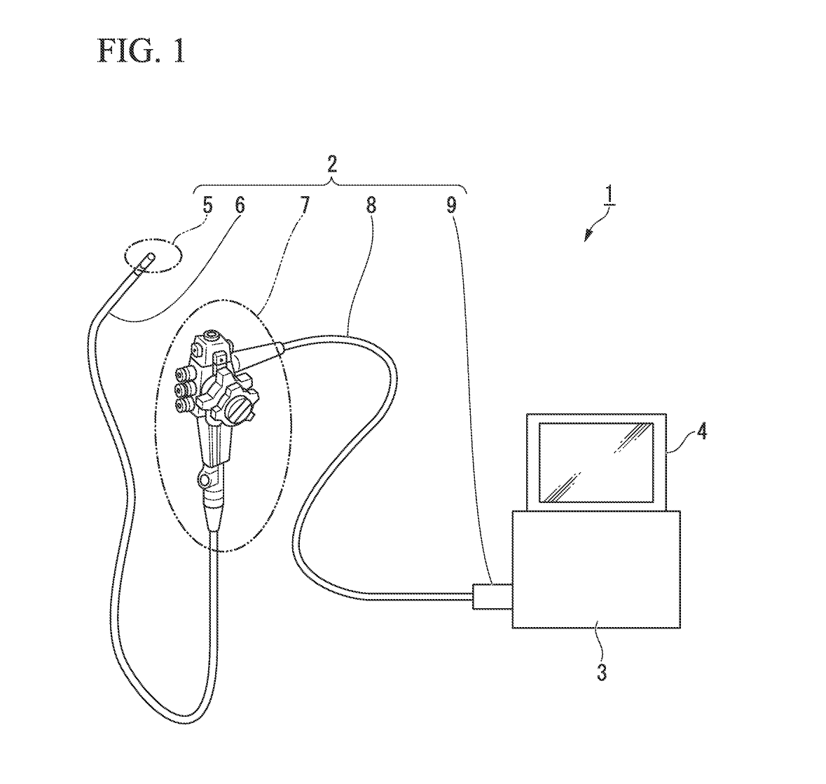

A first preferred embodiment of the present invention will be described, with references made to the drawings. FIG. 1 is a drawing showing the constitution of an endoscope system in accordance with the first preferred embodiment of the present invention. In FIG. 1, an endoscope system 1 has an endoscope 2, a main unit 3, and a monitor 4. In the main unit 3, the endoscope system 1 processes the video (pixel signal) obtained by the endoscope 2, the video signal processed by the main unit 3 being displayed as an image on the monitor 4.

The endoscope 2 is constituted by a distal end 5, an insertion section 6, an operating unit 7, a universal cord 8, and a connector 9. The distal end 5 of the endoscope 2 has an image capturing unit, and is guided by the insertion section 6, which is a cord guiding the distal end 5 within the object under examination, so that it is inserted into the object under examination. When the distal end 5 is inserted into the object under examination, the operating unit 7 operates the movement of the distal end 5 via the insertion section 6. The universal cord 8 is a cable that connects the operating unit 7 and the main unit 3, and is connected to the main unit 3 by the connector 9.

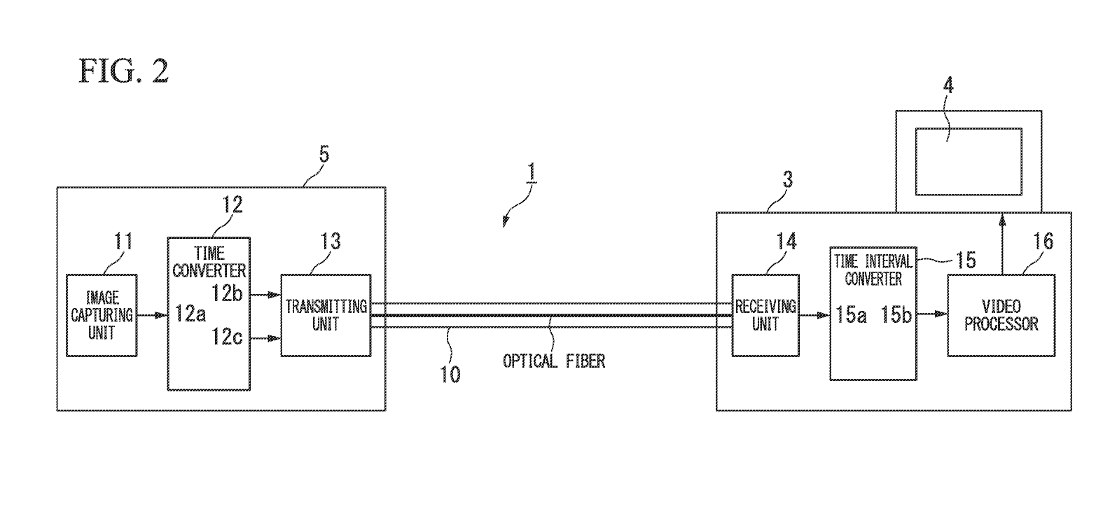

Next, the internal functioning of the endoscope system 1 of the first preferred embodiment of the present invention will be specifically described. FIG. 2 is a block diagram showing an example of the general constitution of the constituent elements of the endoscope system 1 of the first preferred embodiment of the present invention. FIG. 2 shows an example of the internal functions of the endoscope system 1 shown in FIG. 1. In FIG. 2, to simplify the description, the operating unit 7 related to the operation of the movement of the distal end 5 shown in FIG. 1 is omitted, and the insertion section 6, the operating unit 7, the universal cord 8, and the connector 9 are collectively shown as the transfer section 10.

The distal end 5 has an image capturing unit 11, a time converter 12, and a transmitting unit 13. The image capturing unit 11 has a solid-state image pickup device, in which, for example a CMOS (complementary metal-oxide semiconductor) image sensor or the like converts the amounts of light received at pixel to analog electrical signals and sequentially outputs the pixel signals for each pixel, having strengths (magnitudes) commensurate with the amounts of received light (light intensities). When a video image is captured within the object under examination, the image capturing unit 11 sequentially outputs to the time converter 12 pixel signals that are sequentially output from each of the pixels of the solid-state image pickup device.

The time converter 12 outputs time information for converting the magnitude of the pixel signals input from the image capturing unit 11 to time lengths. More specifically, the time converter 12 generates a pulse signal that represents the magnitude of a pixel signal input from the image capturing unit 11 as a time width (time interval). The pulse signal generated by the time converter 12 is a pulse signal that represents the timing of the start and the end of the time interval responsive to the magnitude of the input pixel signal. The time converter 12 outputs the generated pulse signal to the transmitting unit 13 as time information. The time converter 12 inputs the pixel signal output from the image capturing unit 11 at the input terminal 12a, and outputs the generated time information from the output terminal 12b and the output terminal 12c. The method of the time converter 12 generating the time information from the pixel signal will be described in detail later.

The transmitting unit 13, based on the time information input from the time converter 12, generates an optical pulse signal having a pulse width that represents the magnitude of the pixel signal, and transmits the generated optical pulse signal. The method of the transmitting unit 13 generating the optical pulse signal from the time information will be described in detail later.

The transfer section 10 has therewithin, for example, an optical waveguide such as an optical fiber for transmitting an optical signal. The transfer section 10, using the internal optical waveguide, guides (transfers) the optical pulse signal transmitted from the transmitting unit 13 to the outside of the distal end 5, that is, to the outside of the object under examination. FIG. 2 shows the case in which the optical waveguide provided inside the transfer section 10 is an optical fiber.

The main unit 3 has a receiving unit 14, a time interval converter 15, and a video processor 16. The receiving unit 14 converts the optical pulse signal transmitted from the transmitting unit 13 via the transfer section 10 to an electrical signal (hereinafter referred to as an electrical pulse signal) once again. Then, the receiving unit 14 outputs the converted electrical pulse signal to the time interval converter 15.

The time interval converter 15, based on the electrical pulse signal input from the receiving unit 14, detects the time information output by the time converter 12. Then, the time interval converter 15, based on the detected time information, converts the length of the time (time interval) represented by the time information to a binary digital signal, that is, makes a conversion to a binary digital signal that represents the magnitude of the pixel signal input to the time converter 12 from the image capturing unit 11. By doing this, an analog pixel signal, which is a video image from inside the object under examination captured by the image capturing unit 11, is converted to a digital video signal. The time interval converter 15 then outputs the converted digital signal to the video processor 16. The time interval converter 15 inputs the electrical pulse signal output from the receiving unit 14 at the input terminal 15a and outputs the converted digital signal at the output terminal 15b. The methods of the time interval converter 15 detecting the time information and converting from the time information to a digital signal will be described in detail later.

The video processor 16 processes the digital signal input from the time interval converter 15 and, based on the digital signal, displays on the monitor 4 an image that was captured within an object under examination by the image capturing unit 11 at the distal end 5.

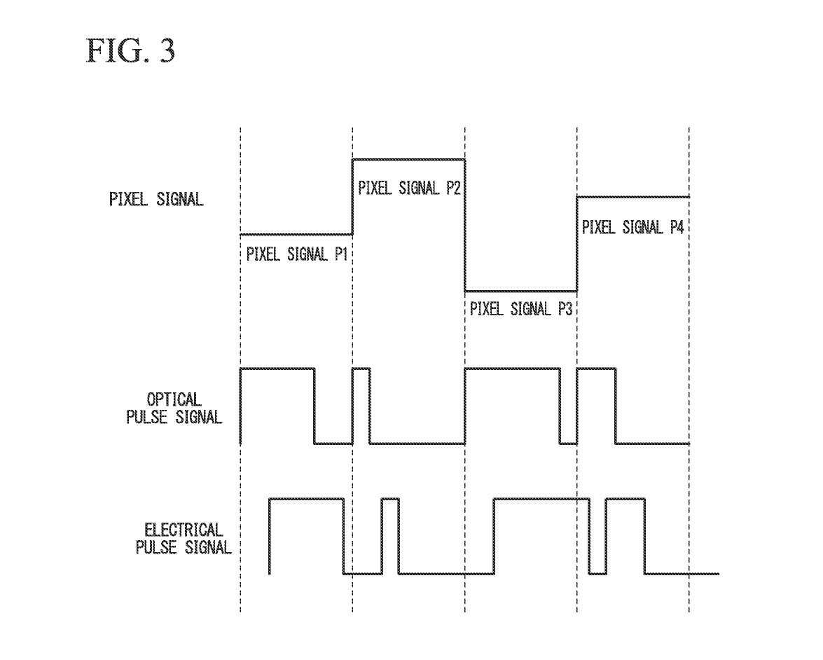

Next, the operation of the endoscope system 1 of the first preferred embodiment of the present invention will be described. FIG. 3 is a timing diagram showing the relationship between the various signals in the endoscope system 1 of the first preferred embodiment of the present invention. In FIG. 3, the pixel signals show one example of pixel signals (analog electrical signals) responsive to a video image within an object under examination that are output by the image capturing unit 11. FIG. 3 shows the timing for the case of sequential output of pixel signals (pixel signals P1 to P4) of four pixels from the image capturing unit 11. The optical pulse signals show a schematic representation of an example of optical pulse signals transmitted by the transmitting unit 13. The electrical pulse signals show one example of electrical pulse signals that are output to the time interval converter 15 after conversion of optical pulse signals transmitted via the transfer section 10 to electrical signals by the receiving unit 14.

The image capturing unit 11 successively outputs pixel signals (pixel signals P1 to P4) having magnitudes (voltages) that correspond to the amounts of light (light intensities) of video image captured by the respective pixels. The time converter 12 then generates time information (pulse signals) that corresponds to the magnitudes of the voltage values of the pixel signals P1 to P4 that are output by the image capturing unit 11. The transmitting unit 13 then generates optical pulse signals having pulse widths that correspond respectively to the time information generated by the time converter 12. In the example of optical pulse signals shown in FIG. 3, the case shown is one in which a light pulse signal is generated, in which the lower is the voltage value of the pixel signal, the wider is high-level pulse width, and the higher is the voltage value of the pixel signal, the narrower is the high-level pulse signal. That is, in the example of optical pulse signals shown in FIG. 3, the time from the rising edge to the falling edge of each of pulse represents the magnitude of the voltage value of the corresponding pixel signals P1 to P4.

The transmitting unit 13 transmits to the main unit 3 the optical pulse signals generated based on the time information output by the time converter 12. The optical pulse signals transmitted by the transmitting unit 13 reach the receiving unit 14 via the transfer section 10, are converted once again to electrical signals by the receiving unit 14, and are input to the time interval converter 15 as electrical pulse signals. By doing this, each time information (pulse signal) output by the time converter 12 is sequentially input to the time interval converter 15 with a fixed time delay.

The time interval converter 15 converts the time width (time interval) between the rising edge and the falling edge of the input electrical pulse signals, that is, converts the magnitudes of the voltages of the pixel signals P1 to P4 to binary digital signals, which are sequentially output to the video processor 16. The video processor 16 displays on the monitor 4 an image that is the result of processing the digital signals sequentially input from the time interval converter 15.

In this manner, in the endoscope system 1 of the first preferred embodiment of the present invention, the time converter 12 provided at the distal end 5 generates time information, based on the analog pixel signals imaged by the image capturing unit 11, and the transmitting unit 13 transmits to the main unit 3 optical pulse signals responsive to the time information. That is, in the endoscope system 1 of the first preferred embodiment of the present invention, at the distal end 5 of the endoscope 2 that is inserted into the object under examination, analog pixel signals are converted to times and transmitted, thereby transmitting a video image captured inside of the object under examination to the main unit 3. The time interval converter 15 provided in the main unit 3 then converts the transmitted time information to digital signals. By doing this, in the endoscope system 1 of the first preferred embodiment of the present invention, it is not necessary as in a conventional endoscope system to have an A/D conversion unit having a large electrical power consumption or a constituent element for the purpose of serialization, within the distal end 5 of the endoscope 2 that is inserted into the object under examination, thereby reducing the electrical power consumption of distal end 5 and enabling a reduction of heat generation.

In this case, the method of the time converter 12 and the transmitting unit 13 provided at the distal end 5 converting to time lengths and transmitting the magnitudes of the pixel signals input from the image capturing unit 11, and the method of the time interval converter 15 provided in the main unit 3 converting the time lengths (time intervals) to binary digital signals will now be described by specific examples.

### Example of a Method of Converting Magnitudes of Pixel Signals to Time Lengths

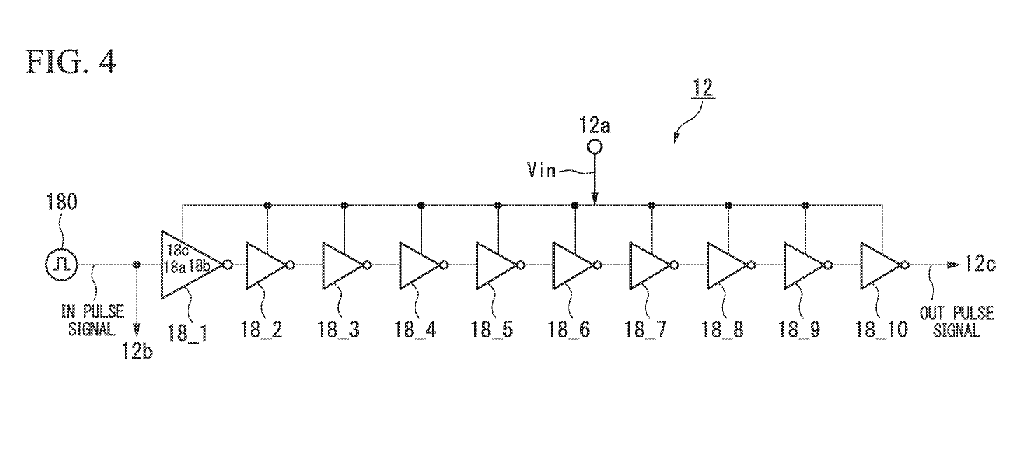

First, an example of a time converter 12 assumed to be provided in the distal end 5 of an endoscope 2 in the endoscope system 1 of the first preferred embodiment of the present invention will be described. FIG. 4 is a circuit diagram showing an example of the general constitution of the time converter 12 provided in the endoscope system 1 of the first preferred embodiment of the present invention. FIG. 4 shows an example of a time converter 12 having a constitution in which ten logical negation circuits (inverter circuits) are used as inverter circuits, each of the inverter circuits being connected in series. In FIG. 4 the time converter 12 has a pulse generator 180 and the ten inverter circuits 18_1 to 18_10. In the description to follow, when indicating any one of the inverter circuits 18_1 to 18_10, the expression “inverter circuit 18” will be used.

Each time pixel signal corresponding to the respective pixels of the solid-state image pickup device provided in the image capturing unit 11 is input to the time converter 12, and the pulse generator 180 outputs a pulse signal (hereinafter referred to as the IN pulse signal) for the purpose of starting the conversion of each of the input pixel signals to a pixel signal time.

The pixel signal input to the input terminal 12a of the time converter 12 is input as the power supply Vin to a power supply terminal 18c of all of the inverter circuits 18. The IN pulse signal output by the pulse generator 180 is input to an input terminal 18a of the first stage of inverter circuit 18_1, and, starting from the next stage the output signal of the previous stage of each of the inverter circuits 18 is input to the input terminal 18a of each of the inverter circuits 18.

Each of the inverter circuits 18 delays a signal that is the inversion (logically negation) of the IN pulse signal input to the input terminal 18a or the output signal from the previous stage inverter circuit 18 by a delay time responsive to the voltage value of the power supply Vin input to the power supply terminal 18c, and outputs the resulting signal at an output terminal 18b thereof. That is, each of the inverter circuits 18 delays the signal input to the input terminal 18a thereof by an amount of time responsive to the voltage value of the pixel signal input to the power supply terminal 18c, and outputs the resulting signal from the output terminal 18b. By doing this, a pulse signal (hereinafter referred to as the OUT pulse signal) with a time delay commensurate with ten stages of the delays of the IN pulse signal generated by the pulse generator 180, responsive to the voltage value of the power supply Vin input to the power supply terminal 18c, is output from the output terminal 18b of the final stage inverter circuit 18_10.

The time converter 12 outputs, as time information from the output terminal 12b and the output terminal 12c, the IN pulse signal output by the pulse generator 180 and the OUT pulse signal output by the inverter circuit 18_10 for the purpose of converting the magnitude of the pixel signal input from the image capturing unit 11 to a time length. Also, the IN pulse signal output from the output terminal 12b of the time converter 12 is a pulse signal representing the timing of the start of a time interval responsive to the magnitude of the input pixel signal, and the OUT pulse signal output from the output terminal 12c is a pulse signal representing the end of a time interval responsive to the magnitude of the input pixel signal.

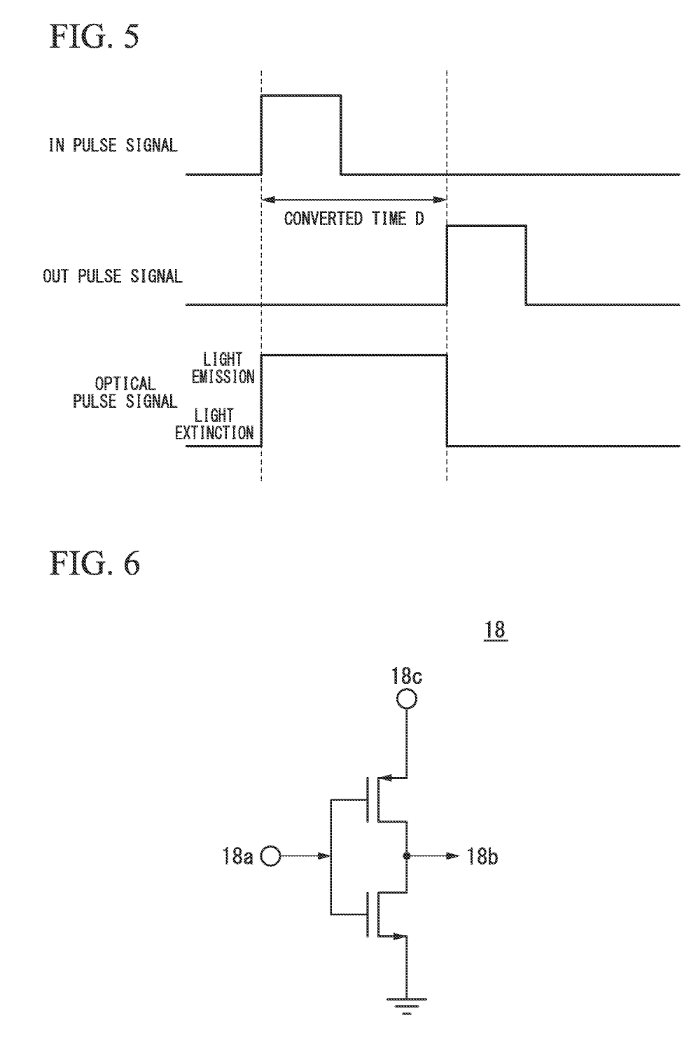

Next, in the endoscope system 1 of the first preferred embodiment of the present invention, the method of generating, based on the time information, an optical pulse signal representing, as a pulse width, the magnitude of a pixel signal will be described. FIG. 5 is a timing diagram showing the method of generating an optical pulse signal in the endoscope system 1 of the first preferred embodiment of the present invention. FIG. 5 shows the timing for the case of generating an optical pulse signal corresponding to a pixel signal of one pixel input from the image capturing unit 11.

At the input terminal 12a of the time converter 12, the time converter 12 inputs as the power supply Vin from the image capturing unit 11a pixel signal to be converted to time, after which, as shown in FIG. 5, the IN pulse signal output by the pulse generator 180 is output from the output terminal 12b as the time information. In the time converter 12, each of the inverter circuits 18 sequentially delays the IN pulse signal by a delay time responsive to the voltage value of the power supply Vin and, as shown in FIG. 5, outputs as time information from the output terminal 12c the OUT pulse signal output from the final stage inverter circuit 18_10.

The time difference between the timing of the rising edge of the IN pulse signal output by the time converter 12 and the timing of the rising edge of the OUT pulse signal is a time that is responsive to the magnitude of the pixel signal input as the power supply Vin to the input terminal 12a of the time converter 12, that is, the converted time D when the pixel signal is converted to a time length.

The transmitting unit 13, in response to the IN pulse signal and the OUT pulse signal input from the time converter 12, generates an optical pulse signal representing the converted time D as a pulse width. FIG. 5 shows the case in which the transmitting unit 13 generates an optical pulse signal in which light is emitted with the timing of the rising edge of the IN pulse signal and light is extinguished with the timing of the rising edge of the OUT pulse signal.

The relationship between the pixel signal input to the time converter 12 and the converted time D will now be described. The inverter circuits 18 provided in the time converter 12 will be described first. FIG. 6 is a circuit diagram showing an example of the constitution of an inverter circuit 18 provided in the time converter 12 of the endoscope system 1 of the first preferred embodiment of the present invention. FIG. 6 shows an example of the constitution of a general inverter circuit 18 that is constituted by two transistors (a PMOS transistor and an NMOS transistor). Because the inverter circuit 18 shown in FIG. 6 has the basic constitution of an inverter circuit, a detailed description of the operation of the inverter circuit will be omitted.

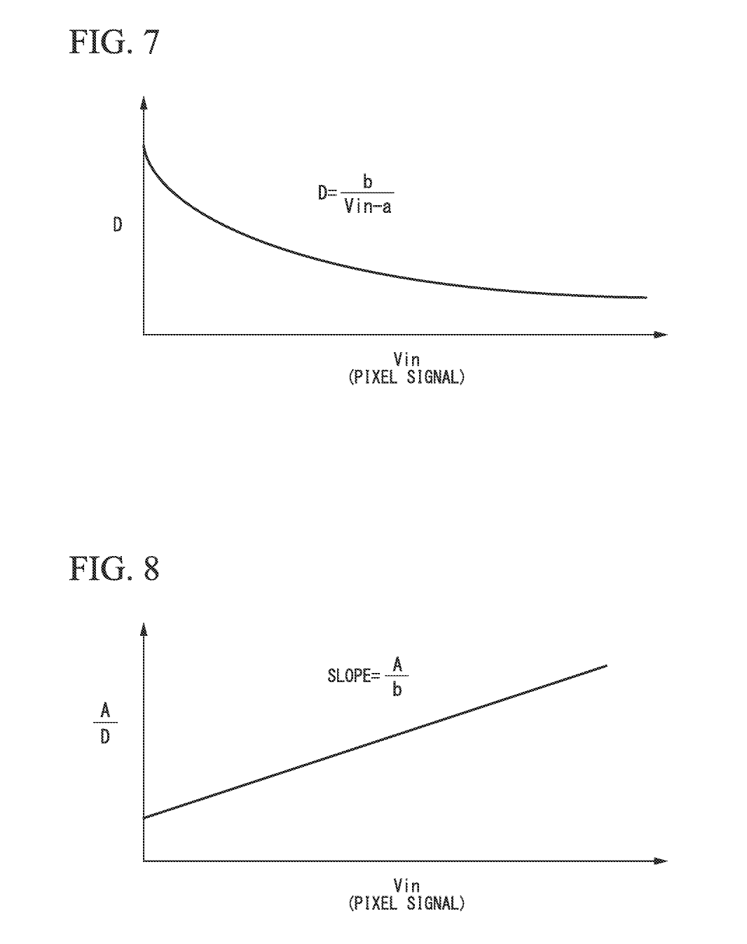

As described above, the pixel signal output from the image capturing unit 11 is input as the power supply Vin of the inverter circuits 18. In general, in an inverter circuit constituted by a PMOS transistor and an NMOS transistor, the power supply voltage and delay time from input to the output of a signal are related by a first-order rational function. FIG. 7 is a drawing showing the relationship between the pixel signal and the converted time in the endoscope system of the first preferred embodiment of the present invention. In the time converter 12 as well, the first-order rational function such as shown in FIG. 7 exists between the pixel signal input as the power supply Vin of the inverter circuits 18 and the converted time D. As can be seen from FIG. 7, the relationship between the pixel signal and the converted time D is not a linear relationship. In this case, the relationship between the pixel signal (power supply Vin) and the converted time D may be represented by the following Equation (1).

D=b/(Vin−a) (1)

In Equation (1), a is an arbitrary real number, and b is an arbitrary real number other than 0. In FIG. 7, a and b are constants larger than 0 (a>0, b>0).

However, if it is known beforehand that the magnitude of a pixel signal will be converted to a time length by the converted time D represented as in Equation (1), by processing the converted time D after conversion to a binary digital signal based on the transmitted optical pulse signal, it is easy to generate a digital video signal having a proportional relationship with the pixel signal (power supply Vin). That is, by performing pre-established processing with respect to the binary digital signal that is converted by the time interval converter 15, it is easy to generate a digital video signal having a proportional relationship with the analog pixel signal (power supply Vin).

FIG. 8 is a drawing showing the relationship between the pixel signal after the transmitted signal is processed and the converted time in the endoscope system 1 of the first preferred embodiment of the present invention. The video processor 16, by dividing a pre-established constant by the digital signal output from the time interval converter 15, may generate a digital video signal having a substantially first-order function relationship such as shown in FIG. 8. In FIG. 8, an arbitrary constant A is divided by the digital signal (converted time D), so as to generate a digital signal (A/D) having a relationship that is proportional to the analog pixel signal (power supply Vin), and having a slope of A/b.

In this manner, in the endoscope system 1 of the first preferred embodiment of the present invention, by providing the distal end 5 with a time converter 12 having the constitution shown in FIG. 4, it is easy to convert the pixel signal to a time length. Even if the relationship between the pixel signal and the converted time D in the time converter 12 is not linear, by processing the converted time D after conversion to a binary digital signal, it is possible to obtain a digital video signal having a substantially proportional relationship with the analog pixel signal.

### Example of a Method of Converting Time Length (Time Interval) to a Digital Signal

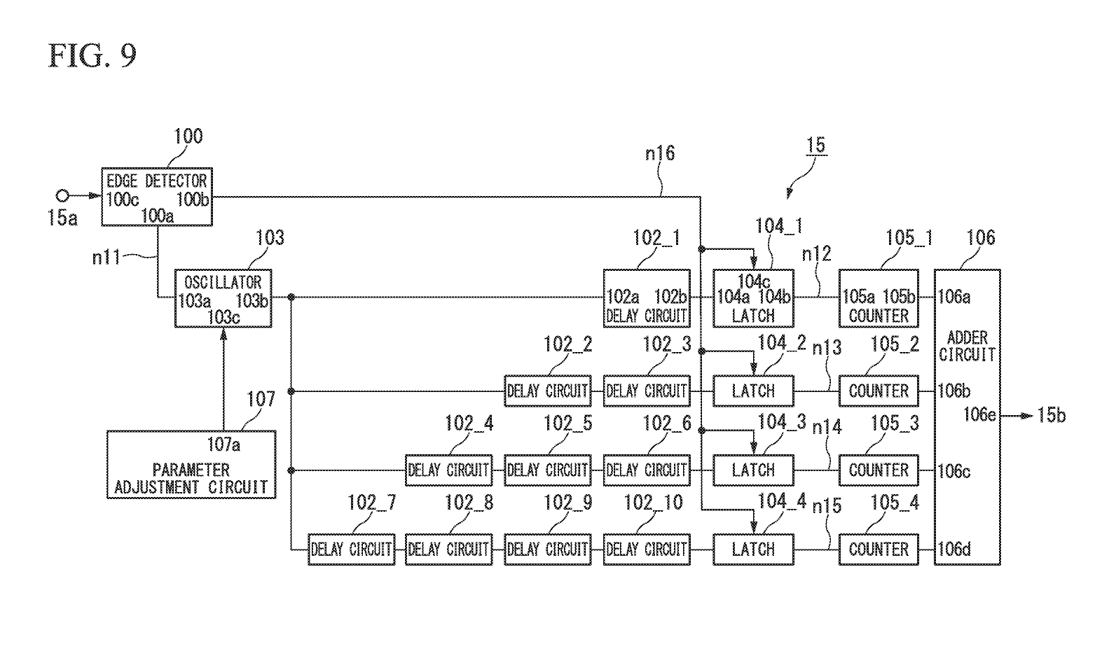

Continuing, an example of a time interval converter 15 assumed to be provided in the main unit 3 in the endoscope system 1 of the first preferred embodiment of the present invention will be described. FIG. 9 is a block diagram showing an example of the general constitution of the time interval converter 15 provided in the endoscope system 1 of the first preferred embodiment of the present invention. In FIG. 9, the time interval converter 15 has an edge detector 100, ten delay circuits 102_1 to 102_10, an oscillator 103, four latches 104_1 to 104_4, four counters 105_1 to 105_4, and an adder circuit 106.

The time interval converter 15, by driving in parallel a plurality of clocks having different phases, converts the time interval, which is represented by the electrical pulse signal that is input, to a digital signal, and outputs the converted digital signal. The time interval converter 15 inputs at the input terminal 15a an electrical pulse signal that is converted to an electrical signal by the receiving unit 14. The time interval converter 15 outputs from the output terminal 15b a digital signal responsive to the time width (time interval) between the rising edge and the falling edge of the input electrical pulse signal, that is, a digital signal responsive to the converted time D that represents the magnitude of the pixel signal as a pulse width.

In a time interval converter such as the time interval converter 15, in which a plurality of clocks having different phases are driven in parallel, because the destruction of the relationship between the edges of neighboring clocks leads to error in conversion to a digital signal, it is desirable that the interval between edges of neighboring clocks be equal. For this reason, in the time interval converter 15, by further having the parameter adjustment circuit 107 and controlling the frequencies of a plurality of clocks having different phases, the variation in the clocks used in converting the time interval represented by the electrical pulse signal to a digital signal is suppressed, and the time interval is converted to a digital signal with high resolution and good accuracy.

In the time interval converter 15 shown in FIG. 9, when indicating any one delay circuit of the delay circuits 102_1 to 102_10, the expression “delay circuit 102” will be used. When indicating any one latch of the latch 104_1 to 104_4, the expression “latch 104” will be used. When indicating any one counter of the counters 105_1 to 105_4, the expression “counter 105” will be used. In the description to follow, the signals at the output terminals of each of the constituent elements within the time interval converter 15 will be referred to as nodes.

The edge detector 100 detects the rising edge and the falling edge of the electrical pulse signal input to the time interval converter 15, and outputs signals that represent the timing of the detected rising and falling edges of the electrical pulse signal. The signal output by the edge detector 100 representing the timing of the start of a time interval responsive to the magnitude of the pixel signal, that is, a signal (hereinafter referred to as the starting signal) representing the timing of the rising edge of the IN pulse signal output by the time converter 12. The signal output by the edge detector 100, which represents the timing of the falling edge of the electrical pulse signal is a signal representing the timing of the ending of the time interval responsive to the magnitude of the pixel signal, that is, a signal (hereinafter referred to as the ending signal) representing the timing of the rising edge of the OUT pulse signal output by the time converter 12. The starting signal output by the edge detector 100 is also the timing of the start of the conversion by the time interval converter 15 of the time interval to a digital signal, and the ending signal output therefrom is also the timing of the end of the conversion by the time interval converter 15 of the time interval to a digital signal.

The electrical pulse signal that is input to the input terminal 15a of the time interval converter 15 is input to the edge detector 100 at the input terminal 100c. The edge detector 100 outputs the starting signal (node n11) from the output terminal 100a and outputs the ending signal (node n16) from the output terminal 100b. More specifically, upon detecting the rising edge of the input electrical pulse signal, the edge detector 100 switches the node n11 from the low level to the high level, and upon detected the falling edge of the input electrical pulse signal, it switches the node n16 from the low level to the high level.

When the time interval converter 15 starts conversion of the time interval to a digital signal, the oscillator 103 outputs a clock having a frequency responsive to an input setting signal. The oscillator 103 inputs at the input terminal 103a the starting signal (node n11) output from the output terminal 100a of the edge detector 100, and inputs at the input terminal 103c a setting signal output from the output terminal 107a of the parameter adjustment circuit 107. The oscillator 103 outputs from the output terminal 103b a clock having a frequency based on the setting signal that is input to the input terminal 103c from the time indicated as the start of the time interval by the node n11. The frequency of the clock output by the oscillator 103 may be changed by the setting signal input to the input terminal 103c from the parameter adjustment circuit 107.

More specifically, the oscillator 103 starts the clock output at the timing of the switch of the node n11 from the low level to the high level, and changes the output terminal 103b to the low level and stops the clock output at the timing of the switch of the node n11 from the high level to the low level. The constitution of the oscillator 103 will be described in detail later.

Each of the delay circuits 102_1 to 102_10 delays the signal input to the input terminal 102a by an amount of time Δt and outputs the resulting signal from the output terminal 102b. By the delay circuits 102 disposed as shown in FIG. 9, the time interval converter 15 outputs in parallel a clock in which the clock output from the oscillator 13 is caused to be delayed by the time Δt (hereinafter, clock d1), delayed by the time 2Δt (hereinafter, clock d2), delayed by the time 3Δt (hereinafter, clock d3), and delayed by the time 4Δt (hereinafter, clock d4).

More specifically, the clock output from the output terminal 103b of the oscillator 103 is input to the input terminals 102a of each of the delay circuit 102_1, the delay circuit 102_2, the delay circuit 102_4, and the delay circuit 102_7. The delay circuit 102_1 outputs from the output terminal 102b thereof the clock d1 that is the input clock delayed by the time Δt. The two delay circuits 102 (delay circuit 102_2 and delay circuit 102_3) that are connected in series successively delay the input clock by the time Δt, and ultimately the delay circuit 102_3 outputs from the output terminal 102b thereof the clock d2, which is the clock that has been input to the input terminal 102a of the delay circuit 102_2 and is delayed by the time 2Δt. The three delay circuits 102 (delay circuit 102_4, delay circuit 102_5, and delay circuit 102_6) that are connected in series successively delay the input clock by the time Δt, and ultimately the delay circuit 102_6 outputs from the output terminal 102b thereof the clock d3, which is the clock that has been input to the input terminal 102a of the delay circuit 102_4 and is delayed by the time 3Δt. The four delay circuits 102 (delay circuit 102_7, delay circuit 102_8, delay circuit 102_9, and delay circuit 102_10) that are connected in series successively delay the input clock by the time Δt, and ultimately the delay circuit 102_10 outputs from the output terminal 102b thereof the clock d4, which is the clock that has been input to the input terminal 102a of the delay circuit 102_7 and is delayed by the time 4Δt. The constitution of the delay circuits 102 will be described in detail later.

Each of the latches 104_1 to 104_4, in response to the signal input to the input terminal 104c thereof, outputs from the output terminal 104b the signal input to the input terminal 104a or a signal that holds the state of the signal input to the input terminal 104a. Each of the latches 104_1 to 104_4 inputs at the input terminal 104a a delayed clock that is output from the output terminal 102b of the corresponding delay circuit 102, and inputs at the input terminal 104a the ending signal (node n16) output from the output terminal 100b of the edge detector 100. When the node n16 is at the low level, each of the latches 104_1 to 104_4 transfers to and outputs from the output terminal 104b the clock input at the input terminal 104a as is, when the node n16 changes from the low level to the high level, holds the state of the clock input at the input terminal 104a and, during the period in which the node n16 is at the high level, continues to output from the output terminal 104b a signal that holds that state. At the time interval converter 15, by the latches 104 disposed as shown in FIG. 9, each of the clocks that are delayed by the delay circuits 102 are output in parallel.

More specifically, the latch 104_1 inputs at the input terminal 104a the clock d1 output from the delay circuit 102_1 and, in response to the state of the node n16, outputs from the output terminal 104b as the node n12 the clock d1 or a signal having the held state of the clock d1. The latch 104_2 inputs at the input terminal 104a the clock d2 output from the delay circuit 102_3 and, in response to the state of the node n16, outputs from the output terminal 104b as the node n13 the clock d2 or a signal having the held state of the clock d2. The latch 104_3 inputs at the input terminal 104a the clock d3 output from the delay circuit 102_6 and, in response to the state of the node n16, outputs from the output terminal 104b as the node n14 the clock d3 or a signal having the held state of the clock d3. The latch 104_4 inputs at the input terminal 104a the clock d4 output from the delay circuit 102_10 and, in response to the state of the node n16, outputs from the output terminal 104b as the node n15 the clock d4 or a signal having the held state of the clock d4.

By the above-noted constitution, each of the latches 104 starts output at the timing of the node n11 the oscillator 103 switching from the low level to the high level, and stops the clock delayed by each of the delay circuits 102 at the timing of the node n16 switching from the low level to the high level. Stated differently, each of the latches 104 outputs, as the nodes n12 to n15 from its respective output terminal 104b the respective clocks output by the oscillator 103 and delayed by the respective delay circuit 102, during the period of time from the time the electrical pulse signal input to the input terminal 15a of the time interval converter 15 indicates the start of the time interval to the time that the input signal indicates the end of the time interval, that is, during the converted time D that is responsive to the magnitude of the pixel signal. Because the latches 104 can be easily configured from general logic circuits, a detailed description thereof will be omitted.

Each of the counters 105_1 to 105_4 counts the number of rising edges and falling edges of the signals (nodes n12 to n15) input to the input terminal 105a and outputs from the output terminal 105b the counted numbers. By the counters 105 disposed as shown in FIG. 9 the time interval converter 15 counts the edges at the output nodes of the corresponding latches 104, that is, the edges of the clock output from the oscillator 103 and delayed by the corresponding delay circuit 102 in parallel. The counters 105 then output the counted numbers of clock edges in parallel.

More specifically, the counter 105_1 inputs the node n12 output from the latch 104_1, that is, the clock d1, at the input terminal 105a, and outputs the counted number of rising edges and falling edges of the node n12 from the output terminal 105b. The counter 105_2 inputs the node n13 output from the latch 104_2, that is, the clock d2, at the input terminal 105a, and outputs the counted number of rising edges and falling edges of the node n13 from the output terminal 105b. The counter 105_3 inputs the node n14 output from the latch 104_3, that is, the clock d3, at the input terminal 105a, and outputs the counted number of rising edges and falling edges of the node n14 from the output terminal 105b. The counter 105_4 inputs the node n15 output from the latch 104_4, that is, the clock d4, at the input terminal 105a, and outputs the counted number of rising edges and falling edges of the node n15 from the output terminal 105b. Because the counters 105 can be easily configured from general logic circuits, a detailed description thereof will be omitted.

The adder circuit 106 inputs at the input terminals 106a to 106d the counted number of clock edges output from the output terminals 105b of each of the counters 105_1 to 105_4, and adds the input counted numbers of clock edges. The adder circuit 106 outputs the total count at the output terminal 106e, that is, from the output terminal 15b of the time interval converter 15, as a digital signal responsive to the time interval represented by the electrical pulse signal input to the time interval converter 15. Because the adder circuit 106 can be configured easily from general logic circuits, a detailed description thereof will be omitted.

The parameter adjustment circuit 107 outputs from the output terminal 107a a setting signal, which is a parameter for controlling the frequency of the clock output by the oscillator 103. By this setting signal, the parameter adjustment circuit 107 adjusts the frequency of the clock output by the oscillator 103 so that the timing that is delayed by the time Δt from the rising edge of the clock d4 output from the delay circuit 102_10 and the timing of the falling edge of the clock d1 output from the delay circuit 102_1 coincide.

By doing this, the time difference between the timing of the rising edge of the clock d4 output from the delay circuit 102_10, that is, the clock resulting from delaying by the time 4Δt the clock output from the oscillator 103 and the timing of the falling edge of the clock d1 output from the delay circuit 102_1, that is, the clock resulting from delaying by the time Δt the clock output from the oscillator 103 is the time Δt. The time difference between the timing of the rising edge of node n15 output from the corresponding latch 104_4 and the timing of the falling edge of the node n12 output from the latch 104_1 is also the time Δt. The method of the parameter setting circuit 107 adjusting the frequency of the clock output from the oscillator 103 will be described in detail later.

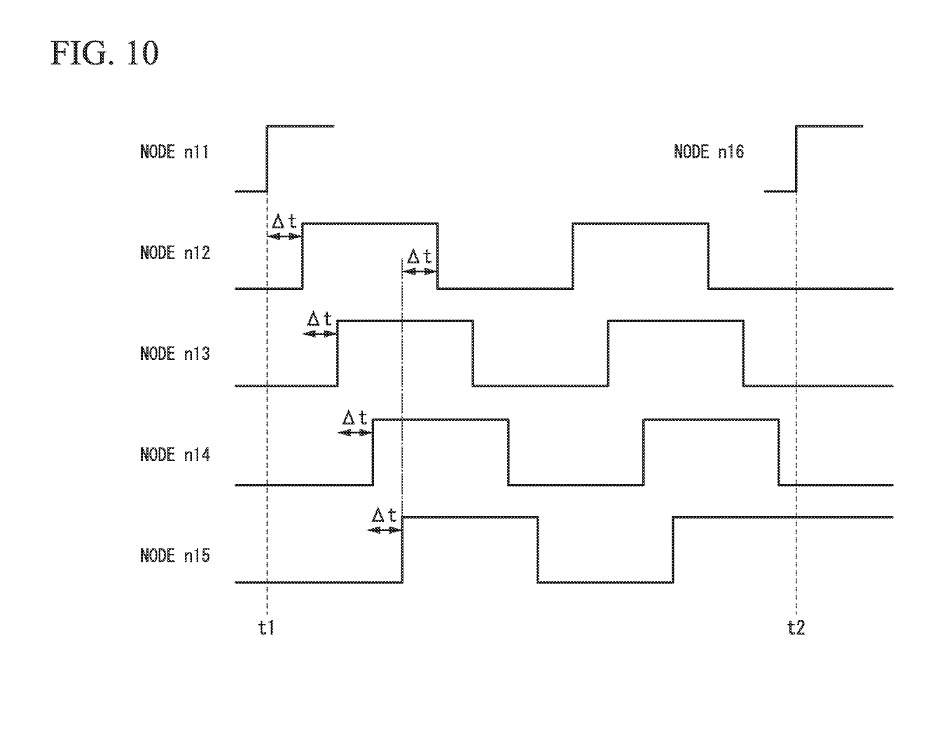

Next, the operation of the time interval converter 15 in the first preferred embodiment of the present invention will be described. FIG. 10 is a timing diagram showing the relationship between the clocks in the time interval converter 15 provided in the endoscope system 1 of the first preferred embodiment of the present invention. FIG. 10 shows the timing of each node in the constitution of the time interval converter 15 of FIG. 9.

First, at the time t1, when the edge detector 100 detects the start of the time interval, that is the rising edge of the electrical pulse signal, based on the electrical pulse signal input to the input terminal 15a of the time interval converter 15 and switches the starting signal (node n11) from the low level to the high level, the oscillator 103 simultaneously starts outputting the clock. By doing this, the node n12, which is the clock d1 that is delayed by the time Δt of one stage of delay circuit 102, is output from the latch 104_1. In parallel with this, the node n13, which is the clock d2 that is delayed by the time 2Δt of two stages of delay circuit 102 is output from the latch 104_2, the node n14, which is the clock d3 that is delayed by the time 3Δt of three stages of delay circuit 102 is output from the latch 104_3, and the node n15, which is the clock d4 that is delayed by the time 4Δt of four stages of delay circuit 102 is output from the latch 104_4.

Each of the counters 105_1 to 105_4 counts the number of the rising edges and the falling edges at the input nodes n12 to n15, and outputs the counted number to the adder circuit 106.

After the above, at the time t2, when the edge detector 100 detects the end of the time interval, that is, the falling edge of the electrical pulse signal, based on the electrical pulse signal input to the input terminal 15a of the time interval converter 15 and switches the ending signal (node n16) from the low level to the high level, each of the latches 104_1 to 104_4 holds the state of the respective node of the nodes n12 to n15.

The adder circuit 106 then adds the counted number of clock edges input from the counters 105_1 to 105_4, and outputs from the output terminal 15b of the time interval converter 15 the total count as a digital signal responsive to the time from the start to the end of the time interval represented by the electrical pulse signal input to the time interval converter 15.

In this manner, in the time interval converter 15 a plurality of clocks of the same frequency and delayed by the same interval (the time Δt in the time interval converter 15) are operated in parallel. The number of rising edges and falling edges of each of the delayed clocks are counted and then finally the counted number of clock edges are added. By doing this in the time interval converter 15, the number of counted edges of the clock during the time interval is increased from the time (node n11) at which the electrical pulse signal detected by the edge detector 100 indicates the start of the time interval up until the time (node n16) it indicates the end of the time interval, thereby enabling an improvement in the resolution of the digital signal that is output.

When this is done, the parameter adjustment circuit 107, as described above, successively adjusts the frequency of the clock output by the oscillator 103 by successively adjusting the parameter (setting signal) so that the timing that is delayed by the time Δt from the rising edge of the node n15 coincides with the timing of the falling edge of the node n12. By doing this, in the time interval converter 15, as shown in FIG. 10, all of the intervals between neighboring edges (rising edges and falling edges) at the nodes n12 to n15 can be made always the same fixed time Δt.

In this manner, in the time interval converter 15, by providing the oscillator 103 having a variable-frequency clock output and the parameter adjustment circuit 107 that successively adjusts the frequency of the clock output by the oscillator 103, it is possible to convert a time interval to a digital signal with high resolution and good precision.

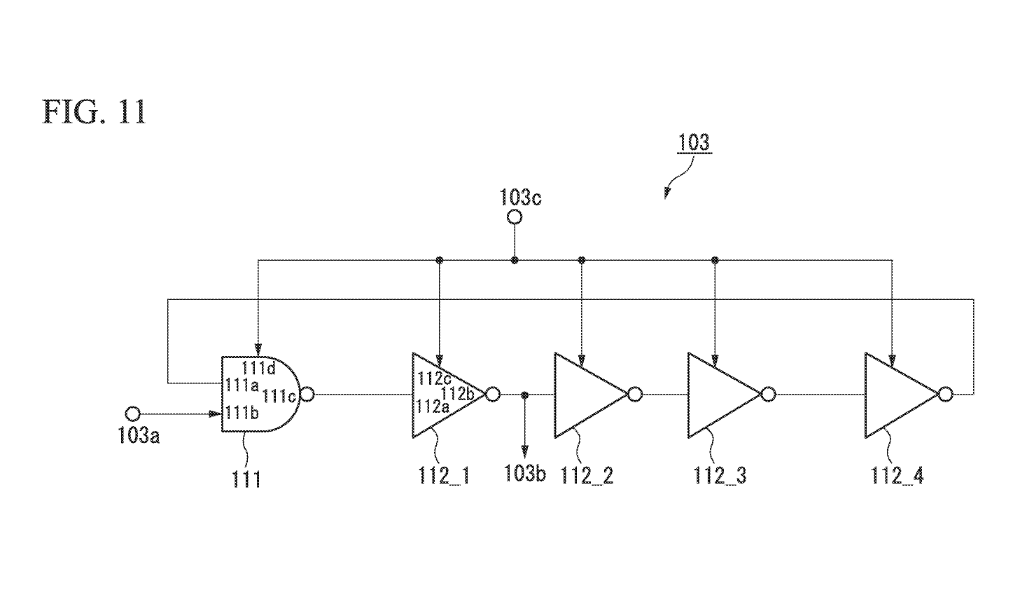

Next, the oscillator 103 provided in the time interval converter 15 will now be described. FIG. 11 is a circuit diagram showing an example of the general constitution of the oscillator 103 in the time interval converter 15 provided in the endoscope system 1 of the first preferred embodiment of the present invention. FIG. 11 shows an example of the constitution of a ring oscillator having five inverting circuits linked in a ring configuration, with a logical negation product circuit (NAND circuit) and logical negation circuits (inverter circuits) each used as inverting circuits. In FIG. 11, the oscillator 103 has a NAND circuit 111 and four inverter circuits 112_1 to 112_4. In the oscillator 103 shown in FIG. 11, when indicating any one of the inverter circuits 112_1 to 112_4, the expression “inverter circuit 112” will be used, and when indicating any one inverter circuit of the NAND circuit 111 and the four inverter circuits 112_1 to 112_4, the expression “inverting circuit” will be used.

The oscillator 103, in response to node n11 that represents the start of measurement of the time interval by the time interval converter 15 and that has been input to the input terminal 103a from the edge detector 100, outputs from the output terminal 103b a clock having a frequency based on the setting signal from the parameter adjustment circuit 107 that is input at the input terminal 103c. FIG. 11 shows the configuration in the case in which the output signal output from the output terminal 112b of the inverter circuit 112_1, which is the second stage of inverting circuit, is output from the output terminal 103b of the oscillator 103 as the clock output from the oscillator 103.

The NAND circuit 111, which is the first stage of inverting circuit, inputs at the input terminal 111b the node n11, which is input to the input terminal 103a of the oscillator 103, the output signal output from the output terminal 112b of the inverter circuit 112_4, which is the last stage of inverting circuit, is input to the input terminal 111a, and the parameter (setting signal) input at the input terminal 103c of the oscillator 103 is input to the power supply terminal 111d. The NAND circuit 111 delays the signal that is the negated logical product of the output signal input to the input terminal 111a and the node n11 input to the input terminal 111b by a delay time responsive to the parameter input to the power supply terminal 111d, and outputs the result from the output terminal 111c.

Each inverter circuit 112 starting from the next stage inputs at the input terminal 112a the output signal from the previous stage of inverting circuit and inputs at a power supply terminal 112c the parameter (setting signal) input to the input terminal 103c of the oscillator 103. More specifically, the inverter circuit 112_1, which is the second stage of inverting circuit, inputs at the input terminal 112a the output signal output from the output terminal 111c of the NAND circuit 111, which is the first stage of inverting circuit, and inputs the parameter (setting signal) at the power supply terminal 112c. The inverter circuit 112_2, which is the third stage of inverting circuit, inputs at the input terminal 112a the output signal output from the output terminal 112b of the inverter circuit 112_1 and inputs the parameter (setting signal) at the power supply terminal 112c. The inverter circuit 112_3, which is the fourth stage of inverting circuit, inputs at the input terminal 112a the output signal output from the output terminal 112b of the inverter circuit 112_2 and inputs the parameter (setting signal) at the power supply terminal 112c. The inverter circuit 112_4, which is the fifth stage of inverting circuit, inputs at the input terminal 112a the output signal output from the output terminal 112b of the inverter circuit 112_3 and inputs the parameter (setting signal) at the power supply terminal 112c. Each of the inverter circuits 112 delays the inverted (logically negated) signal of output signal of the previous stage of inverting circuit input at the input terminal 112a by a delay time responsive to the parameter (setting signal) input to the power supply terminal 112c and outputs the resulting signal from the output terminal 112b.

In this manner, in the time interval converter 15 by using a ring oscillator as the oscillator 103, it is easy to configure an oscillator capable of varying the output clock frequency, with a power supply voltage or power supply current of each inverting circuit in the oscillator 103 as a parameter.

As can be understood from the constitution of the oscillator 103 shown in FIG. 11, there is a delay time (oscillator drive delay time) from the time that the node n11 input to the oscillator 103 indicates the start of time interval until the clock is actually output from the output terminal 103b of the oscillator 103, that is, the time until the output signal is output from the output terminal 112b of the inverter circuit 112_1. The oscillator drive delay time is a time that is the total of the response times of the NAND circuit 111 and the inverter circuit 112_1 shown in FIG. 11. There is also a delay time (latch drive delay time) from the time that the node n16 indicates the end of the time interval until the latch 104 actually outputs a signal that holds the state of the input clock. In the timing diagram of the time interval converter 15 shown in FIG. 10, in order to simplify the description, the description has been of the condition that ignores the oscillator drive delay time and the latch drive delay time. However, as described above, an oscillator drive delay time and a latch drive delay time actually exist. The oscillator drive delay time and the latch drive delay time are causes of error when the time interval converter 15 converts the time interval to a digital signal. For this reason, in the time interval converter 15, in order to reduce the error, it is desirable to set the conditions for the corresponding constituent elements so that the oscillator drive delay time and the latch drive delay time are as nearly the same value of delay time as possible.

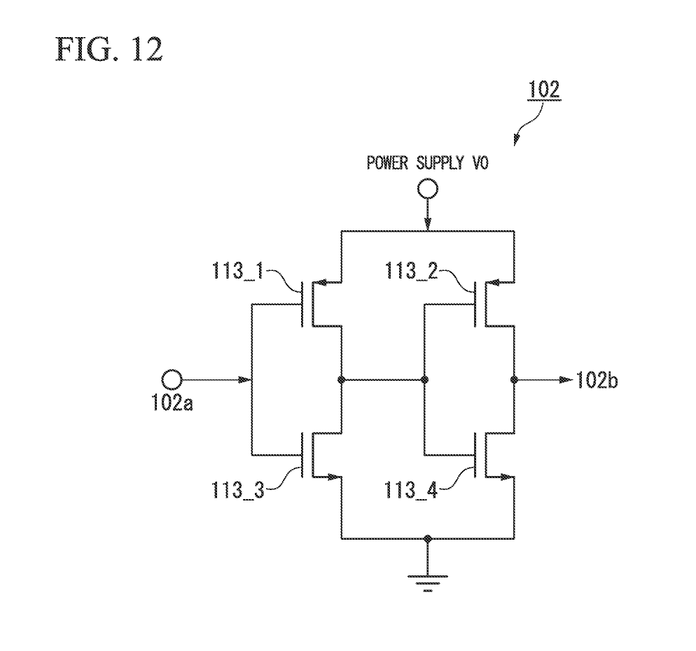

Next, the delay circuit 102 provided in the time interval converter 15 will be described. FIG. 12 is a circuit diagram showing an example of the constitution of a delay circuit 102 in the time interval converter 15 provided in the endoscope system 1 of the first preferred embodiment of the present invention. FIG. 12 shows an example of the constitution of the delay circuit 102 configured by four transistors. In FIG. 12, the delay circuit 102 has two PMOS transistors 113_1 and 113_2 and two NMOS transistors 113_3 and 113_4.

The PMOS transistor 113_1 has its gate terminal connected to the input terminal 102a of the delay circuit 102, its source terminal connected to the power supply V0, and its drain terminal connected to the gate terminal of the PMOS transistor 113_2, the gate terminal of the NMOS transistor 113_4, and the drain terminal of the NMOS transistor 113_3. The NMOS transistor 113_3 has its gate terminal connected to the input terminal 102a of the delay circuit 102, and its source terminal connected to ground and to the source terminal of the NMOS transistor 113_4. The PMOS transistor 113_2 has its source terminal connected to the power supply V0, and its drain terminal connected to the output terminal 102b of the delay circuit 102 and the drain terminal of the NMOS transistor 113_4. The NMOS transistor 113_4 has its drain terminal connected to the output terminal 102b of the delay circuit 102.

In this manner, in the delay circuit 102, the PMOS transistor 113_1 and the NMOS transistor 113_3 constitute the first inverter circuit stage and the PMOS transistor 113_2 and the NMOS transistor 113_4 constitute the following inverter circuit stage. This is a buffer circuit in which an even number of inverter circuit stages are connected in series. By using a buffer circuit in which an even number of inverter circuit stages are connected in series in the time interval converter 15, it is easy to configure a delay circuit.

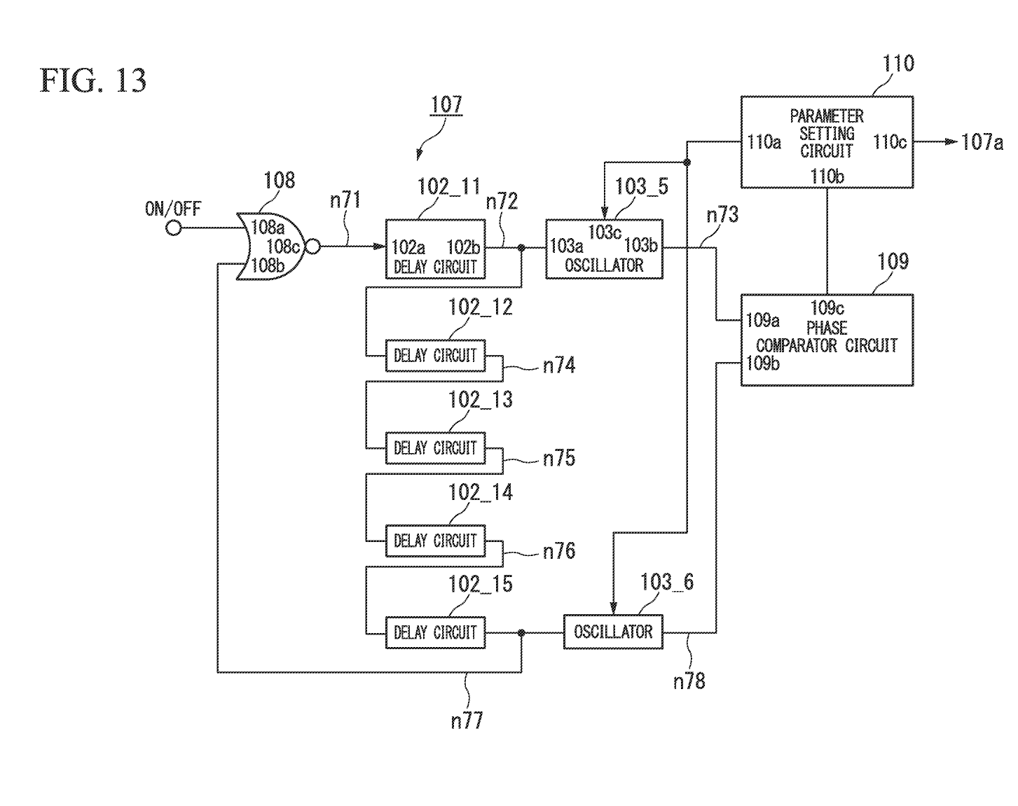

Next, the parameter adjustment circuit 107 provided in the time interval converter 15 will be described. FIG. 13 is a block diagram showing an example of the general constitution of the parameter adjustment circuit 107 in the time interval converter 15 provided in the endoscope system 1 of the first preferred embodiment of the present invention. In FIG. 13 the parameter adjustment circuit 107 has a negated logical summing circuit (NOR circuit) 108, five delay circuits 102_11 to 102_15, two oscillators 103_5 and 103_6, a phase comparator circuit 109, and a parameter setting circuit 110. When operation is started by on/off control of the ON/OFF input terminal the parameter adjustment circuit 107 outputs from the output terminal 107a a setting signal, which is a parameter for controlling the frequency of the clock output by the oscillator 103.

In the parameter adjustment circuit 107 shown in FIG. 13, each of the delay circuits 102_11 to 102_15 has the same constitution, function, and characteristics as the delay circuits 102 in the time interval converter 15 shown in FIG. 9. In the parameter adjustment circuit 107 shown in FIG. 13, the oscillators 103_5 and 103_6 have the same constitution, function, and characteristics as the oscillator 103 in the time interval converter 15 shown in FIG. 9. Therefore, in the following description, the description of the constitution, function, and characteristics of constituent elements provided in the time interval converter 15, which are the same as those shown in FIG. 9 will be omitted, and only constituent elements and operations that differ from the constituent elements provided in the time interval converter 15 shown in FIG. 9 will be described. In the following description, similar to the description of the time interval converter 15 shown in FIG. 9, when indicating any one of the delay circuits 102_11 to 102_15 of the parameter adjustment circuit 107 shown in FIG. 13, the expression “delay circuit 102” will be used, and when indicating either one of the oscillators 103_5 and 103_6, the expression “oscillator 103” will be used. Additionally, in the same manner, signals at the output terminals of each of the constituent elements within the parameter adjustment circuit 107 will be referred to as nodes.

The NOR circuit 108 inputs at the input terminal 108a the ON/OFF signal that is input to the ON/OFF input terminal, and inputs at the input terminal 108b the output signal output from the output terminal 102b of the delay circuit 102_15. The NOR circuit 108 outputs from the output terminal 108c as the node n71a signal that is the negated logical sum of the ON/OFF signal input to the input terminal 108a and the output signal of the delay circuit 102_15 input at the input terminal 108b.

As shown in FIG. 13, in the parameter adjustment circuit 107, the delay circuits 102_11 to 102_15 are connected in series. The node n71 that is input to the input terminal 102a of the first-stage delay circuit 102_11 is successively input to the input terminal 102a of the next stages of delay circuit 102 after delaying the node n71 by the time Δt. The node n71 that has been delayed by the time Δt the delay circuit 102_11 is input as the node n72 to the input terminal 103a of the oscillator 103_5, and the node n71 that has been delayed by the time 5Δt by the last stage of delay circuit 102_15 is input as the node n77 to the input terminal 103a of the oscillator 103_6.

More specifically, the delay circuit 102_11 outputs a signal that is the input node n71 after it delays it by the time Δt from the output terminal 102b as the node n72. The delay circuit 102_12 outputs from the output terminal 102b as the node n74 a signal that is the input node n72 delayed by the time Δt, that is, the signal that is the node n71 delayed by the time 2Δt. The delay circuit 102_13 outputs from the output terminal 102b as the node n75 a signal that is the input node n74 delayed by the time Δt, that is, the signal that is the node n71 delayed by the time 3Δt. The delay circuit 102_14 outputs from the output terminal 102b as the node n76 a signal that is the input node n75 delayed by the time Δt, that is, the signal that is the node n71 delayed by the time 4Δt. The delay circuit 102_15 outputs from the output terminal 102b as the node n77 a signal that is the input node n76 delayed by the time Δt, that is, the signal that is the node n71 delayed by the time 5Δt.

The oscillator 103_5 inputs at the input terminal 103a node n72 that is output from the output terminal 102b of the delay circuit 102_11, and inputs at the input terminal 103c a setting signal that is output from the output terminal 110a of the parameter setting circuit 110. At the timing of the node n72 switching from the low level to the high level, the oscillator 103_5 outputs from the output terminal 103b as the node n73 a clock having a frequency based on the setting signal input to the input terminal 103c. The oscillator 103_6 inputs to the input terminal 103a the node n77 output from the output terminal 102b of the delay circuit 102_15, and inputs to the input terminal 103c the setting signal that is output from the output terminal 110a of the parameter setting circuit 110. At the timing of the node n77 switching from the low level to the high level, the oscillator 103_6 outputs from the output terminal 103b as the node n78 a clock having a frequency based on the setting signal input to the input terminal 103c.

The phase comparator circuit 109 compares the clock at the node n73 input to the input terminal 109a and the clock at the node n78 input at the input terminal 109b, detects the time difference between the falling edge of the clock at the node n73 and the rising edge of the clock at the node n78, and outputs from the output terminal 109c a signal (hereinafter referred to as the time difference signal) that represents the detected time difference.

The parameter setting circuit 110, based on the time difference signal input to the input terminal 110b, calculates a parameter such that the time difference between the falling edge of the clock at the node n73 and the rising edge of the clock at the node n78 is made smaller. The parameter resulting from this calculation is output as a setting signal from the output terminal 110a and the output terminal 110c. The setting signal output from the output terminal 110a of the parameter setting circuit 110 is input to the input terminals 103c of each of the oscillators 103_5 and 103_6 as a parameter for controlling the frequency of the clocks output by the oscillators 103_5 and 103_6. The setting signal output from the output terminal 110c of the parameter setting circuit 110 is output from the output terminal 107a of the parameter adjustment circuit 107 as the parameter output from the parameter adjustment circuit 107, and is input to the input terminal 103c of the oscillator 103 provided in the time interval converter 15.

The parameter setting circuit 110 outputs the same parameter setting signal from both the output terminal 110a and the output terminal 110c. By doing this, the frequency of the clock output by the oscillator 103 provided in the time interval converter 15 and the frequency of each of the clocks output by the oscillators 103_5 and 103_6 in the parameter adjustment circuit 107 are made the same frequency.

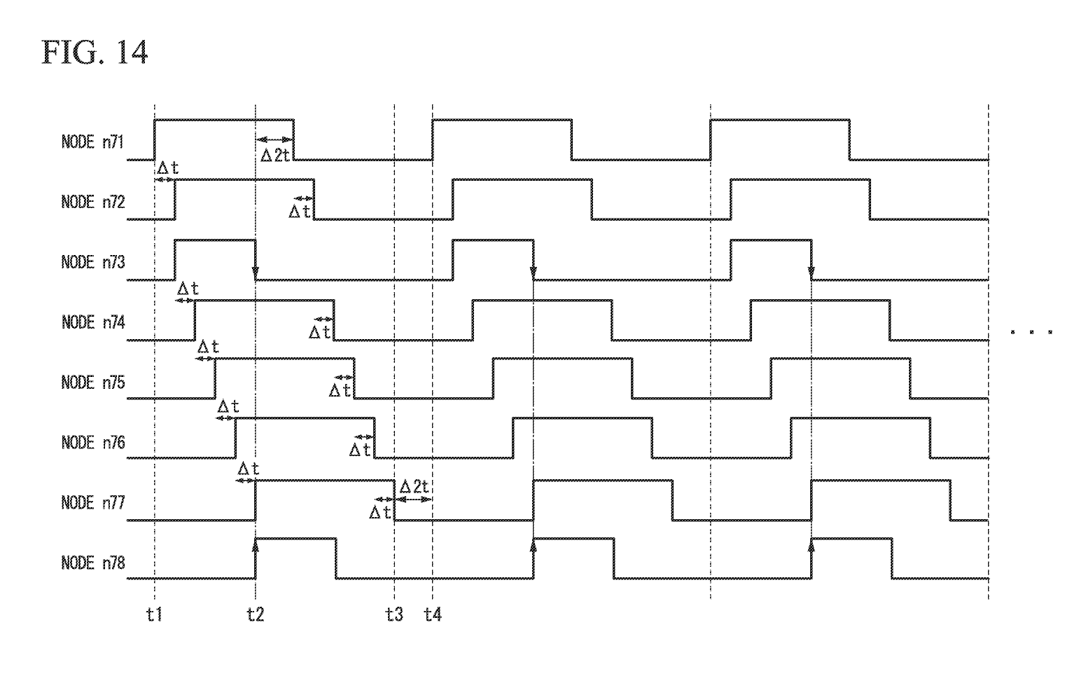

Next, the operation of the parameter adjustment circuit 107 provided in the time interval converter 15 will be described. FIG. 14 is a timing diagram showing the timing of the operation of the parameter adjustment circuit 107 in the time interval converter 15 provided in the endoscope system 1 of the first preferred embodiment of the present invention. FIG. 14 shows the timing at each node in the constitution of the parameter adjustment circuit 107 of FIG. 13.

When the signal at the ON/OFF input terminal switches from the high level to the low level and the parameter adjustment circuit 107 starts operating, at the time t1, the node n71 is switched from the low level to the high level. As a result, the node n72, which is the node n71 delayed by the time Δt of one stage of the delay circuit 102 is output from the delay circuit 102_11. Simultaneously with this, the oscillator 103_5 starts outputting a clock (node n73). The phase comparator circuit 109 successively detects the time difference between the falling edge of the clock at the node n73 and the rising edge of the clock at the node n78, and successively outputs the time difference signal to the parameter setting circuit 110.

Each of the delay circuits 102_12 to 102_15 successively delays the input node n72 by the time Δt of one stage of the delay circuit 102, and makes an output at the respective node of the nodes n74 to n77. Then, at the time t2, when the node n77 that is output from the delay circuit 102_11 switches from the low level to the high level, the oscillator 103_6 simultaneously starts outputting the clock (node n78). The node n78 that is output by the oscillator 103_6 from the time t2 is a clock that is the node n71 delayed by the amount of time 5Δt by the five stages of the delay circuit 102.

When this occurs, the parameter setting circuit 110, based on the time difference signal successively input from the phase comparator circuit 109, sets a parameter in the oscillators 103_5 and 103_6 in the direction that causes the timing of the falling edge of the node n73 and the timing of the rising edge of the node n78 coincide. By doing this, the frequency of the oscillators 103_5 and 103_6 approaches 1/(8Δt), that is, the period of time 8Δt.

This means that the time difference between the node n72 and the node n77 is the time 4Δt, as can be understood from the constitution of the parameter adjustment circuit 107 shown in FIG. 13. Therefore, the time difference between the timing of the falling edge of the node n73 and that of the rising edge of the node n78 is also the time 4Δt. By making the timing of the rising edge of the node n78 coincide with the timing of the falling edge of the node n73, the time period that is one-half of the period of the node n73 is also the time 4Δt. From this, the period of the clock at the node n73 becomes the time 8Δt. The clock at the node n78 has a period that is the time 8Δt and a phase that is the reverse of the clock at the node n73.

The parameter setting circuit 110 outputs a parameter for setting into the oscillators 103_5 and 103_6 from the output terminal 110c of the parameter setting circuit 110, that is, from the output terminal 107a of the parameter adjustment circuit 107, for the purpose of controlling the frequency of the clock output by the oscillator 103. By doing this, the parameter setting circuit 110 controls the frequency of the clock output by the oscillator 103 provided in the time interval converter 15 while simultaneously controlling the frequency of the clocks output by the oscillators 103_5 and 103_6.

At the time t2, when the node n77 output from the delay circuit 102_15 switches from the low level to the high level, the node n71 switches from the high level to the low level. With the timing diagram shown in FIG. 14, the delay time from the change of the node n77 input to the input terminal 108b of the NOR circuit 108 until the change of the node n71 at the output terminal 108c is shown as the time 2Δt. As a result, the node n72 also changes from the high level to the low level with a delay of time Δt of one stage of the delay circuit 102. Simultaneously, the oscillator 103_5 stops outputting the clock (node n73).

After the above, each of the delay circuits 102_{—}12 to 102_15 successively delays the input node n72 by the time Δt of one stage of the delay circuit 102, and makes an output at the respective node of the nodes n74 to n77. Then, at the time t3, when the node n77 output from the delay circuit 102_15 switches from the high level to the low level, the oscillator 1036 simultaneously stops outputting the clock (node n78).

At the time t3, the node n77 output from the delay circuit 102_15 switches from the high level to the low level, and at the time t4, which is the time delayed by 2Δt of the NOR circuit 108, the node n71 once again switches from the low level to the high level. After that, at the parameter adjustment circuit 107, similar to the times t1 to t4, the parameters for the oscillators 103_5 and 103_6 are repeatedly set by the parameter setting circuit 110 so that the frequencies of the oscillators 103_5 and 103_6 are 1/(8Δt), that is, so that the periods thereof are the time 8Δt.

In this manner, in the parameter adjustment circuit 107, the NOR circuit 108 and the delay circuits 102_11 to 102_15 form a ring oscillator and, based on the logical switching of the node n71, the operations at times t1 to t4 are repeated. Then, in the parameter adjustment circuit 107, by repeating the operations at times t1 to t4, parameters are repeatedly set in the oscillators 103_5 and 103_6 in the direction that causes the timing of the falling edge of the node n73 to coincide with that of the rising edge of the node n78. By doing this, the frequencies of the oscillators 103_5 and 103_6 converge to 1/(8Δt) (period of 8Δt). Then, in the time interval converter 15, the parameter at this time is also set repeatedly into the oscillator 103 to cause the frequency of the oscillator 103 to converge to 1/(8Δt) (period of 8Δt). When the frequency of the oscillator 103 converges to 1/(8Δt) (period of 8Δt), in the time interval converter 15, as shown in FIG. 10, the timing that is delayed by the time Δt from the rising edge of the node n15 and the timing of the falling edge of the node n12 coincide.

In this manner, in the time interval converter 15, a ring oscillator using the delay circuits (delay circuits 102_11 to 102_15) the same as the delay circuits 102 that delay the clock output by the oscillator 103 is configured within the parameter adjustment circuit 107. Then, in the time interval converter 15, clocks (the clock at the node n73 and the clock at the node n78) having the same frequency as the clock output by the oscillator 103 is generated within the parameter adjustment circuit 107, and the frequencies of the generated clocks are periodically adjusted. Then, a parameter that is the same as the parameter that adjusts the frequency of the clocks within the parameter adjustment circuit 107 is set with respect to the oscillator 103, so as to periodically adjust the frequency of the clock output by the oscillator 103. That is, rather than by using the clock output by the oscillator 103 directly to adjust the frequency, the same clock that is separately generated is used to indirectly adjust the frequency of the clock output by the oscillator 103.

By virtue of the above-described constitution, in the time interval converter 15 a plurality of clocks having different phases are generated, and the number of edges within the period of the time interval indicated by the electrical pulse signal is counted. By doing this, the time interval converter 15 can improve the resolution when converting the time interval indicated by the electrical pulse signal to a digital signal. As a result, the time interval converter 15 can convert an analog pixel signal of video captured by the image capturing unit 11 inside the object under examination to a high-resolution digital video signal.

Also, in the time interval converter 15, the parameter adjustment circuit 107 successively adjusts the frequency so that the frequency of the clock output by the oscillator 103 is constant. By doing this, in the time interval converter 15, variations (errors) of the interval between edges of neighboring clock edges (rising edges and falling edges), which are caused by variations of the ambient temperature or power supply voltage used by the time interval converter 15, individual device differences when manufacturing the time interval converter 15, or the like, are successively corrected, thereby enabling highly accurate conversion of the time interval indicated by an electrical pulse signal to a digital signal.

As described above, in the endoscope system 1 of the first preferred embodiment of the present invention, the time converter 12 and the transmitting unit 13 provided at the distal end 5 of the endoscope 2 convert the magnitude of an analog pixel signal captured by the image capturing unit 11 to a signal representing a time length, which is transmitted to the main unit 3. By doing this, in the endoscope system 1 of the first preferred embodiment of the present invention, it is not necessary to provide constituent elements that consume a large amount of electrical power within the distal end 5 of the endoscope 2 that is inserted into the object under examination, thereby reducing the electrical power consumption at the distal end 5 and suppressing the generation of heat.

Also, in the endoscope system 1 of the first preferred embodiment of the present invention, the time interval converter 15 provided in the main unit 3 converts the time interval of a signal that represents the length of transmission time, that is, the analog pixel signal captured by the image capturing unit 11 provided in the distal end 5 of the endoscope 2, to a binary digital signal, that is, to a digital video signal. By doing this, in the endoscope system 1 of the first preferred embodiment of the present invention, the analog pixel signal captured by the image capturing unit 11 can be converted to a digital video signal with high resolution and good accuracy.

### Second Preferred Embodiment

Next, an endoscope system of a second preferred embodiment of the present invention will be described. The overall constitution of the endoscope system of the second preferred embodiment of the present invention is the same as the endoscope system 1 of the first preferred embodiment shown in FIG. 1. In the following description, therefore, the description of overall constitution of the endoscope system of the second preferred embodiment of the present invention will be omitted, the internal functionality of the endoscope system of the second preferred embodiment of the present invention being specifically described. Also, in the following description, in the endoscope system of the second preferred embodiment of the present invention, constituent elements of the endoscope system 1 of the first preferred embodiment shown in FIG. 1 and constituent elements that have the same general constitution as constituent elements provided in the endoscope system 1 of the first preferred embodiment shown in FIG. 2 will be described using the same reference numerals.

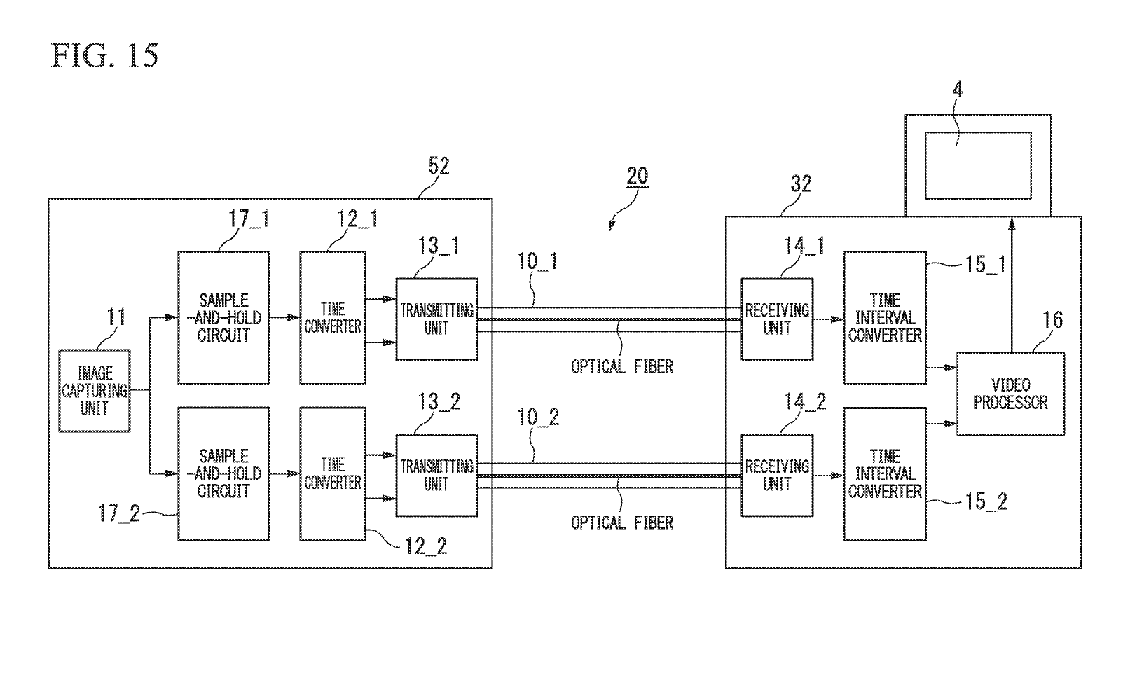

FIG. 15 is a block diagram showing an example of the general constitution of the various constituent elements of an endoscope system of the second preferred embodiment of the present invention. In FIG. 15, the endoscope system 20 has a distal end 52, a transfer section 10_1 and a transfer section 10_2, a main unit 32, and a monitor 4. FIG. 15 shows an example of the internal functions of the endoscope system 20 of the second preferred embodiment of the present invention. The endoscope system 20 of the second preferred embodiment of the present invention differs from the first preferred embodiment only in that it has the distal end 52 in place of the distal end 5, and has the main unit 32 in place of the main unit 3 in the example of the general constitution of the constituent elements of the endoscope system 1 of the first preferred embodiment shown in FIG. 2. By this difference in constitution, the transfer section 10 is divided in two. In FIG. 15 as well, similar to the example of the internal functions of the endoscope system 1 of the first preferred embodiment shown in FIG. 2, the operating unit 7 related to the operation of the movement of the distal end 52 is omitted, and the insertion section 6, the operating unit 7, the universal cord 8, and the connector 9 are collectively shown as the transfer sections 10_1 and 10_2.

The distal end 52 has an image capturing unit 11, two sample-and-hold circuits 17_1 and 172, two time converters 12_1 and 122, and two transmitting units 13_1 and 13_2. The image capturing unit 11 successively outputs to the sample-and-hold circuits 17_1 and 17_2 pixel signals that are captured within the object under examination. Because the image capturing unit 11 has the same functions and operation as the image capturing unit 11 provided in the distal end 5 of the endoscope system 1 of the first preferred embodiment, the detailed description thereof will be omitted.

At a pre-established timing, the sample-and-hold circuit 17_1 and the sample-and-hold circuit 17_2 sample and hold the pixel signals input thereto from the image capturing unit 11, and output the sampled and held pixel signals (hereinafter referred to as sampled signals) to the corresponding time converter 12_1 or 12_2, respectively. More specifically, the sample-and-hold circuit 17_1 samples and holds the pixel signals having odd numbers input from the image capturing unit 11 and outputs the sampled and held signal having odd numbers as a first sampled signal to the corresponding time converter 12_1 during the input of the next, even-numbered pixel signal from the image capturing unit 11. The sample-and-hold circuit 17_2 samples and holds the pixel signals having even numbers input from the image capturing unit 11 and outputs the sampled and held signal having even numbers as a second sampled signal to the corresponding time converter 12_2 during the input of the next, odd-numbered pixel signal from the image capturing unit 11.

The time converter 12_1 and the time converter 12_2 each outputs to the corresponding transmitting unit 13_1 or 13_2 time information for converting the magnitude of the sampled signal (pixel signal) input from the corresponding sample-and-hold circuit 17_1 or 17_2 to a time length. More specifically, the time converter 12_1 outputs time information of the first sampled signal (odd-numbered pixel signal) input from the corresponding sample-and-hold circuit 17_1 to the corresponding transmitting unit 13_1 as first time information. The time converter 12_2 outputs time information of the second sampled signal (even-numbered pixel signal) input from the corresponding sample-and-hold circuit 17_2 to the corresponding transmitting unit 13_2 as second time information. Because each of the time converters 12_1 and 12_2 has the same function and operation as the time converter 12 provided in the distal end 5 of the endoscope system 1 of the first preferred embodiment, the detailed description thereof will be omitted.

Each of the transmitting units 13_1 and 13_2, based on the time information input from the corresponding time converter 12_1 or 12_2, transmits an optical pulse signal that represents by a pulse width the magnitude of the sampled signal (pixel signal) More specifically, the transmitting unit 13_1 transmits an optical pulse signal based on the first time information input from the corresponding time converter 12_1 as the first optical pulse signal. The transmitting unit 13_2 transmits an optical pulse signal based on the second time information input from the corresponding time converter 12_2 as the second optical pulse signal. Because each of the transmitting units 13_1 and 13_2 has the same function and operation as the transmitting unit 13 provided in the distal end 5 of the endoscope system 1 of the first preferred embodiment, the detailed description thereof will be omitted.

Each of the transfer sections 10_1 and 10_2 guides (transfers), by internal optical waveguides, the optical pulse signal transmitted from the corresponding transmitting unit 13_1 or 13_2 to the outside of the distal end 52, that is, to the outside of the object under examination. FIG. 15 shows the example in which the optical waveguides inside the transfer sections 10_1 and 10_2 are optical fibers.

The main unit 32 has two receiving units 14_1 and 14_2, two time interval converters 15_1 and 15_2, and a video processor 16. Each of the receiving units 14_1 and 14_2 convert the optical pulse signal transmitted from the transmitting unit 13_1 or 13_2 via the corresponding transfer section 10_1 or 10_2 to an electrical pulse signal, which outputs it to the corresponding time interval converter 15_1 or 15_2. More specifically, the receiving unit 14_1 outputs as the first electrical pulse signal an electrical pulse signal that is converted from the first optical pulse signal transmitted from the transmitting unit 13_1 via the corresponding transfer section 10_1 to the corresponding time interval converter 15_1. The receiving unit 14_2 outputs as the second electrical pulse signal an electrical pulse signal that is converted from the second optical pulse signal transmitted from the transmitting unit 13_2 via the corresponding transfer section 10_2 to the corresponding time interval converter 15_2. Because the receiving units 14_1 and 14_2 have the same function and operation as the receiving unit 14 provided in the main unit 3 of the endoscope system 1 of the first preferred embodiment, the detailed description thereof will be omitted.

Each of the time interval converters 15_1 and 15_2, based on the electrical pulse signal input from the corresponding receiving unit 14_1 or 14_2, converts the time interval represented by the electrical pulse signal to a digital signal, and outputs the digital signal to the video processor 16. More specifically, the time interval converter 15_1 outputs as the first digital signal to the video processor 16 a digital signal converted from a time interval represented by the first electrical pulse signal input from the corresponding receiving unit 14_1. The time interval converter 15_2 outputs as the second digital signal to the video processor 16 a digital signal converted from a time interval represented by the second electrical pulse signal input from the corresponding receiving unit 14_2. Because the time interval converters 15_1 and 15_2 have the same function and operation as the time interval converter 15 provided in the main unit 3 of the endoscope system 1 of the first preferred embodiment, the detailed description thereof will be omitted.

The video processor 16 processes the first digital signal and the second digital signal input from the time interval converters 15_1 and 15_2 and, based on a digital signal that combines the first digital signal and the second digital signal, displays on the monitor 14 an image that has been captured within the object under examination by the image capturing unit 11 at the distal end 52.

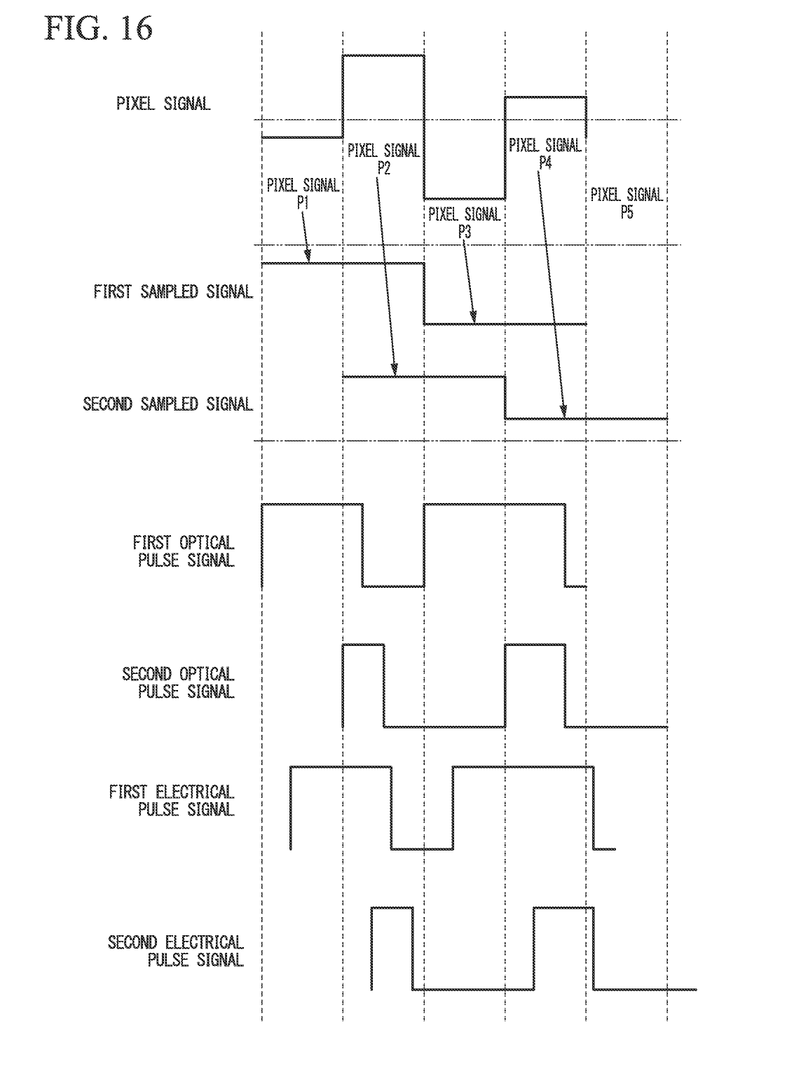

The operation of the endoscope system 20 of the second preferred embodiment of the present invention will be described. FIG. 16 is a timing diagram showing the relationship between the various signals in the endoscope system 20 of the second preferred embodiment of the present invention. In FIG. 16, the pixel signals show one example of pixel signals (analog electrical signals) responsive to a video image within an object under examination that are output by the image capturing unit 11. FIG. 16 shows the timing for the case of sequential output from the image capturing unit 11 of pixel signals of four pixels (pixel signals P1 to P4). The first optical pulse signal shows an example of an optical pulse signal transmitted by the transmitting unit 13_1 and the second optical pulse signal shows schematically an example of an optical pulse signal transmitted by the transmitting unit 13_2. The first electrical pulse signal shows an example of the electrical pulse signal that is converted to an electrical signal by the receiving unit 14_1 from the first optical signal transferred via the transfer section 10_1 and that is output to the time interval converter 15_1. The second electrical pulse signal shows an example of the electrical pulse signal that is converted to an electrical signal by the receiving unit 14_2 from the second optical signal transferred via the transfer section 10_2 and that is output to the time interval converter 15_2.

The image capturing unit 11 successively outputs pixel signals (pixel signals P1 to P4) having magnitudes (voltages) that correspond to the amounts of light (light intensities) of images captured by the respective pixels. The sample-and-hold circuit 17_1 samples and holds the odd-numbered pixel signal P1 or P3 output by the image capturing unit 11 and outputs the pixel signal as the first sampled signal during the input of the next, even-numbered pixel signal P2 or P4 from the image capturing unit 11. The sample-and-hold circuit 17_2 samples and holds the even-numbered pixel signal P2 or P4 output by the image capturing unit 11 and outputs the pixel signal as the second sampled signal during the input of the next, odd-numbered pixel signal P3 or P5 from the image capturing unit 11.

The time converter 12_1, responsive to the magnitudes of the voltage values of the first sampled signal output by the sample-and-hold circuit 17_1, generates each of the first time information (pulse signals) and the transmitting unit 13_1 generates a first optical pulse signal having a pulse width responsive to each of the generated first time information. The time converter 12_2, responsive to the magnitudes of the voltage values of the second sampled signal output by the sample-and-hold circuit 17_2, generates each of the second time information (pulse signals) and the transmitting unit 13_2 generates a second optical pulse signal having a pulse width responsive to each of the generated second time information.

In the example of the optical pulse signals shown in FIG. 16, the case shown is one in which the lower is the voltage value of the sampled signal (pixel signal), the wider is high-level pulse width, and the higher is the voltage value of the sampled signal (pixel signal), the narrower is the high-level pulse signal. That is, in the example of the optical pulse signals shown in FIG. 16, the time from each of the rising edges to each of the falling edges represents the magnitude of the voltage value of the corresponding sampled signals (pixel signals P1 to P4).

The transmitting unit 13_1 transmits to the main unit 32 the first optical pulse signals generated based on the first time information output by the time converter 12_1. The transmitting unit 13_2 transmits to the main unit 32 the second optical pulse signals generated based on the second time information output by the time converter 12_2. The first optical pulse signal transmitted by the transmitting unit 13_1 reaches the receiving unit 14_1 via the transfer section 10_1, is converted to the first electrical pulse signal by the receiving unit 14_1, and is input to the time interval converter 15_1. The second optical pulse signal transmitted by the transmitting unit 13_2 reaches the receiving unit 14_2 via the transfer section 10_2, is converted to the second electrical pulse signal by the receiving unit 14_2, and is input to the time interval converter 15_2. By doing this, the first time information (pulse signals) output by the time converter 12_1 is successively input to the time interval converter 15_1 after a fixed delay time, and the second time information (pulse signals) output by the time converter 12_2 is successively input to the time interval converter 15_2 after a fixed delay time.

The time interval converter 15_1 converts the magnitude of the time width (time interval) between the rising edge and the falling edge of the input first electrical pulse signal, that is, the magnitude of the voltage value of each of the pixel signals of the odd-numbered pixel signal P1 or P3 to a binary first digital signal, which is successively output to the video processor 16. The time interval converter 15_2 converts the magnitude of the time width (time interval) between the rising edge and the falling edge of the input second electrical pulse signal, that is, the magnitude of the voltage value of each of the pixel signals of the even-numbered pixel P2 or P4 to a binary second digital signal, which is successively output to the video processor 16.

The video processor 16 displays on the monitor 4 an image that is the result of processing a digital signal that combines the first digital signal and the second digital signal successively input form the time interval converters 15_1 and 15_2.

As described above, in the endoscope system 20 of the second preferred embodiment of the present invention, by sampling and holding pixel signals input from the image capturing unit 11, odd-numbered and even-numbered pixel signals are processed in parallel. By doing this, the time width (time interval) to which the time converters 12_1 and 12_2 convert the magnitudes of the pixel signals to each time information can be lengthened. By doing this, the time interval converter 15 provided in the main unit 32 can increase the number of effective bits when converting the transferred time information to digital signals. The result of this is that, in the endoscope system 20 of the second preferred embodiment of the present invention, the digital signal resolution is improved and the signal quality when converting analog pixel signals to a digital video signal can be improved.

The description of the endoscope system 20 of the second preferred embodiment of the present invention has been the case in which, by sampling and holding the pixel signals input from the image capturing unit 11, odd-numbered and even-numbered pixel signals are processed in parallel. Specifically, this is the case in which the two sample-and-hold circuits 17_1 and 17_2, the two time converters 12_1 and 12_2, and the two transmitting units 13_1 and 13_2 are provided in the distal end 52, and the two receiving units 14_1 and 14_2 and the two time interval converters 15_1 and 15_2 are provided in the main unit 32. However, the pixel signals processed in parallel are not restricted to the odd-numbered and even-numbered signals, and a constitution may be adopted that processed a greater number of pixel signals in parallel. In such a case, the number of sample-and-hold circuits 17, time converters 12, and transmitting units 13 provided in the distal end 52 and the number of receiving units 14 and time interval converters 15 provided in the main unit 32 are changed in accordance with the number of pixel signals processed in parallel, and the video processor 16 combines and processes the digital signals successively input from each of the time interval converters 15. By doing this, time interval converters 15 provided in the main unit 32 can increase the number of effective bits when converting the transferred time information to digital signals, thereby providing a further improvement in the digital signal resolution and enabling further improvement in the signal quality when converted the analog pixel signals to a digital video signal.

### Third Preferred Embodiment

Next, an endoscope system of a third preferred embodiment of the present invention will be described. The overall constitution of the endoscope system of the third preferred embodiment of the present invention is the same as the endoscope system 1 of the first preferred embodiment in terms of constitution and functionality shown in FIG. 1. In the description to follow, therefore, description of the overall constitution of the endoscope system of the third preferred embodiment of the present invention will be omitted, and the internal functionality of the endoscope system of the third preferred embodiment of the present invention will be specifically described. Also, in the following description, of the constituent elements provided in the endoscope system of the third preferred embodiment of the present invention, constituent elements of the endoscope system 1 of the first preferred embodiment shown in FIG. 1 and constituent elements that have the same general constitution as constituent elements provided in the endoscope system 1 of the first preferred embodiment as shown in FIG. 2 will be described using the same reference numerals.

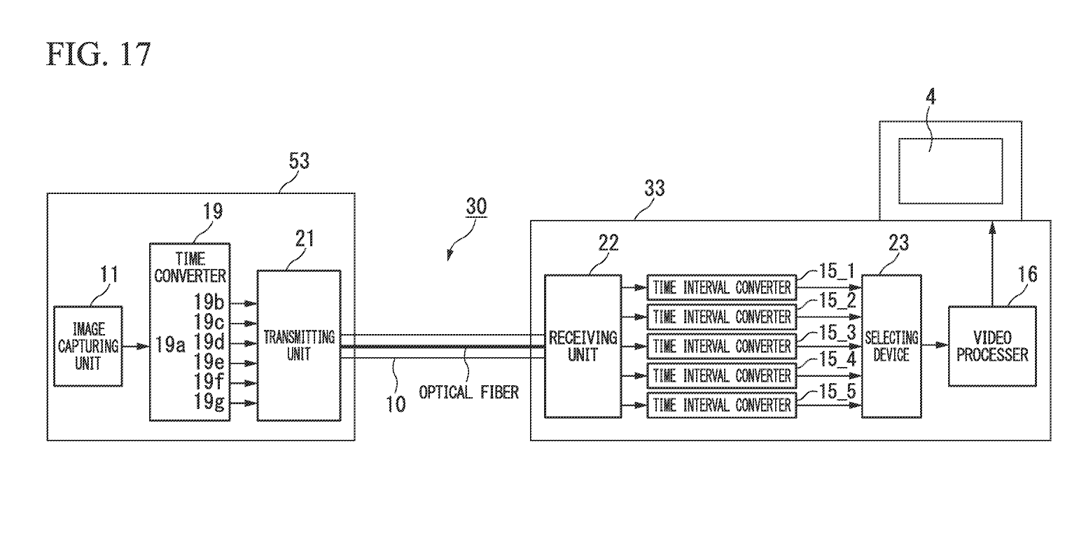

FIG. 17 is a block diagram showing an example of the general constitution of the various constituent elements in an endoscope system of the third preferred embodiment of the present invention. In FIG. 17, the endoscope system 30 has a distal end 53, a transfer section 10, a main unit 33 and a monitor 4. FIG. 17 shows an example of the internal functions of the endoscope system 30 of the third preferred embodiment of the present invention. The endoscope system 30 of the third preferred embodiment of the present invention differs from the first preferred embodiment only in that it has the distal end 53 in place of the distal end 5, and has the main unit 33 in place of the main unit 3 in the example of the general constitution of the constituent elements of the endoscope system 1 of the first preferred embodiment shown in FIG. 2. In FIG. 17, similar to the example of the internal functions of the endoscope system 1 of the first preferred embodiment shown in FIG. 2, the operating unit 7 related to the operation of the movement of the distal end 53 is omitted, and the insertion section 6, the operating unit 7, the universal cord 8, and the connector 9 are collectively shown as the transfer section 10.

The distal end 53 has an image capturing unit 11, a time converter 19, and a transmitting unit 21. The image capturing unit 11 outputs captured pixel signals inside the object under examination to the time converter 19. Because the image capturing unit 11 has the same functions and operation as the image capturing unit 11 provided in the distal end 5 of the endoscope system 1 of the first preferred embodiment, the detailed description thereof will be omitted.

The time converter 19 outputs to the transmitting unit 21 each of a plurality of time information for the purpose of converting the magnitudes of pixel signals input from the image capturing unit 11 to a plurality of different time lengths. More specifically, the time converter 19 generates a plurality of pulse signals for representing the magnitudes of pixel signals input from the image capturing unit 11 as a plurality of different time widths (time intervals). The time converter 19 in the endoscope system 30 shown in FIG. 17 is an example for the case of representing the magnitude of the pixel signals by five types of time information.

The time converter 19 inputs at the input terminal 19a pixel signals output from the image capturing unit 11, and outputs from the output terminal 19b a pulse signal that represents the timing of the start of a time interval responsive to the magnitude of the input pixel signal. The time converter 19 also outputs at the output terminals 19c to 19g five types of pulse signals that represent the timing of the end of a time interval responsive to the magnitude of the input pixel signal. In this case, the time converter 19 is configured so that the time widths of the pulse signals output from the respective output terminals 19d to 19g are pulse widths that are two times, three times, four times, and five times the time width represented by the pulse signal output from the output terminal 19c. The constitution of the time converter 19 and the method of the time converter 19 generating the five types of time information from the pixel signals will be described in detail later.

The transmitting unit 21, based on the time information input from the time converter 19, transmits an optical pulse signal that represents the magnitude of the pixel signal by a pulse width. More specifically, the transmitting unit 21, based on the five types of time interval input from the time converter 19, generates one optical pulse signal and transmits the generated optical pulse signal. The method of the transmitting unit 21 generating one optical pulse signal from a plurality of types of time information will be described in detail later.

The transfer section 10, using an optical waveguide provided therewithin, guides (transfers) the optical pulse signal transmitted from the transmitting unit 21 to the outside of the distal end 53, that is, to the outside of the object under examination. FIG. 17 shows the case in which, similar to the transfer section 10 of the endoscope system 1 of the first preferred embodiment shown in FIG. 2, the optical waveguide provided inside the transfer section 10 is an optical fiber.

The main unit 33 has a receiving unit 22, five time interval converters 15_1 to 15_5, a selecting device 23, and a video processor 16. In the description to follow, when indicating any one time interval converter of the time interval converters 15_1 to 15_5, the expression “time interval converter 15” will be used. The receiving unit 22 converts the optical pulse signal transmitted by the transmitting unit 21 via the transfer section 10 to a plurality of electrical pulse signals expressed as a plurality of different time lengths, and outputs the converted electrical pulse signals to the respective time interval converters 15. The receiving unit 22 in the endoscope system 30 shown in FIG. 17 shows the example for the case in which the five types of electrical pulse signals representing the magnitude of the pixel signals are output to the respective time interval converter of the time interval converters 15_1 to 15_5. Because, with the exception of outputting a plurality of electrical pulse signals, the receiving unit 22 is the same as the receiving unit 14 provided in the main unit 3 of the endoscope system 1 of the first preferred embodiment, the detailed description thereof will be omitted.

Each of the time interval converters 15_1 to 15_5, based on the corresponding input electrical pulse signal input from the receiving unit 22, converts the time interval represented by the electrical pulse signal to a binary digital signal, and outputs each of the converted digital signals to the selecting device 23. Each of the time interval converters 15_1 to 15_5 corresponds to respective time widths of five types represented by the pulse signals output from the output terminals of the time interval converter 19. The time interval converters 15_1 to 15_5 in the endoscope system 30 shown in FIG. 17 are an example of the constitution in which the time interval converters 15_1 to 15_5 each correspond to five types of time information output by the time converter 19.

More specifically, the time interval converter 15_1 corresponds to the time width of the time information (pulse signals) output from the output terminal 19b and the output terminal 19c of the time converter 19, and outputs a digital signal representing a one-times time width. The time interval converter 15_2 corresponds to the time width of the time information (pulse signals) output from the output terminal 19b and the output terminal 19d of the time converter 19, and outputs a digital signal representing a 2-times time width. The time interval converter 15_3 corresponds to the time width of the time information (pulse signals) output from the output terminal 19b and the output terminal 19e of the time converter 19, and outputs a digital signal representing a 3-times time width. The time interval converter 15_4 corresponds to the time width of the time information (pulse signals) output from the output terminal 19b and the output terminal 19f of the time converter 19, and outputs a digital signal representing a 4-times time width. The time interval converter 15_5 corresponds to the time width of the time information (pulse signals) output from the output terminal 19b and the output terminal 19g of the time converter 19, and outputs a digital signal representing a five-times time width. Because each of the time interval converters 15_1 to 15_5 has the same functions and operation as the time interval converter 15 provided in the main unit 3 of the endoscope system 1 of the first preferred embodiment, the detailed description thereof will be omitted.

The selecting device 23 selects, from among the plurality of digital signals input from each of the time interval converters 15_1 to 15_5, a digital signal of the digital signals successfully converted within a pre-established video signal processing time which had the longest time interval before conversion, and processes the selected digital signal to output it to the video processor 16. The selecting device 23 shown in the endoscope system 30 shown in FIG. 17 shows an example of a constitution in which one digital signal is selected from among five types of digital signals representing the magnitude of the pixel signal. The processing with respect to the digital signal selected by the selecting device 23, even in the case of selecting a digital signal input from one of the time interval converters 15 among the time interval converters 15_1 to 15_5, is processing for the purpose of processing a digital signal representing a pixel signal of the same magnitude with the same scale. By doing this, regardless of from which one of the time interval converters 15 the digital signal that represents the pixel signal of the same magnitude is output, the same digital signal is output from the selecting device 23, and the video processor 16 can display the image based on the digital signal on the monitor 14, with the same processing.

More specifically, consider the processing when the selecting device 23 takes as the digital signal to be output to the video processor 16 the digital signal input from the time interval converter 15_1, for example, having a constant given multiplier such as 60-times, that is, a digital signal having a time width of a one-times digital signal multiplied by 60, which is the minimum common multiplier from the time widths of one-times to five-times. In this case, if the selecting device 23 selects the digital signal input from the time interval converter 15_1 as the maximum digital signal, that is, selects the digital signal based on the time information representing the one-times time width, which is output by the time converter 19, the selected digital signal is multiplied by 60 and output to the video processor 16. If the selecting device 23 selects the digital signal input from the time interval converter 15_2 as the maximum digital signal, that is, selects the digital signal based on the time information representing the two-times time width, which is output by the time converter 19, the selected digital signal is multiplied by 30 and output to the video processor 16. If the selecting device 23 selects the digital signal input from the time interval converter 15_3 as the maximum digital signal, that is, selects the digital signal based on the time information representing the three-times time width, which is output by the time converter 19, the selected digital signal is multiplied by 20 and output to the video processor 16. If the selecting device 23 selects the digital signal input from the time interval converter 15_4 as the maximum digital signal, that is, selects the digital signal based on the time information representing the four-times time width, which is output by the time converter 19, the selected digital signal is multiplied by 15 and output to the video processor 16. If the selecting device 23 selects the digital signal input from the time interval converter 15_5 as the maximum digital signal, that is, selects the digital signal based on the time information representing the five-times time width, which is output by the time converter 19, the selected digital signal is multiplied by 12 and output to the video processor 16. By doing this, regardless of from which one of the time interval converters 15_1 to 15_5 the digital signal to be output from the selecting device 23 to the video processor 16 is selected, a digital signal representing a pixel signal of the same scale is obtained.

In this manner, by the selecting device 23 performing multiplication processing with respect to the digital signal that is output, responsive to a characteristic (multiplier) when the time information is output by the time converter 19, at the video processor 16, regardless of from which time interval converter 15 of the time interval converters 15_1 to 15_5 the digital signal is output, processing can be done with the same scale. The method of the selecting device 23 selecting one digital signal from the five types of digital signals will be described in detail later.

The video processor 16 processes the digital signal input from the selecting device 23 and, based on the digital signal, displays on the monitor 4 an image from inside the object under examination captured by the image capturing unit 11 of the distal end 53.

At this point, the method of the time converter 19 and the transmitting unit 21 provided in the distal end 53 converting the magnitude of a pixel signal input from the image capturing unit 11 to five types of time lengths and transmitting the results, and the method of the selecting device 23 provided in the main unit 23 selecting one digital signal from among five types of digital signals will be described by specific examples.

### Example of a Method of Converting the Magnitude of a Pixel Signal to Five Types of Time Lengths

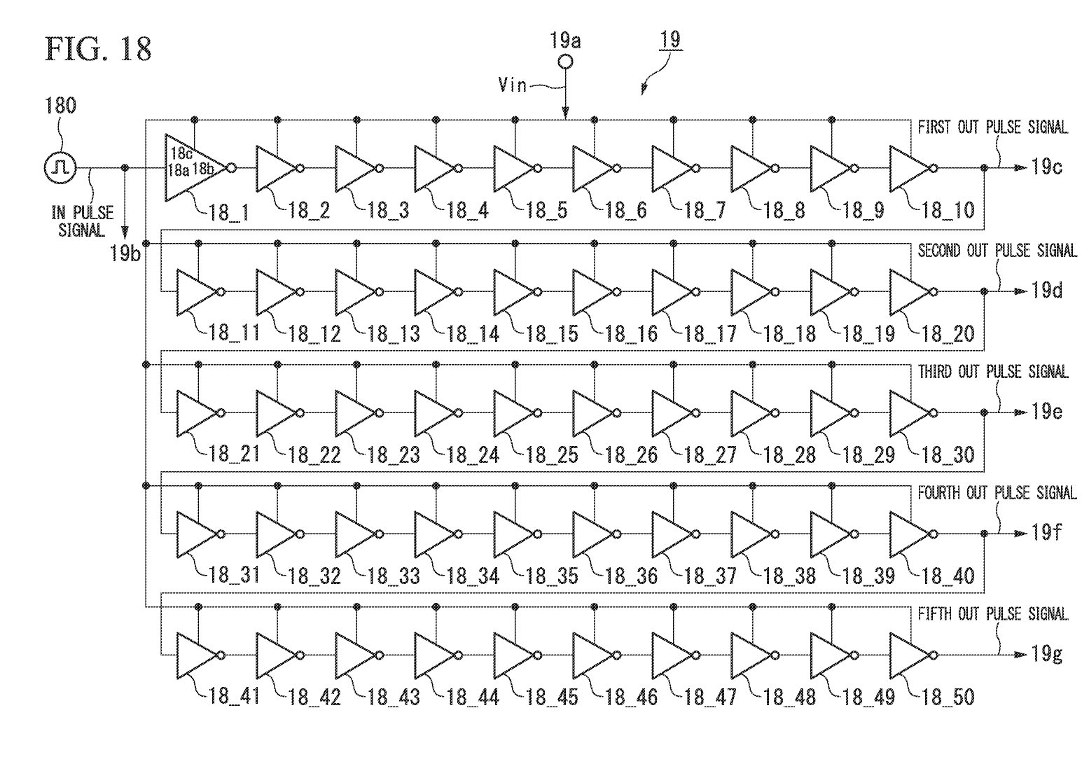

First, an example of the time converter 19 assumed to be provided in the distal end 53 of the endoscope 2 of the endoscope system 30 of the third preferred embodiment of the present invention will be described. FIG. 18 is a circuit diagram of an example of the general constitution of a time converter 19 provided in the endoscope system 30 of the third preferred embodiment of the present invention. FIG. 18 shows an example of the constitution of the time converter 19 in which 50 inverter circuits are connected in series. In FIG. 18, the time converter 19 has a pulse generator 180 and 50 inverter circuits 18_1 to 18_50. The time converter 19 is different only in that it increases the number of inverter circuits 18 of the time converter 12 assumed to be provided in the endoscope system 1 of the first preferred embodiment shown in FIG. 4, and outputs an OUT pulse signal for each 10 inverter circuits 18. In the description to follow, therefore, constituent elements having the same functions and operation as in the time converter 12 are assigned the same reference numerals, and the detailed descriptions of those constituent elements of the time converter 19 will be omitted. When indicating any one of the inverter circuits 18_1 to 18_50, similar to the time converter 12 shown in FIG. 4, the expression “inverter circuit 18” will be used.

Each time a pixel signal corresponding to a pixel of the solid-state image device provided in the image capturing unit 11 is input to the time converter 19, the pulse generator 180 outputs an IN pulse signal for the purpose of starting the conversion of the input pixel signal of each pixel signal to a time.

A pixel signal input to the input terminal 19a of the time converter 19 is input as the power supply Vin to the power supply terminals 18c of all of the inverter circuits 18. Each of the inverter circuits 18 delays a signal that is the logical negation of the IN pulse signal input to the input terminal 18a or of the output signal of the previous stage of the inverter circuit 18 by a delay time responsive to the voltage value of the power supply Vin input to the power supply terminal 18c and outputs the signal from the output terminal 18b.

By doing this, a first OUT pulse signal that is the IN pulse signal delayed by a delay time for 10 stages is output from the output terminal 18b of the inverter circuit 18_10. A second OUT pulse signal that is the IN pulse signal delayed by a delay time for 20 stages, that is, by twice the delay time of the first OUT pulse signal, is output from the output terminal 18b of the inverter circuit 18_20. A third OUT pulse signal that is the IN pulse signal delayed by a delay time for 30 stages, that is, by three times the delay time of the first OUT pulse signal, is output from the output terminal 18b of the inverter circuit 18_30. A fourth OUT pulse signal that is the IN pulse signal delayed by a delay time for 40 stages, that is, by four times the delay time of the first OUT pulse signal, is output from the output terminal 18b of the inverter circuit 18_40. A fifth OUT pulse signal that is the IN pulse signal delayed by a delay time for 50 stages, that is, by five times the delay time of the first OUT pulse signal, is output from the output terminal 18b of the inverter circuit 18_50.

The time converter 19 outputs from the output terminals 19b to 19g, as time information for converting the magnitude of the pixel signal input from the image capturing unit 11 to a time length, the IN pulse signal output by the pulse generator 180, the first OUT pulse signal output by the inverter circuit 18_10, the second OUT pulse signal output by the inverter circuit 18_20, the third OUT pulse signal output by the inverter circuit 18_30, the fourth OUT pulse signal output by the inverter circuit 18_40, and the fifth OUT pulse signal output by the inverter circuit 18_50.

The IN pulse signal output from the output terminal 19b of the time converter 19 is a pulse signal representing the timing of the start of the time interval responsive to the magnitude of the input pixel signal. The first OUT pulse signal to the fifth OUT pulse signal output from the respective output terminals 19c to 19g are each pulse signals representing the timing of the end of the time interval responsive to the magnitude of the input pixel signal. In the description that follows, when indicating any one of the first OUT pulse signal to the fifth OUT pulse signal, the expression “OUT pulse signal” will be used.

By the above-described constitution, the time converter 19 outputs from the output terminals 19b to 19g the five types of time information representing the magnitude of a pixel signal, that is, the five types of time information that are the one-times to five-times time width when the time width indicated by the pulse signal output from the output terminal 19c is taken as being one-times.

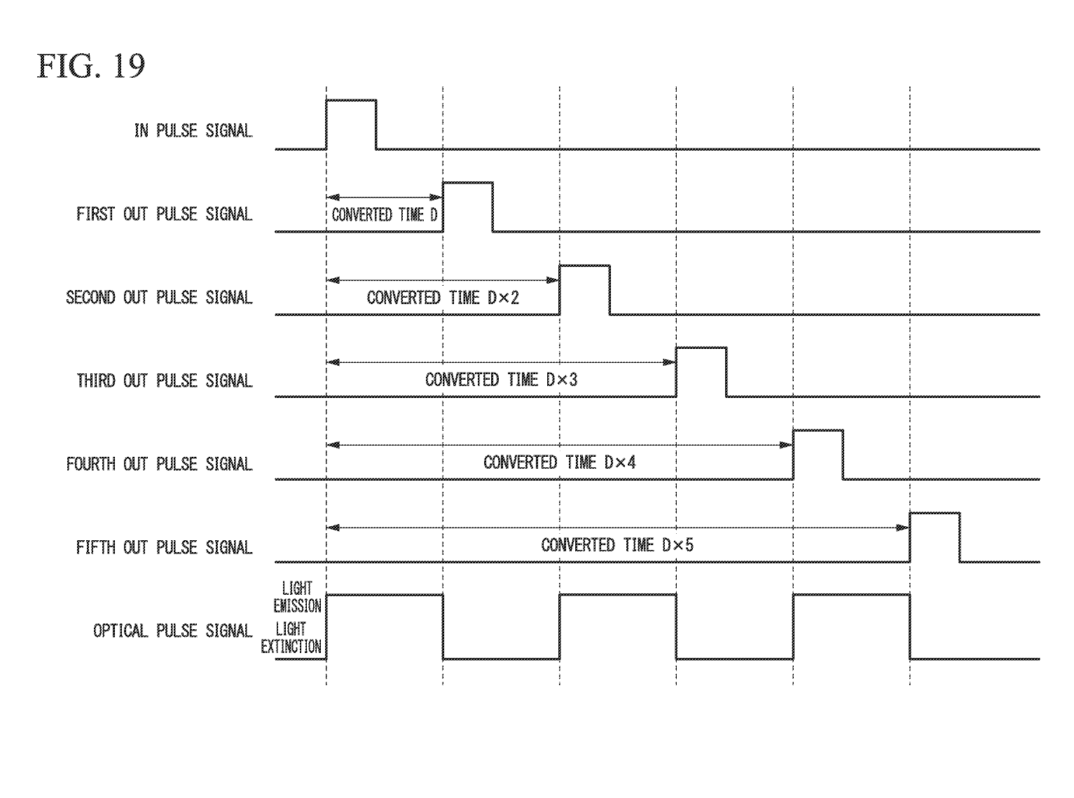

Next, the method in the endoscope system 30 of the third preferred embodiment of the present invention of generating the optical pulse signal representing the magnitude of the pixel signal by a pulse width, based on the time information will be described. FIG. 19 is a timing diagram showing the method of generating the optical pulse signal in the endoscope system 30 of the third preferred embodiment of the present invention. FIG. 19 shows the timing in the case in which optical pulse signals are generated in response to the pixel signal of one pixel input from the image capturing unit 11.

As shown in FIG. 19, after a pixel signal that is to be converted to time is input from the image capturing unit 11 to the input terminal 19a of the time converter 19 as the power supply Vin, the time converter 19 outputs as the time information from the output terminal 19b the IN pulse signal output by the pulse generator 180. Also, as shown in FIG. 19, the time converter 19 outputs the first OUT pulse signal output by the inverter circuit 18_10, the second OUT pulse signal output by the inverter circuit 18_20, the third OUT pulse signal output by the inverter circuit 18_30, the fourth OUT pulse signal output by the inverter circuit 18_40, and the fifth OUT pulse signal output by the final stage inverter circuit 18_50 as the time information from the output terminals 19c to 19g.

In this case, if the time difference between the timing of the rising edge of the IN pulse signal output by the time converter 19 and the timing of the rising edge of the first OUT pulse signal is taken as the converted time D, the time difference between the timing of the rising edge of the IN pulse signal and the rising edges of the second OUT pulse signal to the fifth OUT pulse signal are, respectively, two times to five times the converted time D.

The transmitting unit 21, in response to the IN pulse signal from the time converter 19 and the first OUT pulse signal to the fifth OUT pulse signal, generates optical pulse signals that represent each of the converted times by a pulse width. FIG. 19 shows the case in which, for each of the timing of the rising edges of the IN pulse signal and the first OUT pulse signal to the fifth OUT pulse signal, the transmitting unit 21 repeats light emission and extinction, so as to generate an optical pulse signal that has all of the time information (five types) in one channel. More specifically, the first light emission occurs at the timing of the rising edge of the IN pulse signal, the first light extinction occurs at the timing of the rising edge of the first OUT pulse signal, the second light emission occurs at the timing of the rising edge of the second OUT pulse signal, the second light extinction occurs at the rising edge of the third OUT pulse signal, the third light emission occurs at the timing of the rising edge of the fourth OUT pulse signal, and the third light extinction occurs at the timing of the rising edge of the fifth OUT pulse signal, so as to generate an optical pulse signal that has all the time information in one channel.

The receiving unit 22 converts the optical pulse signal transmitted from the transmitting unit 21 via the transfer section 10 to five types of electrical pulse signals, and outputs the converted five types of electrical pulse signals each to the corresponding time interval converters 15. More specifically, the receiving unit 22 outputs an electrical pulse signal representing the timing from the first light emission to the first light extinction of the optical pulse signal, that is, an electrical pulse signal representing the converted time D, to the time interval converter 15_1. The receiving unit 22 outputs an electrical pulse signal representing the timing from the first light emission to the second light emission of the optical pulse signal, that is, an electrical pulse signal representing the converted time D×2, which is two times of converted time D, to the time interval converter 15_2. The receiving unit 22 outputs an electrical pulse signal representing the timing from the first light emission to the second light extinction of the optical pulse signal, that is, an electrical pulse signal representing the converted time D×3, which is three times of converted time D, to the time interval converter 15_3. The receiving unit 22 outputs an electrical pulse signal representing the timing from the first light emission to the third light emission of the optical pulse signal, that is, an electrical pulse signal representing the converted time D×4, which is four times of converted time D, to the time interval converter 15_4. The receiving unit 22 outputs an electrical pulse signal representing the timing from the first light emission to the third light extinction of the optical pulse signal, that is, an electrical pulse signal representing the converted time D×5, which is five times of converted time D, to the time interval converter 15_5.

FIG. 19 shows a timing diagram for the case of the time converter 19 outputting all of the IN pulse signals and first to fifth OUT pulse signals, that is, all of the five types of time information. However, in actuality, because a plurality of pixel signals to be converted to time are successively input from the image capturing unit 11 for each individual pixel, the amount of time that the time converter 19 can use in the output of time information based on the magnitudes of the input pixel signals is the same time, regardless of the magnitude of the pixel signal. That is, the amount of time that the time converter 19 can use for outputting time information responsive to the magnitude of a pixel signal for one pixel is limited to a pre-established period of time (hereinafter referred to as the “video signal processing time”). For this reason, for example, if the pixel signal (power supply Vin) voltage value is small, the IN pulse signal output by the signal generator 180 might not pass through all of the inverter circuits 18 provided in the time converter 19, thereby preventing output of all the OUT pulse signals from the first OUT pulse signal to the fifth OUT pulse signal.

Given the above, the time converter 19 is provided with a function that resets the processing of conversion of the currently input pixel signal to time information each time the video signal processing time elapsed. Even if all five types of time information are not output, the time converter 19 resets the processing for each period of the video signal processing time, so as to prepare for the processing for conversion to time information of the next pixel signal to be input. By doing this, the time converter 19 outputs the IN pulse signal and the OUT pulse signals up to the inverter circuit 18 to which the IN pulse signal has passed as time information, each time period of the video signal processing time.

By doing this, among the time interval converters 15_1 to 15_5, there might be a time interval converter 15 to which an electrical pulse signal form the receiving unit 22 is not input. For this reason, the selecting device 23 selects from the plurality of digital signals input from the time interval converters 15_1 to 15_5 the maximum digital signal obtained within the video signal processing time and outputs the signal to the video processor 16.

Example of a Method of Selecting a Digital Signal Converted from Five Types of Time Length (Time Intervals)

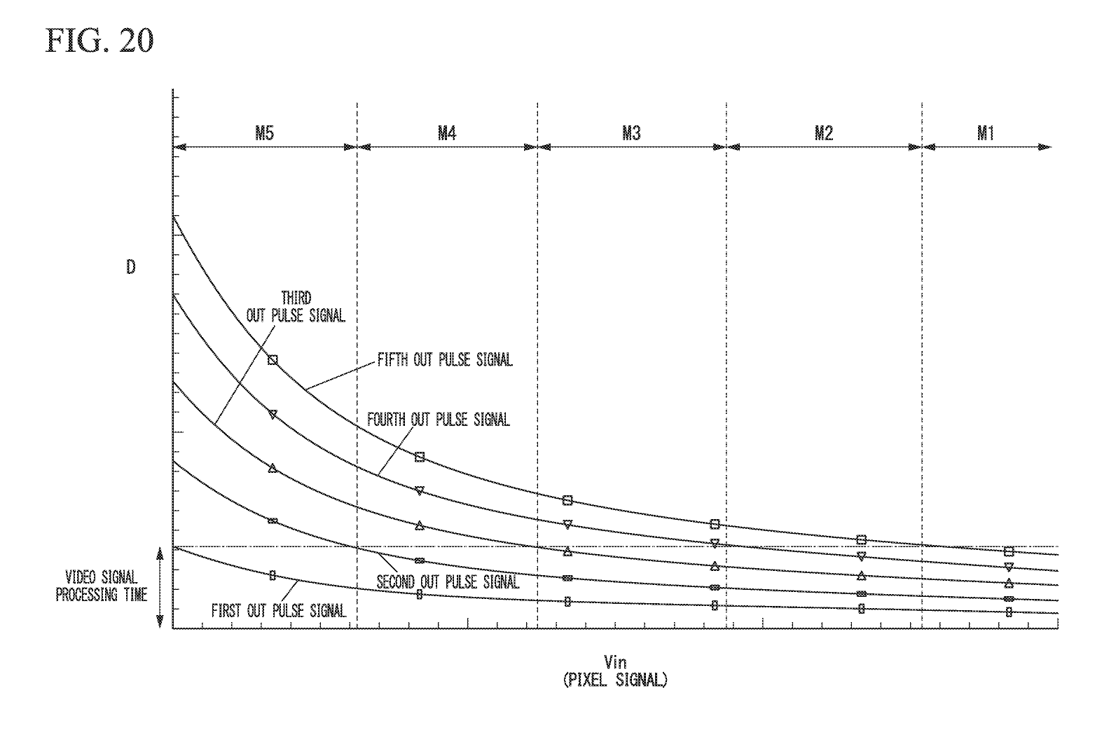

Next, an example of the method of the selecting device 23 provided in the main unit 3 in the endoscope system of the third preferred embodiment of the present invention selecting a digital signal will be described. FIG. 20 describes the method of the selecting device 23 selecting a digital signal in the endoscope system 30 of the third preferred embodiment of the present invention. FIG. 20 shows the relationship between the pixel signal (power supply Vin) that the time converter 19 converts to time information and the converted time D.

As shown in FIG. 20, the time converter 19 has five types of input/output characteristics that are related by a first-order rational function. If the video signal processing time of the time converter 19 is overlaid onto the input/output characteristics of the time converter 19, as shown in FIG. 20, division into five regions is enabled (regions M1 to M5), in accordance with the range of the magnitude of the voltage value of the pixel signal (power supply Vin).

More specifically, as shown in FIG. 20, in the region M1, in which the voltage value of the pixel signal (power supply Vin) is the largest, because the IN pulse signal passes through all of the inverter circuits 18 within the video signal processing time, the time converter 19 outputs all of the time information (first OUT pulse signal to fifth OUT pulse signal) during the video signal processing time. In the region M2, in which the voltage value of the pixel signal (power supply Vin) becomes slightly smaller, because the IN pulse passes through at least up to the inverter circuit 18_40 during the video signal processing time, the time converter 19 outputs four types of time information (first OUT pulse signal to fourth OUT pulse signal) during the video signal processing time. In the region M3, in which the voltage value of the pixel signal (power supply Vin) becomes even smaller, because the IN pulse passes through at least up to the inverter circuit 18_30 during the video signal processing time, the time converter 19 outputs three types of time information (first OUT pulse signal to three OUT pulse signal) during the video signal processing time. In the region M4, in which the voltage value of the pixel signal (power supply Vin) becomes even smaller, because the IN pulse passes through at least up to the inverter circuit 18_20 during the video signal processing time, the time converter 19 outputs two types of time information (first OUT pulse signal and second OUT pulse signal) during the video signal processing time. In the region M5, in which the voltage value of the pixel signal (power supply Vin) is the smallest, because the IN pulse passes through at least up to the inverter circuit 18_10 during the video signal processing time, the time converter 19 outputs one type of time information (first OUT pulse signal) during the video signal processing time.

In this manner, the time converter 19, in response to the voltage value of the pixel signal (power supply Vin), outputs a different number of time information, so that the electrical pulse signals from the receiving unit 22 are not input to all of the time interval converters 15. For this reason, the selecting device 23 does not input the digital signals from all of the time interval converters 15.

The selecting device 23 receives converted digital signals in the sequence from the time interval converter 15_1 to time interval converter 15_5, and selects the digital signal received last from the time interval converters within the video signal processing time. More specifically, in the case in which the digital signals are input from all of the time interval converters 15, that is, if the voltage value of the pixel signal (power supply Vin) is in the region M1, the selecting device 23 selects the digital signal input from the time interval converter 15_5. In the case in which the digital signals are input from the time interval converters 15_1 to 15_4, that is, if the voltage value of the pixel signal (power supply Vin) is in the region M2, the selecting device 23 selects the digital signal input from the time interval converter 15_4. In the case in which the digital signals are input from the time interval converters 15_1 to 15_3, that is, if the voltage value of the pixel signal (power supply Vin) is in the region M3, the selecting device 23 selects the digital signal input from the time interval converter 15_3. In the case in which the digital signals are input from the time interval converters 15_1 and 15_2, that is, if the voltage value of the pixel signal (power supply Vin) is in the region M4, the selecting device 23 selects the digital signal input from the time interval converter 15_2. In the case in which the digital signal from only the time interval converters 15_1 is input, that is, if the voltage value of the pixel signal (power supply Vin) is in the region M5, the selecting device 23 selects the digital signal input from the time interval converter 15_1.

In this manner, by the selecting device 23 selecting the digital signal that has the longest time interval before conversion, a digital signal having a good relationship between the pixel signal (power supply Vin) and the converted time D can be output to the video processor 16. More specifically, a digital signal having a larger slope in the relationship between the pixel signal (power supply Vin) and the converted time D can be output to the video processor 16.

At this point, the effect achieved by selecting a digital signal having a large slope in the relationship between the pixel signal (power supply Vin) and the converted time D will be described. As described above, the video processor 16, by processing the converted time D represented by the input digital signal, obtains a digital video signal having a substantially proportional relationship with the analog pixel signal. The relationship between the pixel signal and the converted time D, as can be understood from FIG. 20, has a small slope when the voltage value of the pixel signal (power supply Vin) is large, and a large slope when the voltage value of the pixel signal (power supply Vin) is small. It can be seen that the result is that a digital video signal obtained by processing the converted time D for a part that has a small slope has a reduced resolution, compared to a digital video signal obtained by processing the converted time D for a part that has a large slope.

The selecting device 23 selects the digital signal having a larger slope in the relationship between the pixel signal (power supply Vin) and the converted time D as largest digital signal. More specifically, as described above, a digital signal responsive to the fifth OUT pulse signal in the region M1 shown in FIG. 20, a digital signal responsive to the fourth OUT pulse signal in the region M2 shown in FIG. 20, a digital signal responsive to the third OUT pulse signal in the region M3 shown in FIG. 20, a digital signal responsive to the second OUT pulse signal in the region M4 shown in FIG. 20, a digital signal responsive to the first OUT pulse signal in the region M5 shown in FIG. 20 are selected as the largest digital signals. By doing this, the reduction in the resolution of the digital video signal obtained by processing by the video processor 16 can be suppressed.

As described above, even the selecting device 23 selects one of the digital signals input from one of the time interval converters 15_1 to 15_5 is selected as the largest digital signal, multiplication processing is performed so as to obtain a digital signal having the same scale as the digital signal output to the video processor 16. The selected device 23 outputs the digital signal, after multiplication processing thereof, to the video processor 16.

As described above, in the endoscope system 30 of the third preferred embodiment of the present invention, the time converter 19 generates a plurality of time information that represent the magnitude of the analog pixel signal captured by the image capturing unit 11, and the transmitting unit 21 transmits to the main unit 33 a plurality of time information on one channel. More specifically, whereas the endoscope system 1 of the first preferred embodiment, as shown in FIG. 7, transmits only one type of time information (the first OUT pulse signal in FIG. 20), the endoscope system 30 of the third preferred embodiment of the present invention transmits five types of time information. Additionally, in the endoscope system 30 of the third preferred embodiment of the present invention, the receiving unit 22 and the time interval converters 15_1 to 15_5 convert to a plurality of digital video signals, and the selecting device 23 selects the digital signal having the larger slope in the relationship between the analog pixel signal and the converted time D. More specifically, in the endoscope system 30 of the third preferred embodiment of the present invention, a digital signal responsive to time information having the largest slope within the video signal processing time is selected and obtained as the digital video signal. By doing this, in the endoscope system 30 of the third preferred embodiment of the present invention, it is possible to greatly improve the resolution of the digital video signal.

As described above, according to the preferred embodiments of the present invention, a time converter provided in the distal end of the endoscope converts analog pixel signals captured by an image capturing unit to time length information, and a transmits this to the main unit. By doing this, in the preferred embodiment of the present invention, it is not necessary as in a conventional endoscope system to have a constituent element such as an A/D conversion unit, which has a large power consumption, within the distal end of the endoscope, thereby enabling a reduction of the electrical power consumption at the distal end. The result is that, compared with a conventional endoscope system, a preferred embodiment of the present invention can suppress the generation of heat at the distal end of the endoscope that is inserted into the object under examination.

Also, according to the preferred embodiments of the present invention, a transmitting unit provided in the distal end of the endoscope converts to optical pulse signals analog pixel signals that have been converted by the time converter to time length information, and transmits the converted signals to the main unit. By doing this, in the preferred embodiments of the present invention, similar to a conventional endoscope system, analog pixel signals captured by the image capturing unit can be transmitted to the main unit without sacrificing the effect of noise immunity.

Additionally, according to the preferred embodiments of the present invention, a time interval converter 15 provided in the main unit converts analog pixel signal represented by the transmitted time length information to binary digital signals. By doing this, in the preferred embodiments of the present invention, it is possible from the analog pixel signals captured by the image capturing unit provided in the distal end of the endoscope to obtain digital video signals with high resolution and high accuracy.

Also, according to preferred embodiments of the present invention, pixel signals captured by the image capturing unit provided at the distal end of the endoscope are sampled and held, and a plurality of time converters perform parallel conversion of the pixel signals to time length information. By doing this, in preferred embodiments of the present invention, the amount of time for conversion by each of the time converters of the analog pixel signals to time length information can be made long, thereby enabling an increase in the number of effective bits in the digital signals represented by the time length information. By doing this, in preferred embodiments of the present invention, the digital signal resolution is improved, and it is possible to improve the signal quality when converting analog pixel signals to digital video signals.

Also, in a preferred embodiment of the present invention, the time converter provided in the distal end of the endoscope converts analog pixel signals captured by the image capturing unit to a plurality of time length information, and the transmitting unit transmits the plurality of time length information to the main unit on one channel. Then, by the receiving unit and the time interval converters provided in the main unit, a plurality of digital signals are generated from the plurality of the transmitted time length information, and the selecting device selects from the plurality of digital signals a digital signal that has a larger slope in the relationship between the analog pixel signal and the converted time. By doing this, in a preferred embodiment of the present invention a digital video signal can be obtained based on the time length information that has the largest slope within the video signal processing time, enabling a great improvement in the digital video signal resolution.

Also, preferred embodiments of the present invention have shown the example in which the transmitting unit, based on time information input from the time converter, the transmitting unit generates and transmits an optical pulse signal expressing the pixel signal magnitude by a pulse width. That is, the description has been for the case in which an optical pulse signal in which the timing of the start and end of a time interval responsive to the magnitude of a pixel signal are included within an optical pulse signal is generated and transmitted. The shape of a light pulse signal to be transmitted, however, is not limited to the preferred embodiments of the present invention. For example, the start timing and end timing of a time interval responsive to the magnitude of a pixel signal may be transmitted by separate optical pulse signals. That is, a constitution may be adopted in which the transmitting unit generates and transmits an optical pulse signal that includes only the starting time of the time interval and an optical pulse signal that includes only the ending time of the time interval separately. In this case, the receiving unit, in response to the optical pulse signal transmitted from the transmitting unit via the transfer section, needs to convert the optical pulse signals to electrical pulse signals.

Also, a preferred embodiment of the present invention shows examples of time interval converters of the type that drive a plurality of clocks with different phases in parallel, and also it is assumed that, by varying the frequency of the clock output by the oscillator, the time interval converters 15 that convert time intervals to digital signals with high resolution and good accuracy are provided in the main unit of the endoscope system. However, the time interval converters assumed to be provided within the main unit of the endoscope system are not restricted to being the preferred embodiments for implementing the present invention.

### Example of Another Method of Converting a Time Length (Time Interval) to a Digital Signal

At this point, another example of a time interval converter assumed to be provided in the main unit of the endoscope system of a preferred embodiment of the present invention will be described. In the description that follows, in place of the time interval converter 15 provided in the endoscope system 1 of the first preferred embodiment of the present invention shown in FIG. 1 to FIG. 14, a separate example of a time interval converter assumed to be provided in the main unit 3 in the endoscope system 1 of the first preferred embodiment will be described. Therefore, the time interval converter in the following description may also be provided in place of the time interval converters 15 provided in the endoscope system 20 of the second preferred embodiment and in the endoscope system 30 of the third preferred embodiment.

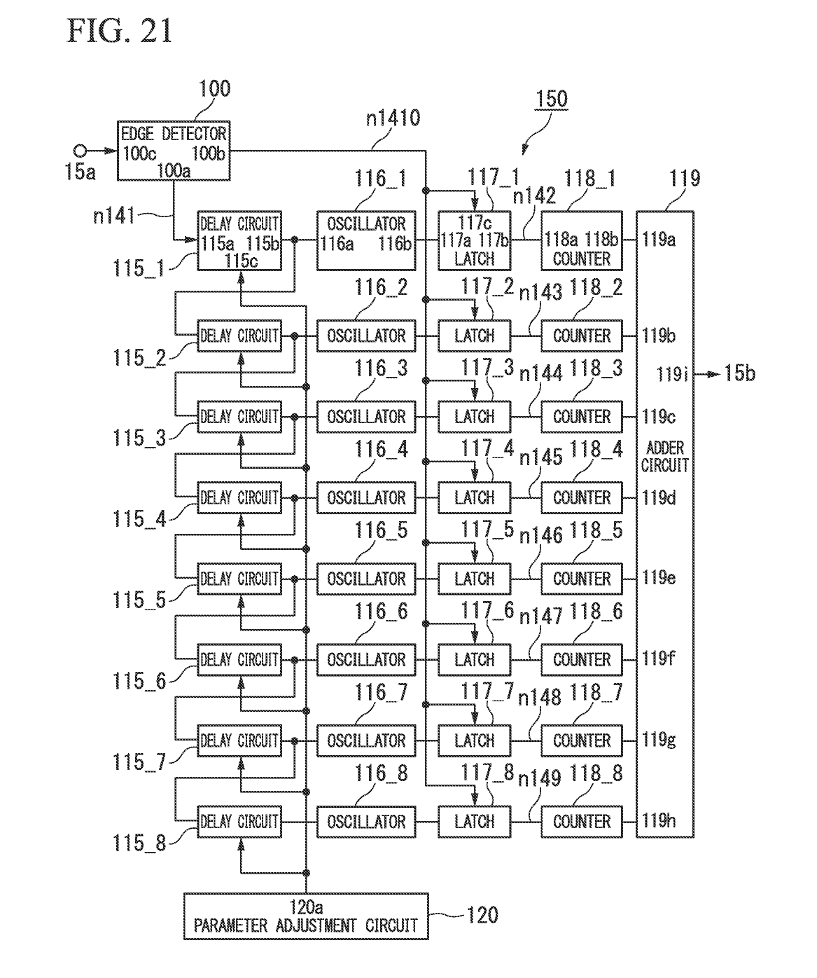

FIG. 21 is a block diagram showing another example of the general constitution of the time interval converter provided in the endoscope system 1 of the first preferred embodiment of the present invention. In FIG. 21, the time interval converter 150 has an edge detector 100, eight delay circuits 115_1 to 115_8, eight oscillators 116_1 to 116_8, eight latches 117_1 to 117_8, eight counters 118_1 to 118_8, and an adder circuit 119.

The time interval converter 150, similar to the time interval converter 15 shown in FIG. 9, by driving a plurality of clocks having different phases in parallel, converts the time intervals expressed by the input electrical pulse signals to digital signals, and outputs the converted digital signals. The time interval converter 150 inputs at the input terminal 15a an electrical pulse signal that the receiving unit 14 has converted to an electrical signal. The time interval converter 150 outputs from the output terminal 15b a digital signal that is responsive to the time width between the rising edge and the falling edge of the input electrical pulse signal, that is, responsive to the converted time D which expresses the magnitude of the pixel signal as a pulse width.

In the time interval converter 150 as well, similar to the time interval converter 15 shown in FIG. 9, it is desirable that the edge intervals between neighboring clocks be equal. For this reason, in the time interval converter 150 as well, similar to the time interval converter 15 shown in FIG. 9, by suppressing the variation in clocks used when converting the time intervals expressed by electrical pulse signals to digital signals, time intervals are converted to digital signals with high resolution and good accuracy. The time interval converter 150 has a parameter adjustment circuit 120 in place of the parameter adjustment circuit 107 provided in the time interval converter 15 shown in FIG. 9, and the parameter adjustment circuit 120 suppresses variation in the clocks used when converting time intervals to digital signals.

In the time interval converter 150 shown in FIG. 21, the edge detector 100 has the same constitution, function, and characteristics as the edge detector 100 in the time interval converter 15 shown in FIG. 9. In the time interval converter 150 shown in FIG. 21, each of the latches 117_1 to 117_8 has the same constitution, function, and characteristics as the latch 104 in the time interval converter 15 shown in FIG. 9. In the time interval converter 150 shown in FIG. 21, the counters 108_1 to 108_8 have the same constitution, function, and characteristics as the counter 105 in the time interval converter 15 shown in FIG. 9. In the time interval converter 150 shown in FIG. 21, the adder circuit 119 has, with the exception of difference in the input counted values, the same function and characteristics as the adder circuit 106 of the time interval converter 15 shown in FIG. 9. In the description that follows, the description of elements that have the same constitution, function, and characteristics as constituent elements provided in the time interval converter 15 shown in FIG. 9 will be omitted, and only constitution and operation of constituent elements that are different from those of the time interval converter 15 shown in FIG. 9 will be described. Also, in the following description as well, similar to the description of the time interval converter 15 shown in FIG. 9, in the time interval converter 150 shown in FIG. 21, when indicating any one of the delay circuits 115_1 to 115_8, the expression “delay circuit 115” will be used, and when indicating any one of the oscillators 116_1 to 116_8, the expression “oscillator 116” will be used. In the same manner, when indicating any one of the latches 117_1 to 117_8, the expression “latch 117” will be used, and when indicating any one of the counters 118_1 to 118_8, the expression “counter 118” will be used. In the same manner, the signals at the output terminals of each of the constituent elements within the time interval converter 150 will be referred to as nodes.

The edge detector 100, similar to the edge detector 100 in the time interval converter 15 shown in FIG. 9, detects the rising edge and the falling edge of the electrical pulse signal input to the time interval converter 150, and outputs a starting signal representing the timing of the detected rising edge of the electrical pulse signal, and an ending signal representing the timing of the detected falling edge of the electrical pulse signal.

The edge detector 100 inputs to the input terminal 100c an electrical pulse signal that has been input to the input terminal 15a of the time interval converter 150. The edge detector 100 outputs the starting signal (node n141) at the output terminal 100a and the ending signal (node n1410) from the output terminal 100b. More specifically, when the edge detector 100 detects the rising edge of the input electrical pulse signal, it switches the node n141 from the low level to the high level, and when it detects the falling edge of the input electrical pulse signal, it switches the node n1410 from the low level to the high level.

The delay circuit 115_1 to 115_8 each delay the signal input at the input terminal 115a by a delay time (for example Δt) responsive to a setting signal input to the input terminal 115c, and output the result from the output terminal 115b. In the description to follow, the delay time responsive to the setting signal input to the input terminal 115c will be described as being the “time Δt”. In the time interval converter 150, as shown in FIG. 21, the delay circuits 115_1 to 115_8 are connected in series. The starting signal (node n141) output from the output terminal 100a of the edge detector 100 and input to the input terminal 115a of the first stage delay circuit 115_1 is successively delayed in response to the setting signal by amount of the delay time (time Δt), and is input to the input terminal 115a of the next stage of delay circuit 115. Each of the delay circuits 115_1 to 115_8 inputs a signal that is delayed by the amount of time Δt output from its output terminal 115b to the input terminal 116a of a corresponding oscillator of oscillators 116_1 to 116_8. The delay time that delays input signals by each of the delay circuits 115_1 to 115_8 can be changed by the setting signal from the parameter adjustment circuit 120 input to its input terminal 115c.

More specifically, the delay circuit 115_1 outputs from the output terminal 115b a signal that is the input node n141 delayed by time Δt. The delay circuit 115_2 outputs from the output terminal 115b a signal that is further delayed by time Δt input from the delay circuit 115_1 delayed by time Δt, that is, a signal that is node n141 delayed by time 2Δt. The delay circuit 115_3 outputs from the output terminal 115b a signal that is further delayed by time Δt input from the delay circuit 115_2 delayed by time Δt, that is, a signal that is node n141 delayed by time 3Δt. In the same manner, each of the delay circuits 115_4 to 115_8 outputs from the output terminal 115b signals that are further delayed by time Δt input from the previous stage of delay circuit 115_3 to 115_7 delayed by time Δt, that is, signals that are node n141 delayed by times 4Δt to 8Δt. The constitution of the delay circuit 115 will be described in detail later.

At the timing of the switching of the signal input to the input terminal 116a from the low level to the high level, each of the oscillators 116_1 to 116_8 outputs a clock having a pre-established frequency. Each of the oscillators 116 inputs at the input terminal 116a the delayed node n141 output from the output terminal 115b of the corresponding delay circuit 115. Each of the oscillators 116 outputs from the output terminal 116b a clock of a pre-established frequency, at a timing offset by time Δt from when the input node n141 indicates the start of the time interval.

More specifically, an oscillator 116 starts output of a clock at the timing of the switching of the delayed node n141 from the low level to the high level, changes the output terminal 116b to the low level at the timing of the switching of the delayed node n141 from the high level to the low level, and stops output the clock. Each of the oscillators 116_1 to 116_8 inputs its clock to the input terminal 117a of the corresponding latch of the latches 117_1 to 117_8. Because, with the exception of not having a function of changing the frequency, the oscillator 116 may be thought of as being the same as the oscillator 103 in the time interval converter 15 shown in FIG. 9, the detailed description thereof will be omitted.

In response to a signal input at the input terminal 117c, each of the latches 117_1 to 117_8, similar to the latch 104 in the time interval converter 15 shown in FIG. 9, outputs from the output terminal 117b the signal that is input to the input terminal 117a or a signal that holds the state of the signal input to the input terminal 117a. Each of the latches 117_1 to 117_8 inputs at the input terminal 117a the clock output from the output terminal 116b of the corresponding oscillator 116, and inputs at the input terminal 117c the ending signal (node n1410) output from the output terminal 100b of the edge detector 100. When the node n1410 is at the low level, each of the latches 117_1 to 117_8 transfers and outputs as is to the output terminal 117b the clock input to the input terminal 117a and, at the timing of the switching of the node n1410 from the low level to the high level, holds the state of the clock input to the input terminal 117a, and during the time when the node n1410 is at the high level, maintains the output to the output terminal 117b a signal that holds the state of the clock. In the time interval converter 150, by the latches 117 disposed as shown in FIG. 21, each of the clocks output by the oscillators 116 are output in parallel.

More specifically, the latch 117_1 inputs to the input terminal 117a the clock output from the oscillator 116_1 and, in response to the state of the node n1410, outputs as node n142 from the output terminal 117b the clock output from the oscillator 116_1 or a signal that has the held state of the clock. The latch 117_2 inputs to the input terminal 117a the clock output from the oscillator 116_2 and, in response to the state of the node n1410, outputs as node n 143 from the output terminal 117b the clock output from the oscillator 116_2 or a signal that has the held state of the clock. The latch 117_3 inputs to the input terminal 117a the clock output from the oscillator 116_3 and, in response to the state of the node n1410, outputs as the node n144 from the output terminal 117b the clock output from the oscillator 116_3 or a signal that has the held state of the clock. In the same manner, each of the latches 117_4 to 117_8 inputs to the input terminal 117a the clock output from the corresponding oscillator of the oscillators 116_4 to 116_8 and, in response to the state of the node n1410, outputs as the nodes n145 to n149 from the output terminal 117b the clock output from the oscillators 116_4 to 116_8 or a signal that has the held state of the clock.

By the above-noted constitution, at the timing of the switching of the node n1410 from the low level to the high level, each of the latches 117 stops the output of the clock of which the output was started by the corresponding oscillator 116 at the timing of the switching of the node n141 from the low level to the high level. Stated differently, each of the latches 117 outputs from the output terminal 117b as the nodes n142 to n149 from the time that the electrical pulse signal input to the input terminal 15a of the time interval converter 150 indicates the start of the time interval until the electrical pulse signal indicates the end of the time interval, that is, over the converted time D, which is responsive to the magnitude of the pixel signal. The latch 117, similar to the latch 104 of the time interval converter 15 shown in FIG. 9, can be easily configured from general logic circuits, a detailed description thereof will be omitted.

Each of the counters 118_1 to 118_8 counts the number of rising edges of the signals (nodes n142 to n149) input to the input terminal 118a and outputs the counted number from the output terminal 118b. In the time interval converter 150, by the counters 118 disposed as shown in FIG. 21, the nodes output from the corresponding latches 117, that is, the edges of clock output from the corresponding oscillators 116, are counted in parallel. The counters 118 output in parallel the numbers of counted clock edges that have been counted.

More specifically, the counter 118_1 inputs at the input terminal 118a the node n142 output from the latch 117_1, that is, the clock output from the corresponding oscillator 116_1, and outputs from the output terminal 118b the number of counted rising edges of the node n142. The counter 118_2 inputs at the input terminal 118a the node n143 output from the latch 117_2, that is, the clock output from the corresponding oscillator 116_2, and outputs from the output terminal 118b the number of counted rising edges of the node n143. The counter 118_3 inputs at the input terminal 118a the node n144 output from the latch 117_3, that is, the clock output from the corresponding oscillator 116_3, and outputs from the output terminal 118b the number of counted rising edges of the node n144. In the same manner, each of the counters 118_4 to 118_8 inputs at the input terminal 118a the node output of the nodes n145 to n149 output from the corresponding latch of the latches 117_4 to 117_8, that is, the clock output from the corresponding oscillator of the oscillators 116_4 to 116_8, and outputs from the output terminal 118b the number of counted rising edges of the corresponding node of the nodes n145 to n149. Because the counter 118 can be easily configured from general logic circuits, similar to the counter 105 in the time interval converter 15 shown in FIG. 9, the detailed description thereof will be omitted.

The adder circuit 119 inputs the counted number of clock edges output from the output terminals 118b of the counters 118_1 to 118_8 to the corresponding input terminal of the input terminals 119a to 119h, and adds the input counted numbers of clock edges. Then the adder circuit 119 outputs the total count from the output terminal 119i, that is, from the output terminal 15b of the time interval converter 150, as a digital signal responsive to the time interval expressed by the electrical pulse signal input to the time interval converter 150. Because the adder circuit 119 can be easily configured from general logic circuits, similar to the adder circuit 106 in the time interval converter 15 shown in FIG. 9, the detailed description thereof will be omitted.

The parameter adjustment circuit 120 outputs from the output terminal 120a a setting signal that is a parameter for controlling the delay time to delay the signals input to each of the delay circuits 115. The parameter adjustment circuit 120 inputs the setting signal to the input terminal 115c of each of the delay circuits 115_1 to 115_8.

The parameter adjustment circuit 120, by the setting signal, adjusts the delay times of the delay circuits 115_1 to 115_8 so that the timing that is delayed by the time Δt from the rising edge of the clock output from the oscillator 116_8 coincides with the timing of the rising edge of the clock output from the oscillator 116_1. By doing this, the time difference between the timing of the rising edge of the node n149 output from the corresponding latch 117_8 and the timing of the rising edge of the node n142 output from the corresponding latch 117_1 is the time Δt. The method of the parameter adjustment circuit 120 adjusting the delay time of the delay circuits 115 will be described in detail later.

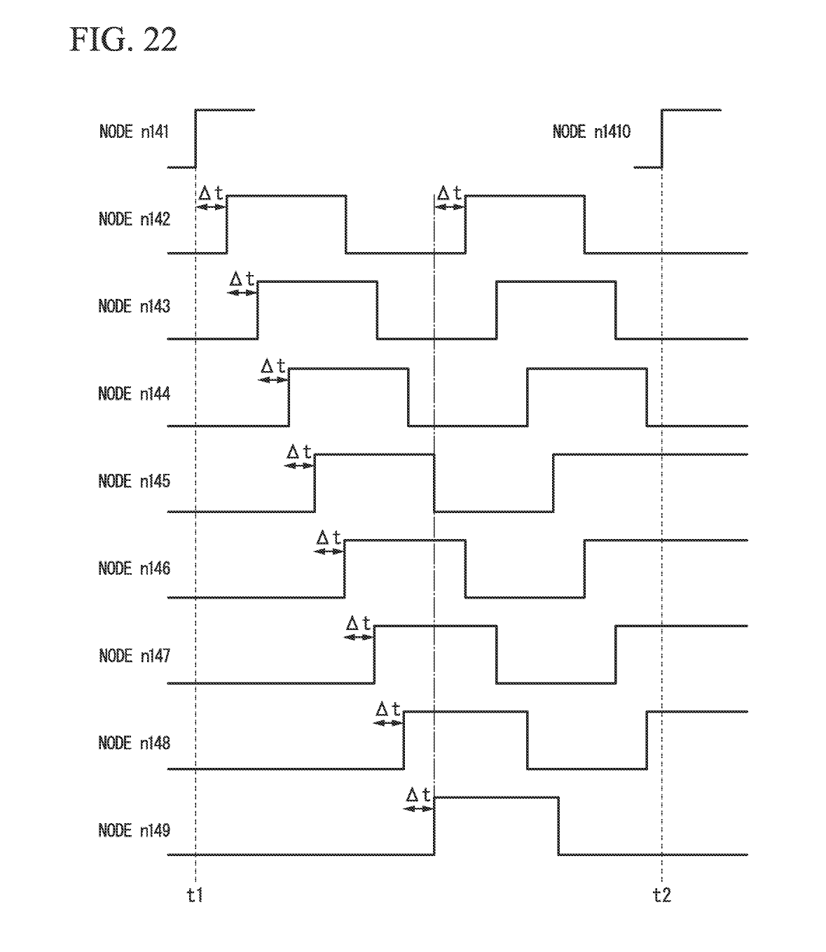

Next, the operation of the time interval converter 150 in the second preferred embodiment of the present invention will be described. FIG. 22 is a timing diagram showing the relationship of clocks in the time interval converter 150 that is another time interval converter provided in the endoscope system 1 of the first preferred embodiment of the present invention. FIG. 22 shows the timing at each node in the constitution of the time interval converter 150 of FIG. 21.

First, when the edge detector 100 detects the start of the time interval at the time t1, that is, the rising edge of the electrical pulse signal, based on the electrical pulse signal input to the internal terminal 15a of the time interval converter 150 and switches the starting signal (node n141) from the low level to the high level, the delay circuits 115_1 to 115_8 connected in series successively delay the node n141 by the time Δt of one stage of delay circuits 115. By doing this, the oscillators 116_1 to 116_8 start successively output of clocks that are delayed by the time Δt. The clock that is output being delayed by the time Δt is output from the respective latch of the latches 117_1 to 117_8 as the respective node of the nodes n142 to node n149.

Each of the counters 118_1 to 118_8 counts the number of the rising edges of each of the input nodes n142 to n149 and outputs the counted number to the adder circuit 119.

After the above, at the time t2, when the edge detector 100 detects the end of the time interval, that is, the falling edge of the electrical pulse signal, based on the electrical pulse signal input to the input terminal 15a of the time interval converter 150 and switches the ending signal (node n1410) from the low level to the high level, each of the latches 117_1 to 117_8 holds the state of the respective node of the nodes n142 to n149.

The adder circuit 119 then adds the counted numbers of edges of each of the node n142 to n149 input from each of the counters 118_1 to 118_8, and outputs from the output terminal 15b of the time interval converter 150 the total count as a digital signal responsive to the time from the start to the end of the time interval represented by the electrical pulse signal input to the time interval converter 150.

In this time, in the time interval converter 150 a plurality of clocks of the same frequency and delayed by the same interval (the time Δt in the time interval converter 150) are operated in parallel. The number of rising edges of each of the delayed clocks is counted and then finally the counted number of clock edges is added. By doing this in the time interval converter 150, the number of counted edges of the clock during the time interval is increased from the time (node n141) that the electrical pulse signal detected by the edge counter 100 indicates the start of the time interval up until the time (node n1410) indicates the end of the time interval, thereby enabling an improvement in the resolution of the digital signal that is output.

When this is done, the parameter adjustment circuit 120, as described above, successively adjusts the delay time of the delay circuits 115_1 to 115_8 by successively adjusting the parameter (setting signal) so that the timing that is delayed by the time Δt from the rising edge of the node n149 coincides with the timing of the rising edge of the node n142. By doing this, in the time interval converter 150, as shown in FIG. 22, all of the intervals between neighboring rising edges at the nodes n142 to n149 can be made the same fixed time Δt.

In this manner, in the time interval converter 150, by making the delay time of the signals output from the delay circuits 115 variable and providing the parameter adjustment circuit 120 that successively adjusts the delay time of the delay circuit 115, it is possible to convert a time interval to a digital signal with high resolution and good precision.

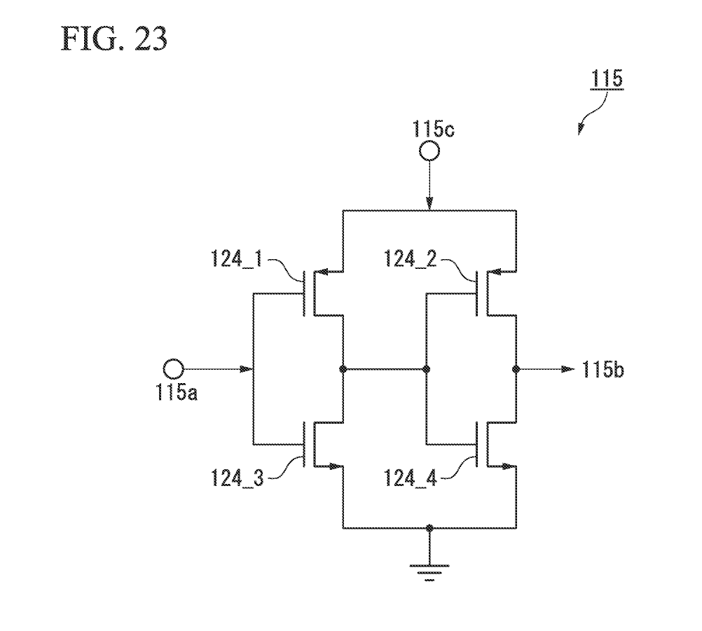

Next, the delay circuit 115 provided in the time interval converter 150 will be described. FIG. 23 is a circuit diagram showing an example of the constitution of a delay circuit 115 provided in the time interval converter 150 that is another time interval converter of the endoscope system 1 of the first preferred embodiment of the present invention. FIG. 23 shows an example of the constitution of the delay circuit 115 configured by four transistors. In FIG. 23, the delay circuit 115 has two PMOS transistors 124_1 and 124_2 and two NMOS transistors 124_3 and 124_4.

The PMOS transistor 214_1 has its gate terminal connected to the input terminal 115a of the delay circuit 115, its source terminal connected to the input terminal 115c of the delay circuit 115, and its drain terminal connected to the gate terminal of the PMOS transistor 124_2, the gate terminal of the NMOS transistor 124_4, and the drain terminal of the NMOS transistor 124_3. The NMOS transistor 124_3 has its gate terminal connected to the input terminal 115a of the delay circuit 115, and its source terminal connected to ground and to the source terminal of the NMOS transistor 124_4. The PMOS transistor 124_2 has its source terminal connected to the input terminal 115c of the delay circuit 115, and its drain terminal connected to the output terminal 115b of the delay circuit 115 and the drain terminal of the NMOS transistor 124_4. The NMOS transistor 124_4 has its drain terminal connected to the output terminal 115b of the delay circuit 115.

In this manner, in the delay circuit 115, the PMOS transistor 124_1 and the NMOS transistor 124_3 constitute the first inverter circuit stage and the PMOS transistor 124_2 and the NMOS transistor 124_4 constitute the following inverter circuit stage. This is a buffer circuit in which even number of inverter circuit stages are connected in series. The delay circuit 115 takes a level of parameter (setting signal) input to the input terminal 115c as the drive voltage of each of the inverter circuits. This causes the delay circuit 115 to delay the starting signal (node n141) input to the input terminal 115a by the delay time responsive to the magnitude of the drive voltage, and to output the signal from the output terminal 115b.

By using a buffer circuit in which an even number of inverter circuit stages are connected in series in this manner in the time interval converter 150, it is easy to configure a delay circuit with variable delay time from input to the output, taking as a parameter the power supply voltage or power current of each inverter circuit of the delay circuit 115.

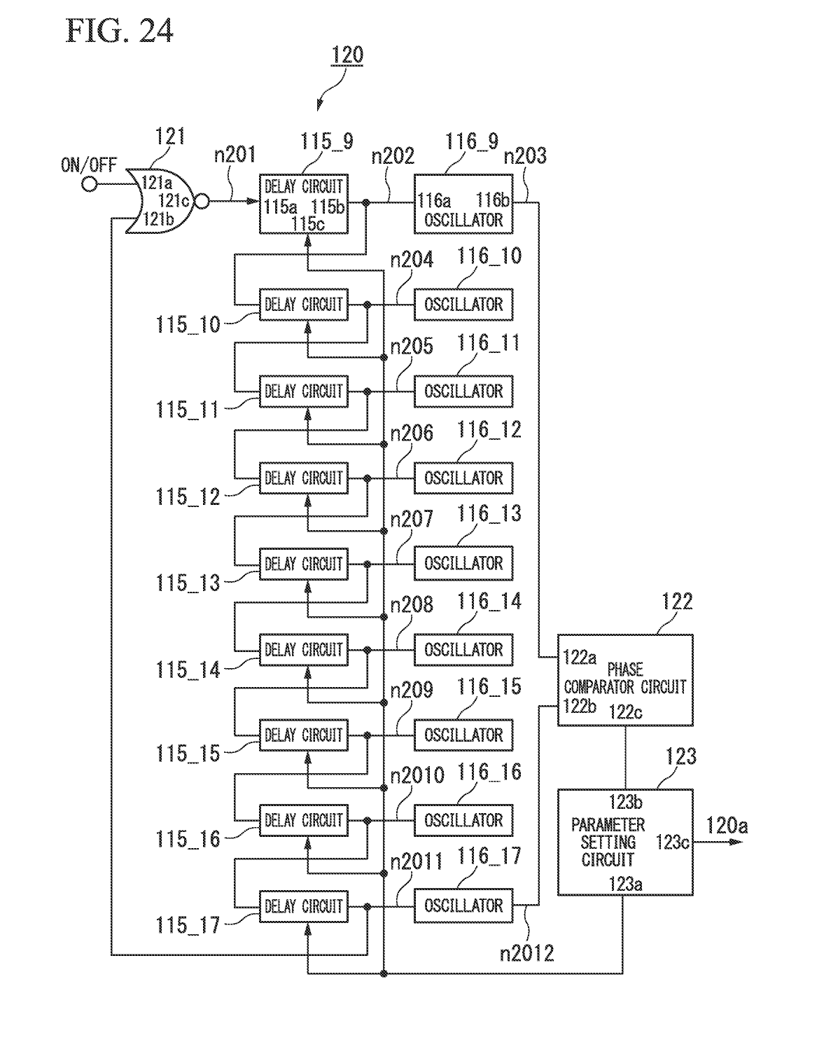

Next, the parameter adjustment circuit 120 provided in the time interval converter 150 will be described. FIG. 24 is a block diagram showing an example of the general constitution of the parameter adjustment circuit 120 in the time interval converter 150, which is another time interval converter, provided in the endoscope system 1 of the first preferred embodiment of the present invention. In FIG. 24, the parameter adjustment circuit 120 has a NOR circuit 121, nine delay circuits 115_9 to 115_17, nine oscillators 116_9 to 116_17, a phase comparator circuit 122, and a parameter setting circuit 123. When operation is started by on/off control of the input terminal ON/OFF the parameter adjustment circuit 120 outputs from the output terminal 120a a setting signal, which is a parameter for controlling the delay time of the delay circuit 115.

In the parameter adjustment circuit 120 shown in FIG. 24, each of the delay circuits 115_9 to 115_17 has the same constitution, function, and characteristics as the delay circuits 115 in the time interval converter 150 shown in FIG. 21. In the parameter adjustment circuit 120 shown in FIG. 24, the oscillators 116_9 to 116_17 have the same constitution, function, and characteristics as the oscillator 116 in the time interval converter 150 shown in FIG. 21. Therefore, in the following description, the description of the constitution, function, and characteristics of constituent elements provided in the time interval converter 150, which are the same as those shown in FIG. 21 will be omitted, and only constitution and operations that differ from the constituent elements provided in the time interval converter 150 shown in FIG. 21 will be described. In the following description, similar to the description of the time interval converter 150 shown in FIG. 21, when indicating any one of the delay circuits 115_9 to 115_17 of the parameter adjustment circuit 120 shown in FIG. 24, the expression “delay circuit 115” will be used, and when indicating any one of the oscillators 116_9 to 116_17 thereof, the expression “oscillator 116” will be used. Additionally, in the same manner, signals at the output terminals of each of the constituent elements within the parameter adjustment circuit 120 will be referred to as nodes. Also, in the same manner, the delay time responsive to an input setting signal to the input terminal 115c of the delay circuit 115 is taken as being the time Δt.

The NOR circuit 121 inputs at the input terminal 121a the ON/OFF signal that is input to the ON/OFF input terminal, and inputs at the input terminal 121b the output signal output from the output terminal 115b of the delay circuit 115_17. The NOR circuit 121 outputs from the output terminal 121c as the node n201a signal that is the negated logical sum of the ON/OFF signal input to the input terminal 121a and the output signal of the delay circuit 115_17 input at the input terminal 121b.

As shown in FIG. 24, in the parameter adjustment circuit 120, the delay circuits 115_9 to 115_17 are connected in series. Each of the delay circuits 115_9 to 115_17 outputs the node n201 that is input to the input terminal 115a of the first-stage delay circuit 115_9 after it successively delays it by the delay time (the time Δt) responsive to an input setting signal to the input terminal 115c from the output terminal 115, so as to input it to the input terminal 115a of the next stages of delay circuit 115. Each of the delay circuit 115_9 to 115_17 inputs to the input terminals 116a of the corresponding oscillator of the oscillators 116_9 to 116_17 signals that are delayed from the node 201 output from the output terminal 115b (node n202 and nodes n204 to n2011). The delay time delaying the signals that are input to the delay circuits 115_9 to 115_17 can be changed by the setting signal input to the input terminal 115c from the parameter setting circuit 123.

More specifically, the delay circuit 115_9 outputs a signal, which is the input node n201 after delaying it by the time Δt, from the output terminal 115b as the node n202. The delay circuit 115_10 outputs from the output terminal 115b as the node n204 a signal that is the input node n202 delayed by the time Δt, that is, the signal that is the node n201 delayed by the time 2Δt. In the same manner, each of the delay circuits 115_11 to 115_16 outputs respectively from the output terminal 115b as the nodes n205 to n2010 a signal that is the input nodes n204 to n209 delayed by the time Δt from the corresponding previous stage of the delay circuits 115_10 to 115_15, that is, the signal that is the node n201 delayed by the times 3Δt to 8Δt. The delay circuit 115_17 outputs from the output terminal 115b as the node n2011 a signal that is the input node n2010 delayed by the time Δt, that is, the signal that is the node n201 delayed by the time 9Δt.

In the parameter adjustment circuit 120, as shown in FIG. 24, each of the oscillators 116_9 to 116_17 input at the input terminals 116a delayed nodes n202 and nodes n204 to n2011 output from the output terminal 115b of the corresponding delay circuit of the delay circuits 115_9 to 115_17. Each of the oscillators 116 outputs a clock having a prescribed frequency from the output terminal 116b at the timing of the input node n202 and nodes n204 to n2011 switching from the low level to the high level.

More specifically, the oscillator 116_9 inputs at the input terminal 116a the node n202 that is output from the output terminal 115b of the delay circuit 115_9 and, at the timing of the node n202 switching from the low level to the high level, outputs from the output terminal 116b as the node n203 a clock having a prescribed frequency. The oscillator 116_17 inputs at the input terminal 116a the node n2011 output from the output terminal 115b of the delay circuit 115_17, and at the timing of the node n2011 switching from the low level to the high level, the oscillator 116_17 outputs from the output terminal 116b as the node n2012 a clock having a prescribed frequency.

As can be understood from FIG. 24, each of the oscillators 116_10 to 116_16 inputs to the input terminal 116a the corresponding node of the nodes n204 to n2010, and the clock of the pre-established frequency output from each of the output terminals 116b of the oscillators 116_10 to 116_16 is not connected to any of the constituent elements within the parameter adjustment circuit 120. This is because, in the parameter adjustment circuit 120, the delay circuits 115 and the oscillators 116 are configured and connected in the same manner as the delay circuits 115 and oscillators 116 in the time interval converter 150 shown in FIG. 21, so that each of the oscillators 116_10 to 116_16 is disposed as the output load of the corresponding delay circuit of the delay circuits 115_10 to 115_16. By disposing each of the oscillators 116_10 to 116_16 as the output load of the corresponding delay circuit of the delay circuits 115_10 to 115_16, the delay time of each of the delay circuits 115_10 to 115_16 can be more accurately made the same as the delay time of the delay circuits 115 in the time interval converter 150 shown in FIG. 21.

Also, although the parameter adjustment circuit 120 shown in FIG. 24 shows the example of a case in which each of the oscillators 116_10 to 116_16 is disposed as the output load of the corresponding delay circuit of the delay circuits 115_10 and 115_16, the constitution of the output load of each of the delay circuits 115_10 to 115_16 in the parameter adjustment circuit 120 is not restricted to being the constitution shown in FIG. 24. For example, a constitution may be adopted in which only the input circuits within the oscillators 116 to which the nodes n204 to n2010 output by the respective delay circuit of the delay circuits 115_10 to 115_16 are disposed as the output loads of the delay circuits 115_10 to 115_16. In this case, for example, if the oscillator 116 has the constitution shown in FIG. 11, the constitution is one in which only the NAND circuit 111 is disposed as the output load of each of the delay circuits 115_10 to 115_16. By adopting this constitution, it is possible to reduce the circuit scale of the parameter adjustment circuit 120.

Also, for example, even if an output load is not connected to each of the delay circuits 115_10 to 115_16, if it is possible to have the delay times thereof coincide with the delay time of the delay circuit 115 of the time interval converter 150 shown in FIG. 21 to an allowable degree, a constitution may be adopted in which the nodes n204 to n2010 output from the delay circuits 115_10 to 115_16 are not connected to any constituent elements. That is, a constitution may be adopted in which the oscillators 116_10 to 116_16 are not disposed within the parameter adjustment circuit 120. By adopting this constitution, it is possible to further reduce the circuit scale of the parameter adjustment circuit 120.

The phase comparator circuit 122 compares the clock at the node n203 input to the input terminal 122a and the clock at the node n2012 input to the input terminal 122b, detects the time difference between the rising edge of the clock at the node n203 and the rising edge of the clock at the node n2012, and outputs a time difference signal indicating the detected time difference from the output terminal 122c.

The parameter setting circuit 123, based on the time difference signal input at the input terminal 123b, calculates a parameter so that the time difference between the rising edge of the clock at the node n203 and the rising edge of the clock at the node n2012 is made smaller, and outputs the parameter resulting from the calculation from the output terminals 123a and 123c as setting signals. The setting signal output from the output terminal 123a of the parameter setting circuit 123 is input to the input terminals 115c of the delay circuits 115_9 to 115_17 as a parameter for controlling the delay times of the delay circuits 115_9 to 115_17. The setting signal output from the output terminal 123c of the parameter setting circuit 123 is output from the output terminal 120a of the parameter setting circuit 120 as the parameter output by the parameter setting circuit 120, and is input to the input terminals 115c of the delay circuits 115 provided in the time interval converter 150.

The parameter setting circuit 123 output the same parameter as setting signals from the output terminals 123a and 123c. By doing this, the delay times of the delay circuits 115 provided in the time interval converter 150 are the same as the delay times of the delay circuits 115_9 to 115_17 within the parameter adjustment circuit 120.

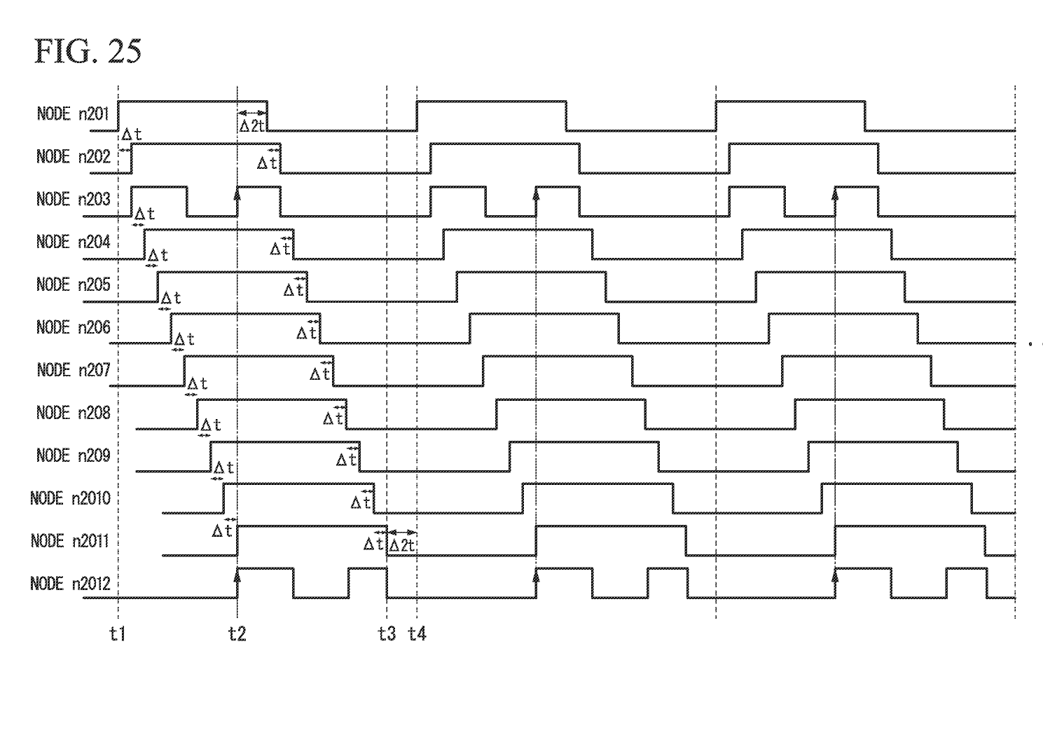

Next, the operation of the parameter adjustment circuit 120 provided in the time interval converter 150 will be described. FIG. 25 is a timing diagram showing the timing of the operation of the parameter adjustment circuit 120 in the time interval converter 150 that is another time interval converter provided in the endoscope system 1 of the first preferred embodiment of the present invention. FIG. 25 shows the timing at each node in the constitution of the parameter adjustment circuit 120 of FIG. 24.

When the signal at the ON/OFF input terminal switches from the high level to the low level and the parameter adjustment circuit 120 starts operating, at the time t1, the node n201 switches from the low level to the high level. As a result, the node n202, which is the node n201 delayed by the time Δt of one stage of the delay circuit 115, is output from the delay circuit 115_9. Simultaneously with this, the oscillator 116_9 starts outputting a clock (node n203). The phase comparator circuit 122 successively detects the time difference between the rising edge of the clock at the node n203 and the rising edge of the clock at the node n2012, and successively outputs a time difference signal to the parameter setting circuit 123.

Each of the delay circuits 115_10 to 115_17 successively delays the input node n202 by the time Δt of one stage of the delay circuit 115, and makes an output at the respective node of the nodes n204 to n2011. Then, at the time t2, when the node n2011 that is output from the delay circuit 115_17 switches from the low level to the high level, the oscillator 116_17 simultaneously starts outputting the clock (node n2012). The node n2012 that is output by the oscillator 116_17 from the time t2 is a clock that is the node n201 delayed by the amount of time 9Δt by the nine stages of delay circuit 115.

When this occurs, the parameter setting circuit 123, based on the time difference signal successively input from the phase comparator circuit 122, sets a parameter in the delay circuits 115_9 to 115_17 in the direction that causes the timing of the rising edge of the node n203 to coincide with the timing of the rising edge of the node n2012. By doing this, the delay time of the delay circuits 115_9 to 115_17 approaches the time of ⅛ the clock period (node n203) output by the oscillator 116_9.

This means that the time difference between the node n202 and the node n2011 is the time 8Δt, as can be understood from the constitution of the parameter adjustment circuit 120 shown in FIG. 24. Therefore, the time difference between the timing of the rising edge of the node n203 and that of the rising edge of the node n2012 is also the time 8Δt. By making the timing of the rising edge of the node n2012 coincide with the timing of the rising edge of the node n203, the period of the node n203 is also the time 8Δt. The clock at the node n2012 has a period that is the time 8Δt and a phase that is the reverse of the clock at the node n203.

The parameter setting circuit 123 outputs from the output terminal 123c of the parameter setting circuit 123, that is, from the output terminal 120a of the parameter adjustment circuit 120, a parameter for setting into the delay circuits 115_9 to 115_17 for the purpose of controlling the delay time of the delay circuits 115_1 to 115_8. By doing this, the parameter setting circuit 123 controls the delay time of the delay circuits 115_1 to 115_8 provided in the time interval converter 150 while simultaneously controlling the delay time of the delay circuits 115_9 to 115_17.

At the time t2, when the node n2011 output from the delay circuit 115_17 switches from the low level to the high level, the node n201 switches from the high level to the low level. With the timing shown in FIG. 25, the delay time from the change of the node n2011 input to the input terminal 121b of the NOR circuit 121 until the change of the node n201 at the output terminal 121c is shown as the time 2Δt. As a result, the node n202 also changes from the high level to the low level with a delay of time Δt of one stage of the delay circuit 115. Simultaneously, the oscillator 116_9 stops outputting the clock (node n203).

After the above, each of the delay circuits 115_10 to 115_17 successively delays the input node n202 by the time Δt of one stage of the delay circuit 115, and makes an output at the respective nodes of the nodes n204 to n2011. Then, at the time t3, when the node n2011 output from the delay circuits 115_17 switches from the high level to the low level, the oscillator 116_17 simultaneously stops outputting the clock (node n2012).

At the time t3, the node n2011 output from delay circuit 115_17 switches from the high level to the low level, and at the time t4, which is the time delayed by 2Δt of the NOR circuit 121, the node n201 once again switches from the low level to the high level. After that, at the parameter adjustment circuit 120, similar to the times t1 to t4, the parameters for the delay circuits 115_9 to 115_17 are repeatedly set by the parameter setting circuit 123 so that the delay times of each of the delay circuits 115_9 to 115_17 is the time of ⅛ the period of the clock (node n203) output by the oscillator 116_9.

In this manner, in the parameter adjustment circuit 120, the NOR circuit 121 and the delay circuits 115_9 to 115_17 form a ring oscillator and, based on the logical switching of the node n201, the operations at times t1 to t4 are repeated. Then, in the parameter adjustment circuit 120, by repeating the operations at times t1 to t4, parameters are repeatedly set in the delay circuits 115_9 to 115_17 in the direction that causes the timing of the rising edge of the node n203 to coincide with that of the rising edge of the node n2012. By doing this, the delay time of the delay circuits 115_9 to 115_17 converge to the time of ⅛ the period of the clock (node n203) output by the oscillator 116_9. Then, in the time interval converter 150, the parameter at this time is also set repeatedly into the delay circuits 115_1 to 115_8 to causes the delay time of the delay circuits 115_1 to 115_8 to converge to the time of ⅛ the period of the clock (node n203) output by the oscillator 116_9. In this situation, because the frequency of the clock (node n203) output by the oscillator 116_9 is the same period as the clock period output by each of the oscillators 116_1 to 116_8, the delay time of the delay circuits 115_1 to 115_8 is the same with conversion to the time of ⅛ the clock period output by each of the oscillator s 116_1 to 116_8. When the delay time of the delay circuits 115_1 to 115_8 converges to the time of ⅛ the clock period output by each of the oscillator s 116_1 to 116_8, in the time interval converter 150, as shown in FIG. 22, the timing that is delayed by the time Δt from the rising edge of the node n149 coincides with the timing of the rising edge of the node n142.

In this manner, in the time interval converter 150, a ring oscillator using the delay circuits (delay circuits 115_9 to 115_17) that are the same as the delay circuits 115 that input and delay a signal that causes the oscillator 116 to start outputting a clock, that is, a starting signal, at which the time interval converter 150 starts conversion of a time interval to a digital signal, is configured within the parameter adjustment circuit 120. Then, in the time interval converter 150, clocks (the clock at the node n203 and the clock at the node n2012) having the same frequency as the clock output by the oscillator 116 is generated within the parameter adjustment circuit 120, and by periodically adjusting the delay time of the delay circuits 115_9 to 115_17, the frequencies of the generated clocks are periodically adjusted. Then, a parameter that is the same as the delay time parameter of the delay circuits 115_9 to 115_17 and that adjusts the frequency of the clocks within the parameter adjustment circuit 120 is set with respect to the delay circuits 115_1 to 115_8, so as to periodically adjust the period of the clock output by the oscillator 116. That is, rather than by using the clock output by the oscillator 116 directly to calculate a parameter of the delay time of the delay circuits 115 for adjusting the period, the same clock that is separately generated is used to indirectly calculate a parameter of the delay time of the delay circuit 115 for adjusting the period of the clock output by the oscillator 116.

By virtue of the above-described constitution, in the time interval converter 150 a plurality of clocks having different phases are generated, and the edges within the period of the time interval indicated by the electrical pulse signal are counted. By doing this, the time interval converter 150 can also improve the resolution when converting the time interval indicated by the electrical pulse signal to a digital signal. As a result, the time interval converter 150 can also convert an analog video signal captured by the image capturing unit 11 inside the object under examination to a high-resolution digital video signal.

In the time interval converter 150, delay circuits 115 and the oscillators 116 of the parameter adjustment circuit 120 are configured and connected in the same manner as the delay circuits 115 and oscillators 116 in the time interval converter 150. By successively adjusting the delay time so that the delay time of the delay circuits 115 in the parameter adjustment circuit 120 and the delay time of the delay circuits 115 in the time interval converter 150 are the same at all times, adjustment is made so that the frequency of the clock output by the oscillators 116 is constant. By doing this, even in the time interval converter 150, successive correction is made of the variation (error) in the interval between the rising edges of neighboring clocks output by the oscillators 116 caused by variation in the ambient temperature in which the time interval converter 150 is used and variation in the power supply voltage, enabling conversion of the time interval represented by the electrical pulse signal to a digital signal with good accuracy.

In the endoscope system of a preferred embodiment of the present invention, by providing a time interval converter 150 within the main unit 3 in place of the time interval converter 15 described by FIG. 9 to FIG. 14, similar to the time interval converter 15, conversion is done within the distal end 5 of the endoscope 2 to a signal representing a time length, which is transmitted, enabling analog pixel signals captured by the image capturing unit 11 to be converted to binary digital video signals with high resolution and good accuracy.

The foregoing has been a description of the case in which, in the time interval converter 15, the parameter adjustment circuit 107 adjusts the frequency of the clock output by the oscillator 103 so that the timing delayed by the time Δt after the rising edge of the clock d4 output from the delay circuit 102_10 coincides with the timing of the falling edge of the clock d1 output by the delay circuit 102_1. Additionally, the description has been of the case in which, in the time interval converter 150, the parameter adjustment circuit 120 adjusts the time delay of the delay circuits 115_1 to 115_8 so that the timing delayed by the time Δt after the rising edge of the clock output from the oscillator 116_8 coincides with that of the rising edge of the clock output from the oscillator 116_1. The method of causing the timing of the clock edges to coincide, however, is not restricted to the preferred embodiments of the present invention.

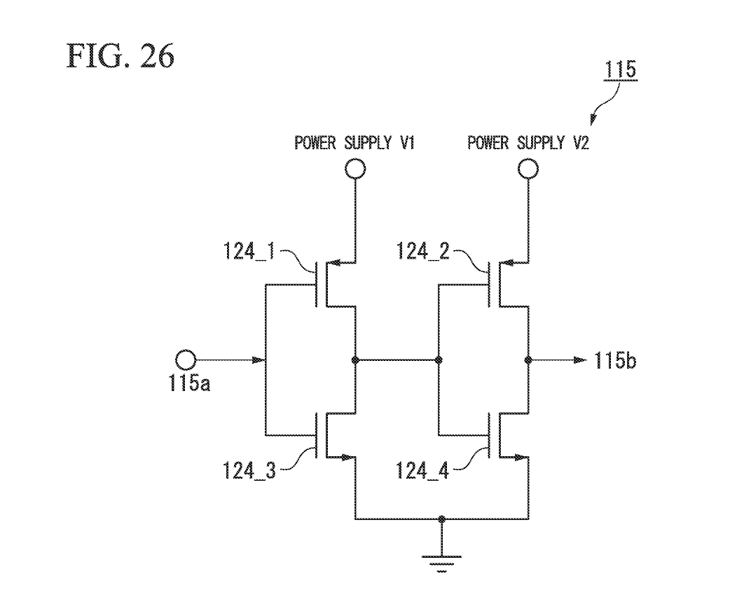

For example, a constitution may be adopted in which, in the time interval converter 15, a parameter adjustment circuit 107 adjusts the delay times of the delay circuits 102_1 to 102_10 so that the timing delayed by the time Δt after the rising edge of the clock d4 output from the delay circuit 102_10 coincides with the timing of the falling edge of the clock d1 output from the delay circuit 102_1. Also, for example, a constitution may be adopted in which, in the time interval converter 150, a parameter adjustment circuit 120 may adjust the frequency of the clocks output from the oscillators 116_1 to 116_8 so that the timing delayed by the time Δt after the rising edge of the clock output from the oscillator 116_8 coincides with the timing of the rising edge of the clock output from the oscillator 116_1. Also, the delay circuits 115_1 to 115_17 provided in the time interval converter 150 have been described for the case of a constitution in which they have a delay time changing function. However, the delay circuits 115 provided in the time interval converter 150 are not restricted to the preferred embodiments of the present invention. For example, a constitution may be adopted in which the delay time of the delay circuit (delay circuits 115_1 to 115_17) provided in the time interval converter 150, similar to the time interval converter 15, are made fixed delay times, and the frequency of the clocks output by the oscillators (oscillators 116_1 to 116_17) is varied. In this case, a parameter adjustment circuit (parameter adjustment circuit 120 and parameter setting circuit 123) provided in the time interval converter 150 controls the oscillator clock frequency. In the case of the above-described constitution of the time interval converter 150, the constitution of delay circuits (delay circuits 115_1 to 115_17) that have a fixed delay time may be changed to the constitution such in FIG. 26.

At this point, another constitution of a delay circuit 115 provided in the time interval converter 150 will be described. FIG. 26 is a circuit diagram of an example of another constitution of the delay circuit 115 in the time interval converter 150 provided in the endoscope system 1 of the first preferred embodiment of the present invention. FIG. 26 shows an example of another constitution of a delay circuit 115 constituted by four transistors. In FIG. 26, the delay circuit 115 has two PMOS transistors 124_1 and 124_2, two NMOS transistors 124_3 and 124_4, and power supplies V1 and V2.

The PMOS transistor 124_1 has its gate terminal connected to the input terminal 115a of the delay circuit 115, its source terminal connected to the power supply V1, and its drain terminal connected to the gate terminal of the PMOS transistor 124_2, the gate terminal of the NMOS transistor 124_4, and the drain terminal of the NMOS transistor 124_3. The NMOS transistor 124_3 has its gate terminal connected to the input terminal 115a of the delay circuit 115, its source terminal connected to ground and the source terminal of the NMOS transistor 124_4. The PMOS transistor 124_2 has its source terminal connected to the power supply V2 and its drain terminal connected to the output terminal 115b of the delay circuit 115 and to the drain terminal of the NMOS transistor 124_4. The NMOS transistor 124_4 has it drain terminal connected to the output terminal 115b of the delay circuit 115.

In the delay circuit 115, the voltage of the power supply V1 is set to a value lower than the voltage of the power supply V2, the ratio W/L between the channel length L and the channel width W of the NMOS transistor 124_3 is set to be larger than the ratio W/L of the NMOS transistor 124_4, and the W/L ratio of the PMOS transistor 124_1 is set to be smaller than the W/L ratio of the PMOS transistor 124_2. In this manner, by setting the power supply voltages and W/L ratios of the transistors, the threshold voltage of the first stage inverter circuit that is constituted by the PMOS transistor 124_1 and the NMOS transistor 124_3 can be set to a value that is lower than the threshold voltage of the following stage of inverter circuit that is constituted by the PMOS transistor 124_2 and the NMOS transistor 124_4.

By the above, in the delay circuit 115, it is possible to shorten the delay time, that is, the time Δt, of the output signal output at the output terminal 115b when the signal input to the input terminal 115a switches from the low level to the high level. In the time interval converter 150, by using a delay circuit 115 having this type of constitution, the resolution of the digital signal that is output can be improved.

The setting of the power supply voltages and the W/L ratios of the transistors in the delay circuit 115 are not restricted to the above-noted settings. For example, the voltage of the power supply V1 may be set to a value higher than the voltage of the power supply V2, the W/L ratio of the NMOS transistor 124_3 may be made smaller than the W/L ratio of the NMOS transistor 124_4, and the W/L ratio of the PMOS transistor 124_1 may be made larger than the W/L ratio of the PMOS transistor 124_2. By doing this, the threshold voltage of the first inverter circuit stage can be set to be a value that is higher than the threshold voltage of the following inverter circuit stage and, in the delay circuit 15, it is possible to shorten the delay time, that is, the time Δt, of the output signal output at the output terminal 115b when the signal input to the input terminal 115a switches from the high level to the low level. From this, in the same manner as in the delay circuit 115 set as described above, the resolution of the digital signal output by the time interval converter 150 can be improved.

In the preferred embodiments of the present invention, the description has been for the case in which a transmitting unit provided in the distal end of the endoscope generates an optical pulse signal based on time information input from a time converter. The signal generated based on the time information input from the time converter is not restricted to the preferred embodiments of the present invention. For example, a constitution may be adopted in which the transmitting unit generates an electrical pulse signal based on time information input from the time converter, in which case, in place of the optical waveguide (an optical fiber in the case of the preferred embodiment) provided in the transfer section, a conductor or the like that transfers an electrical signal would be provided. Also, in this case, the receiving unit provided in the main unit may have a constitution that outputs the transmitted electrical pulse signal as is to the time interval converter.

In the preferred embodiment, the description has been for the case of applying to an endoscope system an A/D converter that converts the magnitude of an analog pixel signal to a signal that represents a time length and transmits the signal, and converts the time interval in the signal representing the transmitted time length to a digital video signal. That is, the description has been for the case of applying to an endoscope system an A/D converter that converts the magnitude of an analog signal to time information representing a time length and converts the time information to a digital signal, so as to convert the analog signal to a digital signal. In the preferred embodiment, however, the system to which an A/D converter is applied to an endoscope system is not restricted to being an endoscope system, an A/D converter based on the idea of the present invention being applicable to a various systems.

### A/D Converter

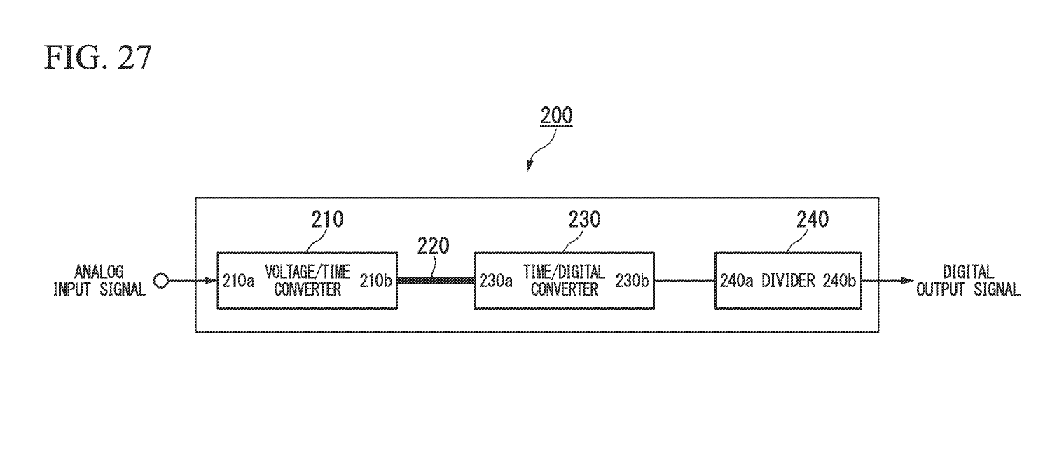

An A/D converter based on the idea of the present invention that can be applied to various systems will now be described. FIG. 27 is a block diagram showing an example of the general constitution of the A/D converter in accordance with the preferred embodiment of the present invention. In FIG. 27 an A/D converter 200 has a voltage/time converter 210, a coaxial cable 220, a time/digital converter 230, and a divider 240. The A/D converter 200 shown in FIG. 27, similar to the endoscope system 1 of the first preferred embodiment, shows an example of a constitution in which the magnitude of an analog input signal is represented by time information and transmitted, and ultimately a digital signal is output that is converted based on the transmitted time information.

The voltage/time converter 210 outputs time information that is the magnitude of the input analog signal converted to a time width (time interval) as an electrical pulse signal to the coaxial cable 220. In the A/D converter 200, the functions corresponding to the time converter 12 and the transmitting unit 13 provided at the distal end 5 of the endoscope system 1 of the first preferred embodiment shown in FIG. 2 are performed by the voltage/time converter 210. However, whereas in the endoscope system 1 of the first preferred embodiment the transmitting unit 13 transmitted an optical pulse signal, in the voltage/time converter 210, an electrical pulse signal that is an electrical signal is transmitted on the coaxial cable 220.

More specifically, the voltage/time converter 210, similar to the time converter 12 in the endoscope system 1, generates, as time information, pulse signals that represent, respectively, the timing of the start and the timing of the end of a time interval responsive to the magnitude of an input analog signal. Also, the voltage/time converter 210, similar to the transmitting unit 13 in the endoscope system 1, generates, based on the generated time information, an electrical pulse signal that represents the magnitude of the analog input signal by a pulse width, and transmits the generated electrical pulse signal to the coaxial cable 220. The voltage/time converter 210 inputs the analog signal at the input terminal 210a, and outputs the generated electrical pulse signal from the output terminal 210b. The details of the constitution of the voltage/time converter 210, the method of the voltage/time converter 210 generating time information from the analog input signal and generating an electrical signal from the time information will be described later.

The coaxial cable 220 is a cable that has, surrounding a conductor (signal line) for transmitting an electrical signal, for example, another conductor made to be at the ground level, for the purpose of shielding noise that comes from outside. The coaxial cable 220, by the signal line, transmits the electrical pulse signal transmitted from the voltage/time converter 210 to the time/digital converter 230.

The time/digital converter 230, based on the electrical pulse signal transmitted from the voltage/time converter 210 via the coaxial cable 220, detects the time information representing the magnitude of the analog input signal converted by the voltage/time converter 210. Then, the time/digital converter 230, based on the detected time information, converts the time length (time interval) represented by the time information to a binary digital signal, that is, to a binary digital signal representing the magnitude of the analog input signal input to the A/D converter 200. The time/digital converter 230 outputs the converted digital signal to the divider 240. The time/digital converter 230 inputs at the input terminal 230a the electrical pulse signal transmitted from the voltage/time converter 210 via the coaxial cable 220, and outputs the detected time information from the output terminal 230b.

The divider 240 performs pre-established processing with respect to the digital signal input from the time/digital converter 230 and ultimately outputs a binary digital signal representing the magnitude of the analog input signal input to the A/D converter 200. The divider 240 inputs the time information output from the time/digital converter 230 at the input terminal 240a and outputs the ultimately converted digital output signal from the output terminal 240b.

In the A/D converter 200, the functions corresponding to the receiving unit 14 and the time interval converter 15 provided in the main unit 3 of the endoscope system 1 of the first preferred embodiment shown in FIG. 2 are performed by the time/digital converter 230 and the divider 240. By doing this, the analog input signal input to the A/D converter 200 is converted to a digital output signal, that is, A/D (analog/digital) converted. The details of the method of the time/digital converter 230 detecting the time information and converting the time information to the digital output signal, and the method of the divider 240 performing conversion to the ultimate digital output signal will be described later.

Next, the operation of the A/D converter 200 will be described in detail. More specifically, the method of the voltage/time converter 210 generating time information from the analog input signal and generating the electrical pulse signal from the time information, and the methods of the time/digital converter 230 detecting the time information and converting it to the digital output signal and of the divider 240 performing conversion to the ultimate digital output signal will be described with regard to specific examples.

Example of a Method of Generating Time Information from an Analog Input Signal and a Method of Generating an Electrical Pulse Signal from Time Information

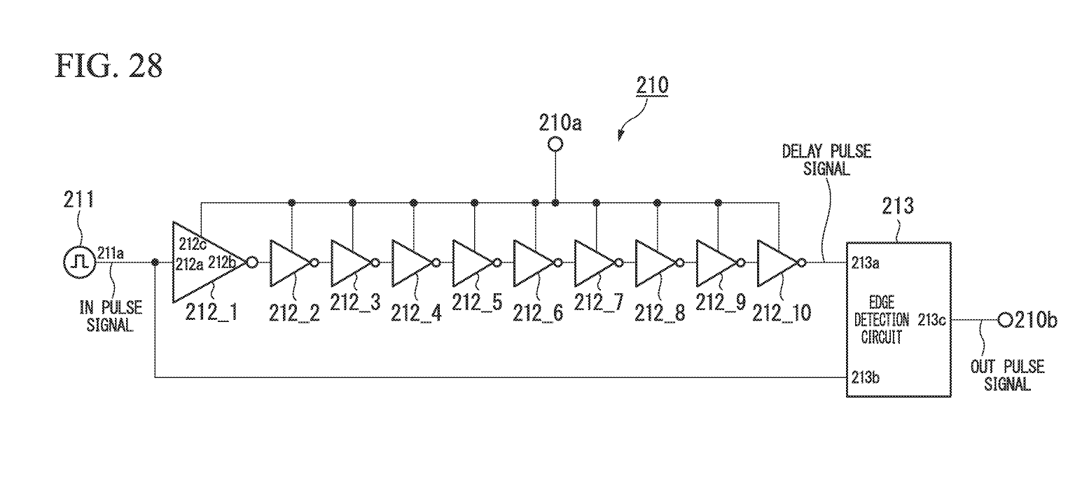

First, an example of the voltage/time converter 210 provided in the A/D converter 200 will be described. FIG. 28 is a block diagram showing an example of the general constitution of the voltage time converter 210 provided in the A/D converter 200 in accordance with the preferred embodiment of the present invention. FIG. 28 shows an example of the constitution of a voltage/time converter 210 in which 10 logical negation circuits (inverter circuits) are inverter circuits connected in series. In FIG. 28, the voltage/time converter 210 has a pulse generator 211, 10 inverter circuits 212_1 to 212_10, and an edge detection circuit 213. In the description to follow, when indicating any one of the inverter circuits 212_1 to 212_10, the expression “inverter circuit 212” will be used.

Each time an analog input signal is input to the voltage/time converter 210 at the input terminal 210a, the pulse generator 211 outputs to the output terminal 211a an IN pulse signal for the purpose of starting the conversion of the magnitude of the input analog input signals to a time.

An analog input signal input to the input terminal 210a of the voltage/time converter 210 is input as the power supply to the power supply terminals 212c of all of the inverter circuits 212. The IN pulse signal output by the pulse generator 211 is input to the first stage of the inverter circuit 212_1 at the input circuit 212a and, each inverter circuit 212 starting from the next stage inputs at the input terminal 212a the output signal from the previous stage of inverter circuit 212. Because the constitution of each of the inverter circuits 212 is the same as the inverter circuit 18 provided in the time converter 12 in the endoscope system 1 shown in FIG. 6, the detail description of operation of the inverter circuits 212 will be omitted.

Each inverter circuit 212 delays the IN pulse signal input to the input terminal 212a or the inverted (logically negated) signal of output signal of the previous stage of inverter circuit 212 by a delay time responsive to the voltage value of the power supply input to the power supply terminal 212c and outputs the resulting signal from the output terminal 212b. That is, each of the inverter circuits 212 delays a signal input to the input terminal 212a responsive to the voltage value of the analog input signal input to the power terminal 212c and outputs the resulting signal from the output terminal 212b. By doing this, a pulse signal (hereinafter referred to as the DELAY pulse signal) with a time delay commensurate with ten stages of the delays of the IN pulse signal generated by the pulse generator 211, responsive to the voltage value of the power supply input to the power supply terminal 212c, is output from the output terminal 212b of the final stage inverter circuit 212_10.

The IN pulse signal output from the output terminal 211a of the pulse generator 211 is a pulse signal representing the timing of the start of a time interval responsive to the magnitude of the input analog input signal. The DELAY pulse signal output from the output terminal 211b of the final stage inverter circuit 212_10 is a pulse signal representing the timing of the end of a time interval responsive to the magnitude of the input analog input signal. In the voltage/time converter 210, the IN pulse signal output by the pulse generator 211 and the DELAY pulse signal output by the inverter circuit 212_10 are time information for converting the magnitude of the input analog input signal to a time length.

The edge detection circuit 213 inputs the IN pulse signal output by the pulse generator 211 at input to an input terminal 213a and inputs the DELAY pulse signal output by the inverter circuit 212_10 at the input terminal 213b. The edge detection circuit 213 generates an electric pulse signal from the timing of the edge of the input IN pulse signal output by the pulse generator 211 to the timing of the edge of the DELAY pulse signal output by the inverter circuit 212_10, and the output terminal 213c outputs the generated electric pulse signal. When this is done, the electric pulse signal output from the output terminal 213c by the edge detection circuit 213 is output from the output terminal 210b as an OUT pulse signal that represents the magnitude of an analog input signal as a pulse width by the voltage/time converter 210.

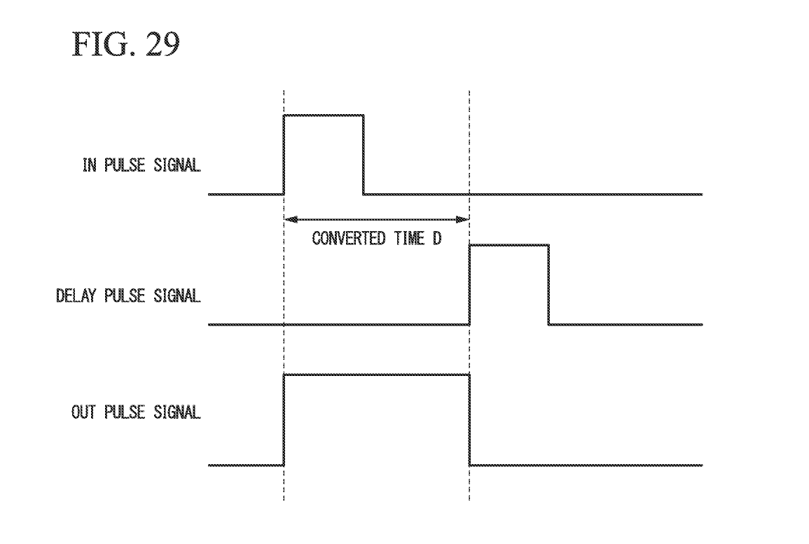

The operation of the voltage/time converter 210 will be described. FIG. 29 is a timing diagram showing the method of generating an electrical pulse signal in the voltage/time converter 210 provided in the A/D converter 200 in accordance with the preferred embodiment of the present invention. FIG. 29 shows the timing of generating time information from the input analog input signal and the timing of generating an electrical pulse signal from the time information.

The voltage/time converter 210 inputs as the power supply an analog input signal to be converted to a time at the input terminal 210a of voltage/time converter 210, after which, as shown in FIG. 29, the pulse generator 211 outputs an IN pulse signal from the output terminal 211a. Each of the inverter circuits 212 successively delays the IN pulse signal input to the input terminal 212a by a delay time responsive to the power supply input to the power supply terminal 212c, that is, the voltage value of an analog input signal, and, as shown in FIG. 29, the final stage inverter circuit 212_10 outputs from the output terminal 212b the DELAY pulse signal.

The time difference between the timing of the rising edge of the IN pulse signal output by the pulse generator 211 and the timing of the rising edge of the DELAY pulse signal output by the inverter circuit 212_10 is a time that is responsive to the magnitude of the analog input signal input as the power supply to the input terminal 210a of the voltage/time converter 210, that is, the converted time D when the analog input signal is converted to a time length.

The edge detector 213 outputs from the output terminal 213c, that is, the output terminal 210b of the voltage/time converting device 210 the electric pulse signal (OUT pulse signal) from the timing of the rising edge of the IN pulse signal input to the input terminal 213a and output by the pulse generator 211 to the timing of the rising edge of the DELAY pulse signal input to the input terminal 213b and output by the inverter circuit 212_10.

By doing this, the voltage/time converting device 210 provided in the A/D converter 200 generates time information, based on the input analog input signal, and output the electric pulse signal (OUT pulse signal) based on the generated time information.

The relationship between the analog input signal and the converted time D input to the voltage/time converter 210 is the first-order rational function, similar to the relationship between the pixel signal (power supply Vin) and the converted time D in the time converter 12 provided in the endoscope system 1 as shown in FIG. 7. That is, in the relationship between the pixel signal (power supply Vin) and the converted time D as shown in FIG. 7, the relationship represented by the above Equation (1) in which the pixel signal (power supply Vin) is considered to be substituted for the analog input signal exists. The detailed description regarding the relationship between the analog input signal and the converted time D in the voltage/time converter 210 will thus be omitted.

Example of a Method of Detecting Time information and Converting it to a Digital Output Signal and a Method of Converting that to the Ultimate Digital Output Signal

At the A/D converter 200, it is already known that the magnitude of the analog input signal will be converted to a time length by a converted time D expressed as in the above Equation (1). Given this, in the A/D converter 200, based on the priorly known relationship between the analog input signal and the converted time D, it is possible to generate the ultimate digital output signal having a substantially first-order functional relationship, such as shown in FIG. 8 of the endoscope system 1 of the first preferred embodiment.

More specifically, the time/digital converter 230 detects the time information representing the magnitude of the analog input signal from the electrical pulse signal transmitted from the voltage/time converter 210 via the coaxial cable 220 and, based on the detected time information, converts this to a binary digital signal that represents the magnitude of the analog input signal. The divider 240 then, by dividing a pre-established constant by the digital signal (converted time D) output from the time/digital converter 230, generates and outputs the ultimate digital output signal having the substantially first-order functional relationship such as shown in FIG. 8. In this case, if the pixel signal (power supply Vin) is substituted for the analog input signal, and the digital video signal is substituted for the digital signal output by the time/digital converter 230, the divider 240 performs generation by dividing an arbitrary constant A by the digital signal (converted time D). The result indicates a relationship (A/D) of a digital output signal that is proportional to the analog input signal and has a slope of A/b.

The constitution of the time/digital converter 230 is the same as that of the time interval converter 15 in the endoscope system 1. The divider 240 can be easily configured from general logic circuits. Because the operation of the time/digital converter 230 and the divider 240 converting the time information to the ultimate digital output signal is the same as the operation of the time interval converter 15 in the endoscope system 1, the detailed description of the constitution and the operation of the time/digital converter 230 and the divider 240 will be omitted.

As noted above, the A/D converter 200 generates, in the voltage/time converter 210, an electrical pulse signal having a relationship to the converted time D shown in the above Equation (1) and transmits the electrical pulse signal. The A/D converter 200 converts to a digital signal from the electrical pulse signal transmitted from the time/digital converter 230, and further by dividing an arbitrary pre-established constant in the divider 240 by the converted digital signal, generates the ultimate digital output signal. By doing this, in the A/D converter 200, a digital output signal having a relationship that is substantially proportional to the analog input signal can be generated, and the linearity of the A/D conversion can be improved.

In the A/D converter 200, each of the inverter circuits 212 in the voltage/time converter 210 is constituted the same as the inverter circuit 18 provided in the time converter 12 in the endoscope system 1 shown in FIG. 6. The result is that, in the A/D converter 200, an electrical pulse signal representing the magnitude of the input analog input signal by a time interval can be generated by a voltage/time converter 210 having a circuit with a scale that is small, such as shown in FIG. 28.

Also, in the A/D converter 200, although the description has been for the case in which the electrical pulse signal (OUT pulse signal) generated by the voltage time converter 210 is transmitted by the coaxial cable 220, which is a conductor (signal line) for transmitting an electrical signal, the method of transmitting the OUT pulse signal is not restricted to the method of transmission by the coaxial cable 220. For example, the voltage/time converter 210 may also convert the OUT pulse signal to an optical pulse signal and transmit the converted optical pulse signal by an optical fiber. In this case, it can be envisioned that a converter converting an electrical pulse signal to an optical signal is provided within the voltage/time converter 210, and a converter converting the optical pulse signal to an electrical pulse signal is provided within the time/digital converter 230.

### Another Constitution of the A/D Converter

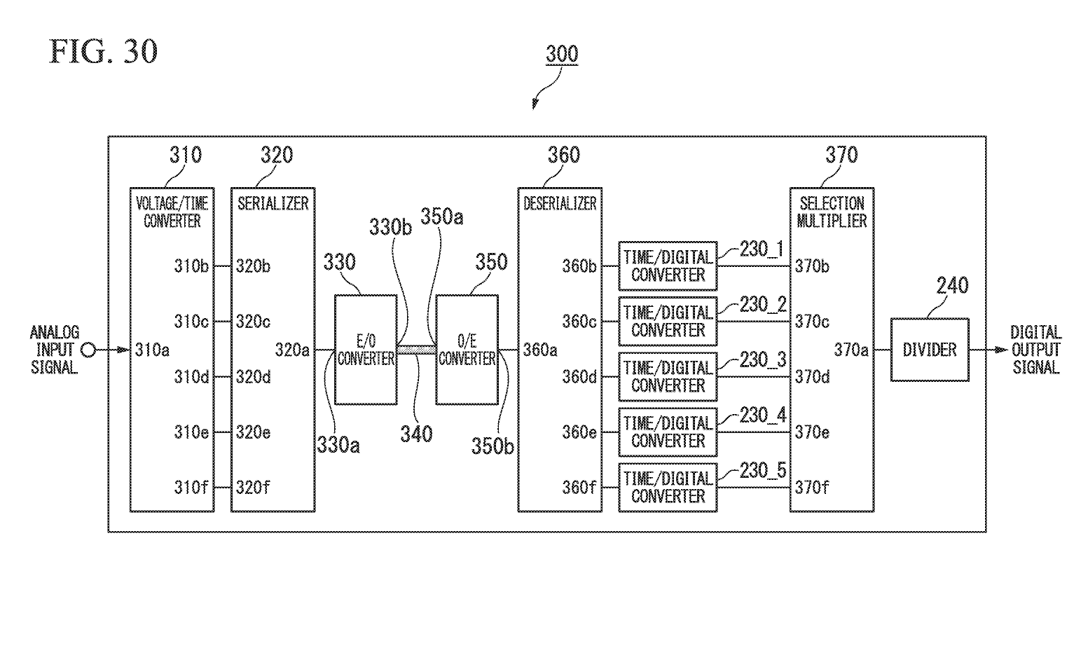

Next, another constitution of an A/D converter of the idea of the present invention that can be applied to various systems will be described. FIG. 30 is a block diagram showing another example of the general constitution of the A/D converter in accordance with the preferred embodiment of the present invention. In FIG. 30, an A/D converter 300 has a voltage/time converter 310, a serializer 320, an E/O converter 330, an optical fiber 340, an O/E converter 350, a deserializer 360, five time/digital converters 230_1 to 230_5, a selection multiplier 370, and a divider 240. The A/D converter 300 shown in FIG. 30, similar to the endoscope system 30 of the third preferred embodiment, is an example of a constitution in which the magnitude of the analog input signal is represented by five types of time information and transmits the timing information and, after conversion to five types of digital signals based on the transmitted time information, one digital signal is selected and output as the ultimate digital output signal. In the following description, constituent elements of the A/D converter 300 that are the same as constituent elements of the A/D converter 200 shown in FIG. 27 are described using the same reference numerals.

The voltage/time converter 310 outputs to the deserializer 320 each of a plurality of time information for the purpose of converting the magnitude of the analog input signal to a plurality of time lengths. More specifically, the voltage/time converter 310 generates a plurality of electrical pulse signals (OUT pulse signals) for the purpose of representing the magnitude of the analog input signal that is input by a plurality of different time widths (time intervals). The voltage/time converter 310 in the A/D converter 300 shown in FIG. 30 shows an example of the case in which the magnitude of the analog input signal is represented by five types of time information.

The voltage/time converter 310 inputs the analog input signal at the input terminal 310a and outputs the generated five types OUT pulse signals from the output terminals 310b to 301f. In this case, the voltage/time converter 310 is constituted so that if the time width represented by the OUT pulse signal output from the output terminal 310b is one-times, the time widths represented by the OUT pulse signals output from the output terminals 310c to 310f are two-times, three-times, four-times, and five-times. The constitution of the voltage/time converter 310 and the method of the voltage/time converter 310 generating a plurality of time information from the analog input signal will be described in detail later.

The serializer 320 is a parallel-serial converter that, based on the plurality of OUT pulse signals input from the voltage/time converter 310, generates one electrical pulse signal (hereinafter “serial signal”) that includes the plurality of time information. More specifically, the serializer 320 parallel-serial converts the five types of OUT pulse signals input in parallel from the voltage/time converter 310, generates one serial signal that represents each of the five types of time information by a pulse width, and outputs the generated serial signal to the E/O converter 330.

The serializer 320 inputs the five types of OUT pulse signals output from the voltage/time converter 310 at the input terminals 320b to 320f, and outputs the generated serial signal from the output terminal 320a. The method of the serializer 320 generating one serial signal from the plurality of OUT pulse signals will be described in detail later.

The E/O converter 330 converts the electrical pulse signal (serial signal) input from the serializer 320 to an optical pulse signal, and outputs the converted optical pulse signal to the optical fiber 340. The E/O converter 330 inputs the serial signal output from the serializer 320 at the input terminal 330a and outputs the converted optical pulse signal from the output terminal 330b.

In the A/D converter 300, the functions corresponding to the time converter 19 and the transmitting unit 21 provided in the distal end 53 of the endoscope system 30 of the third preferred embodiment shown in FIG. 17 are performed by the voltage/time converter 310, the serializer 320, and the E/O converter 330. By doing this, a plurality of time information representing the magnitude of the analog input signal input to the A/D converter 300 are transmitted. In the A/D converter 300, similar to the endoscope system 30, the example shown is that of transmitting the time information by an optical pulse signal.

The optical fiber 340 transmits to the O/E converter 350 the optical pulse signal transmitted from the E/O converter 330. The optical fiber 340 is the same as the optical waveguide (optical fiber) provided in the transfer section 10 in the endoscope system 30.

The O/E converter 350 converts the optical pulse signal transmitted from the E/O converter 330 via the optical fiber 340 once again to an electrical pulse signal (serial signal) and outputs the converted serial signal to the deserializer 360. The O/E converter 350 inputs optical pulse signal transmitted from the E/O converter 330 by the optical fiber 340 at the input terminal 350a and outputs the converted serial signal from the output terminal 350b.

The deserializer 360, is a parallel-serial converter that, based on one serial signal input from the O/E converter 350, generates OUT pulse signals that are equivalent to the OUT pulse signals representing the plurality of different time lengths and that are output from by the voltage/time converter 310. More specifically, the deserializer 360 serial-parallel converts the serial signal input from the O/E converter 350, generates a plurality of OUT pulse signals that represent each of the plurality of time information represented by the serial signal once again by separate pulse widths, and outputs each of the generated OUT pulse signals to the corresponding time/digital converter 230. In FIG. 30, the deserializer 360 shows the example of a case in which the outputs to the corresponding time/digital converters 230_1 to 230_5 OUT pulse signals equivalent to the five types of OUT pulse signals generated by the voltage/time converter 310 and transmitted as one serial signal.

The deserializer 360 inputs the serial signal output from the O/E converter 350 at the input terminal 360a and outputs the generated five types of OUT pulse signals from the output terminals 360b to 360f. The method of the deserializer 360 generating the plurality of OUT pulse signals from one serial signal will be described in detail later.

The time/digital converters 230_1 to 230_5, based on the OUT pulse signals input from the deserializer 360, detect the corresponding time information representing the magnitude of the analog input signal converted by the voltage/time converter 310, and convert time intervals represented by each of the detected time information to a binary digital signal. Each of the time/digital converters 230_1 to 230_5 outputs the respective converted digital signal to the selection multiplier 370. Each of the time/digital converters 230_1 to 230_5 corresponds to one of the five types of time width represented by the OUT pulse signals output from the output terminals of the voltage/time converter 310. In the example of the constitution shown in FIG. 30, the time/digital converters 230_1 to 230_5 in the A/D converter 300 correspond to each of the respective five types of time information output by the voltage/time converter 310. In the following description, when indicating any one of the time/digital converters 230_1 to 230_5, the expression “time/digital converter 230” will be used.

More specifically, the time/digital converter 230_1 corresponds to the time width of the time information (OUT pulse signal) output from the output terminal 310b of the voltage/time converter 310, and outputs a digital signal representing a one-times time width. The time/digital converter 230_2 corresponds to the time width of the time information (OUT pulse signal) output from the output terminal 310c of the voltage/time converter 310, and outputs a digital signal representing a two-times time width. The time/digital converter 230_3 corresponds to the time width of the time information (OUT pulse signal) output from the output terminal 310d of the voltage/time converter 310, and outputs a digital signal representing a three-times time width. The time/digital converter 230_4 corresponds to the time width of the time information (OUT pulse signal) output from the output terminal 310e of the voltage/time converter 310, and outputs a digital signal representing a four-times time width. The time/digital converter 230_5 corresponds to the time width of the time information (OUT pulse signal) output from the output terminal 310f of the voltage/time converter 310, and outputs a digital signal representing a five-times time width. Because the function and the operation of each of the time/digital converters 230_1 to 230_5 are the same as the time digital converter 230 provided in the A/D converter 200, the detailed description thereof will be omitted.

The selection multiplier 370 selects, from among the plurality of digital signals input from each of the time/digital converters 230_1 to 230_5, a digital signal of the digital signals that has the longest time interval before conversion, for which the conversion has been completed within a pre-established A/D conversion signal processing time, multiplies by a pre-established constant in accordance with the selected digital signal, and outputs the result to the divider 240. The selection multiplier 370 in the A/D converter 300 shown in FIG. 30 shows an example of a constitution in which one digital signal is selected from five types of digital signal representing the magnitude of the analog input signal. The selection multiplier 370 inputs the five types of OUT pulse signals output from the respective time/digital converters 230_1 to 230_5 at the input terminals 370b to 370f and outputs the digital signal multiplied by the pre-established constant from the output terminal 370a.

In the selection multiplier 370, the constant by which the selected digital signal is multiplied is a constant such that, regardless of from which of the time/digital converters 230_1 to 230_5 the digital signal input from the time/digital converters 230 is selected, it is possible to perform processing of the digital signal representing the analog input signal of the same magnitude, using the same scale. By doing this, regardless of from which time/digital converter 230 the digital signal representing the analog input signal of the same magnitude is output, the same digital signal from the selection multiplier 370 can be output to the divider 240.

More specifically, consider the case in which the selection multiplier 370, similar to the selecting device 23 in the endoscope system 30, outputs to the divider 240 the digital signal input from the time/digital converter 230_1, for example, the digital signal multiplied by 60 that is a pre-established fixed multiplier, that is, a digital signal having the time width of one-times made to the digital signal multiplied by 60, which is the minimum common multiplier among the time widths from one-times to five-times. When this is done, if the selection multiplier 370 selects the digital signal input from the time/digital converter 230_1 as the largest digital signal, that is, if it selects the digital signal based on the time information representing the one-times time width output by the voltage/time converter 310, the selected digital signal is multiplied by 60 and output to the divider 240. If the selection multiplier 370 selects the digital signal input from the time/digital converter 230_2 as the largest digital signal, that is, if it selects the digital signal based on the time information representing the two-times time width output by the voltage/time converter 310, the selected digital signal is multiplied by 30 and output to the divider 240. If the selection multiplier 370 selects the digital signal input from the time/digital converter 230_3 as the largest digital signal, that is, if it selects the digital signal based on the time information representing the three-times time width output by the voltage/time converter 310, the selected digital signal is multiplied by 20 and output to the divider 240. If the selection multiplier 370 selects the digital signal input from the time/digital converter 230_4 as the largest digital signal, that is, if it selects the digital signal based on the time information representing the four-times time width output by the voltage/time converter 310, the selected digital signal is multiplied by 15 and output to the divider 240. If the selection multiplier 370 selects the digital signal input from the time/digital converter 230_5 as the largest digital signal, that is, if it selects the digital signal based on the time information representing the five-times time width output by the voltage/time converter 310, the selected digital signal is multiplied by 12 and output to the divider 240. By doing this, regardless of from which time/digital converter 230 of the time/digital converters 230_1 to 230_5 the digital signal output from the selection multiplier 370 to the divider 240 is selected, it is a digital signal representing the analog input signal of the same scale.

In this manner, by the selection multiplier 370 performing multiplication processing with respect to the digital signal that is output, responsive to the characteristic (multiplier) when the time information is output by the voltage/time converter 310, at the divider 240, regardless of from which time/digital converter 230 of the time/digital converters 230_1 to 230_5 the digital signal is output, processing can be done with the same scale. The method of the selection multiplier 370 selecting one digital signal from the plurality of digital signals will be described in detail later.

The divider 240 performs the pre-established processing with respect to the digital signal input from the selection multiplier 370 and outputs the ultimate binary digital signal representing the magnitude of the analog input signal input to the A/D converter 300. Because the function and operation of the divider 240 are the same as the divider 240 provided in the A/D converter 200, the detailed description thereof will be omitted.

In the A/D converter 300, the functions corresponding to the receiving unit 22, the five time interval converters 15_1 to 15_5, and the selecting device 23 provided in the main unit 33 of the endoscope system 30 of the third preferred embodiment shown in FIG. 17 are performed by the O/E converter 350, the deserializer 360, the five time/digital converters 230_1 to 230_5, the selection multiplier 370, and the divider 240. By doing this, the analog input signal input to the A/D converter 300 is converted to a digital output signal, that is, A/D (analog/digital) converted. Because the method of the time/digital converters 230 detecting the time information and converting to a digital output signal from the time information and the method of the divider 240 converting to the ultimate digital output signal are the same as the respective methods in the A/D converter 200, the detailed description thereof will be omitted.

Next, the operation of the A/D converter 300 will be described in detail. Specifically, the method of the voltage/time converter 310 generating a plurality of time information from the analog input signal, the method of the serializer 320 generating one serial signal from the plurality of OUT pulse signals, the method of the deserializer 360 generating a plurality of OUT pulse signals from one serial signal, and the method of the selection multiplier 370 selecting one digital signal from the plurality of digital signals will be described with regard to specific examples. In this case, an example will be described of the method of the voltage/time converter 310 generating five types of time information and the serializer 320 generating one serial signal from five types of OUT pulse signals, and the method of the deserializer 360 generating five types of OUT pulse signals from one serial signal and the selection multiplier 370 selecting one digital signal from five types of digital signals.

Example of a Method of Generating Five Types of Time Information from an Analog Input Signal and a Method of Generating One Serial Signal from Five Types of OUT Pulse Signals

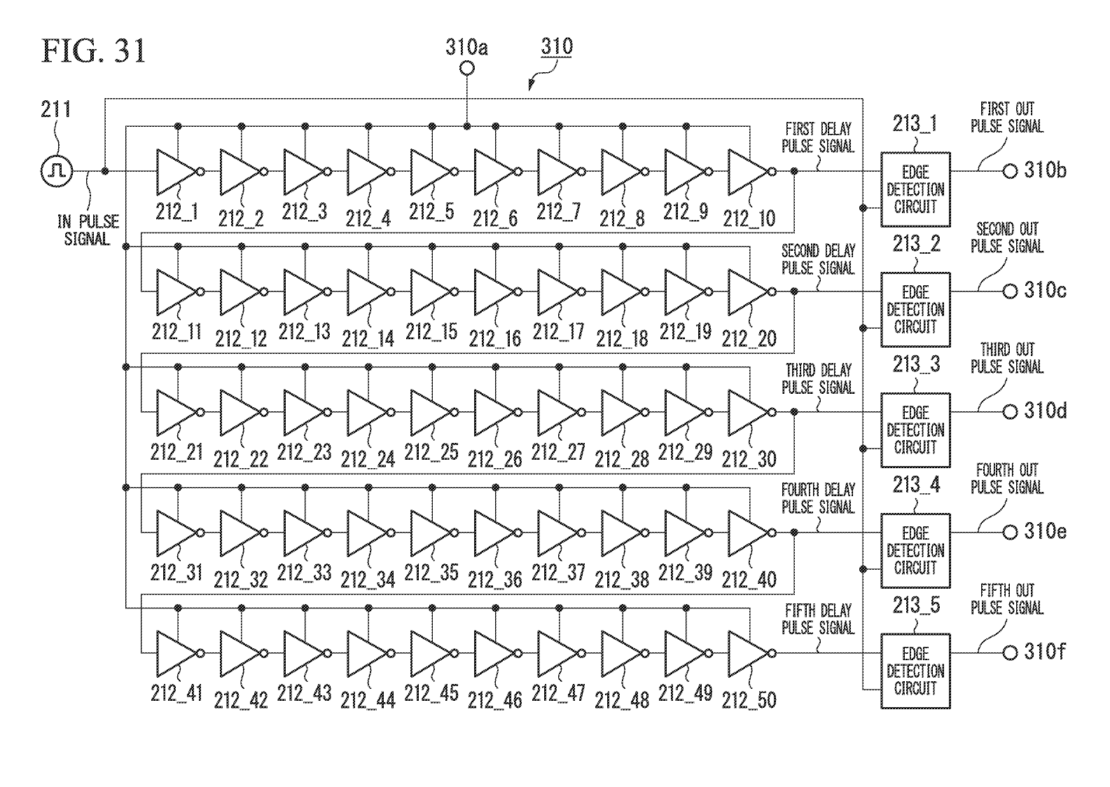

First, an example of the voltage/time converter 310 provided in the A/D converter 300 will be described. FIG. 31 is a block diagram of an example of the general constitution of the voltage/time converter 310 provided in the A/D converter 300 that is an A/D converter in accordance with another preferred embodiment of the present invention. FIG. 31 shows an example of the constitution of the voltage/time converter 310 in which 50 inverter circuits are connected in series. In FIG. 31, the voltage/time converter 310 has a pulse generator 211, 50 inverter circuits 212_1 to 212_50, and five edge detection circuits 213_1 to 213_5.

The voltage/time converter 310 differs only in that it increases the number of the inverter circuits 212 of the voltage/time converter 210 provided in the A/D converter 200 shown in FIG. 28, has the edge detection circuits 213 at each of 10 inverter circuits 212, and outputs OUT pulse signals by the edge detection circuits 213.

In the description to follow, therefore, constituent elements having the same function and operation as in the voltage/time converter 210, which is provided in the A/D converter 200, are assigned the same reference numerals, and the detailed description of the constituent elements of the voltage/time converter 310 will be omitted. When indicating any one of the inverter circuits 212_1 to 212_50, similar to the time converter 12 shown in FIG. 28, the expression “inverter circuit 212” will be used. When indicating any one edge detecting circuit 213 of the edge detection circuits 213_1 to 213_5, the expression “edge detecting circuit 213” will be used.

In the voltage/time converter 310 one circuit group is constituted by a pulse generator 211, inverter circuits 212_1 to 212_10, and an edge detection circuit 213_1. The voltage/time converter 310 has one circuit group constituted by a pulse generator 211, inverter circuits 212_1 to 212_20, and an edge detection circuit 213_2. The voltage/time converter 310 also has one circuit group constituted by a pulse generator 211, inverter circuits 212_1 to 212_30, and an edge detection circuit 213_3. The voltage/time converter 310 also has one circuit group constituted by a pulse generator 211, inverter circuits 212_1 to 212_50, and an edge detection circuit 213_4. The voltage/time converter 310 also has one circuit group constituted by a pulse generator 211, inverter circuits 212_1 to 212_50, and an edge detection circuit 213_5. Each circuit group constituted in the voltage/time converter 310 operates the same as the voltage/time converter 210 provided in the A/D converter 200. Each circuit group outputs the OUT pulse signal representing the magnitude of the analog input signal that is input by a pulse width that corresponds to the delay time for the number of stages of the inverter circuit 212.

Each time an analog input signal is input to the voltage/time converter 310, the pulse generator 211 outputs the IN pulse signal for the purpose of starting of the conversion of the magnitude of the input analog input signal to a time.

An analog input signal input to the input terminal 310a of the voltage/time converter 310 is input as the power supply to the power supply terminals 212c of all of the inverter circuits 212. Each of the inverter circuits 212 delays a signal that is the logical negation of the IN pulse signal input to the input terminal 212a or of the output signal of the previous stage of the inverter circuit 212 by a delay time responsive to the voltage value of the power supply input to the power supply terminal 212c and outputs the signal from the output terminal 212b.

By doing this, a first DELAY pulse signal that is the IN pulse signal delayed by a delay time for 10 stages is output from the output terminal 212b of the inverter circuit 212_10. A second DELAY pulse signal that is the IN pulse signal delayed by a delay time for 20 stages, that is, by twice the delay time of the first DELAY pulse signal, is output from the output terminal 212b of the inverter circuit 212_20. A third DELAY pulse signal that is the IN pulse signal delayed by a delay time for 30 stages, that is, by three times the delay time of the first DELAY pulse signal, is output from the output terminal 212b of the inverter circuit 212_30. A fourth DELAY pulse signal that is the IN pulse signal delayed by a delay time for 40 stages, that is, by four times the delay time of the first DELAY pulse signal, is output from the output terminal 212b of the inverter circuit 212_40. A fifth DELAY pulse signal that is the IN pulse signal delayed by a delay time for 50 stages, that is, by five times the delay time of the first DELAY pulse signal, is output from the output terminal 212b of the inverter circuit 212_50.

The IN pulse signal output from the output terminal 211a of the pulse generator 211 is a pulse signal representing the timing of the start of the time interval responsive to the magnitude of the input analog input signal. The first DELAY pulse signal to the fifth DELAY pulse signal output from the respective output terminals 212b of the inverter circuit 212c for each of 10 stages are each pulse signals representing the timing of the end of the time interval responsive to the magnitude of the input analog input signal. In the voltage/time converter 310, the IN pulse signal output by the pulse generator 211 and the first DELAY pulse signal to the fifth DELAY pulse signal output by each inverter circuit 212c for each 10 stages are time information for the purpose of converting the magnitude of the analog input signal that is input to one- to five-time time lengths. In the description that follows, when indicating any one of the first DELAY pulse signal to the fifth DELAY pulse signal, the expression “DELAY pulse signal” will be used.

Each of the edge detection circuits 213_1 to 213_5 inputs at the input terminal 213a an IN pulse signal output by the pulse generator 211 and inputs at the input terminal 231b a DELAY pulse signal output by the corresponding inverter circuit 212. Each of the edge detection circuits 213_1 to 213_5 generates an electrical pulse signal from the timing of the edge of the input IN pulse signal output by the input pulse generator 211 until the timing of the edge of the DELAY pulse signal output by the corresponding inverter circuit 212, and outputs the generated electrical pulse signal as the corresponding OUT pulse signal from the output terminal 213c.

More specifically, the voltage/time converter 310 outputs as the first OUT pulse signal from the output terminal 310b the OUT pulse signal generated by the edge detection circuit 213_1 based on the IN pulse signal output by the pulse generator 211 and the first DELAY pulse signal output by the inverter circuit 212_10. The voltage/time converter 310 also outputs as the second OUT pulse signal from the output terminal 310c the OUT pulse signal generated by the edge detection circuit 213_2 based on the IN pulse signal output by the pulse generator 211 and the second DELAY pulse signal output by the inverter circuit 212_20. The voltage/time converter 310 also outputs as the third OUT pulse signal from the output terminal 310d the OUT pulse signal generated by the edge detection circuit 213_3 based on the IN pulse signal output by the pulse generator 211 and the third DELAY pulse signal output by the inverter circuit 212_30. The voltage/time converter 310 also outputs as the fourth OUT pulse signal from the output terminal 310e the OUT pulse signal generated by the edge detection circuit 213_4 based on the IN pulse signal output by the pulse generator 211 and the fourth DELAY pulse signal output by the inverter circuit 212_40. The voltage/time converter 310 also outputs as the fifth OUT pulse signal from the output terminal 310f the OUT pulse signal generated by the edge detection circuit 213_5 based on the IN pulse signal output by the pulse generator 211 and the fifth DELAY pulse signal output by the inverter circuit 212_50.

The first OUT pulse signal to the fifth OUT pulse signal output from the respectively output terminals 310b to 310f of the voltage/time converter 310 are pulse signals representing the time intervals responsive to the magnitude of the input analog input signal. That is, the first OUT pulse signal to fifth OUT pulse signal output by the voltage/time converter 310 are OUT pulse signals with which the voltage/time converter 310 represents the magnitude of the analog input signal by one-times, two-times, three-times, four-times, and five-times pulse widths. In the following description, when indicating one OUT pulse signal of the first OUT pulse signal to fifth OUT pulse signal, the term “OUT pulse signal” will be used.

By the above-described constitution, the voltage/time converter 310 outputs from the output terminals 310b to 310f the five types of time information representing the magnitude of an analog input signal, that is, the five types of time information that are the one-times to five-times time width when the time width indicated by the OUT pulse signal output from the output terminal 310b is taken as being one-times.

The serializer 320 detects the edges of each of the first OUT pulse signal to fifth OUT pulse signal input to the input terminals 320b to 320f, and generates electrical pulse signals the logical value of which inverts at the timing of every rising edge or falling edge of the respective detected OUT pulse signals. That is, the serializer 320 converts each of the five types of time information represented by the respective OUT pulse signals input from the voltage/time converter 310 to one serial signal represented as binary values. The serializer 320 then outputs the generated serial signal from the output terminal 320a.

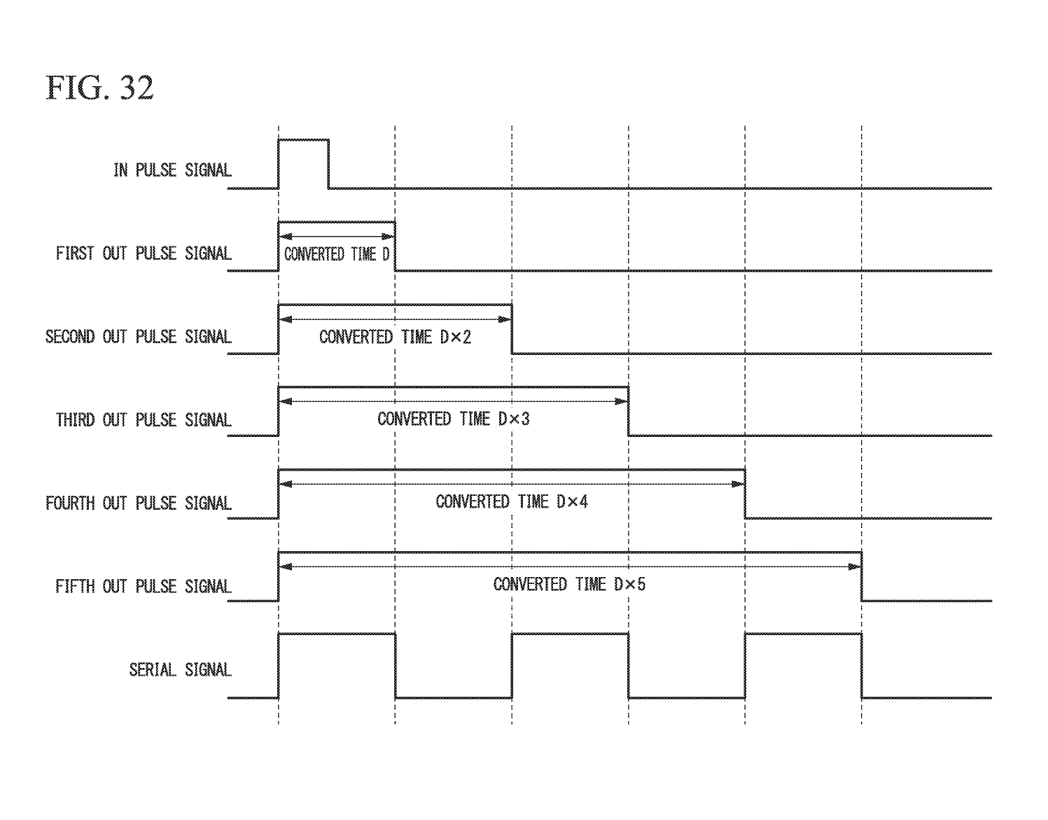

The operation of the voltage/time converter 310 will now be described. FIG. 32 is a timing diagram showing the method of generating electrical pulse signals in the voltage/time converter 310 and the serializer 320 provided in the A/D converter 300 that is an A/D converter in accordance with another preferred embodiment of the present invention. FIG. 32 shows the timing of the generation of five types of time information (first OUT pulse signal to fifth OUT pulse signal) from the analog input signal input by the voltage/time converter 310, and the generation by the serializer 320 of one serial signal from the five types of OUT pulse signals.

After the voltage/time converter 310 inputs an analog input signal to be converted to a time at the input terminal 310a of the voltage/time converter 310 as a power supply, the pulse generator 211 outputs an IN pulse signal such as shown in FIG. 32 from the output terminal 211a. Then, each of the inverter circuits 212 outputs from the respective output terminals 212b a DELAY pulse signal that is delayed successively by a delay time responsive to the power supply that is the IN pulse signal input at the input terminal 212a and input to the power supply terminal 212c, that is, to the voltage value of the analog input signal. More specifically, the inverter circuit 212_10 outputs the first DELAY pulse signal, the inverter circuit 212_20 outputs the second DELAY pulse signal, the inverter circuit 212_30 outputs the third DELAY pulse signal, the inverter circuit 212_40 outputs the fourth DELAY pulse signal, and the inverter circuit 212_50 outputs the fifth DELAY pulse signal, from each respective output terminal 212b.

Each of the edge detection circuits 213 outputs from the output terminal 213c an electrical pulse signal (OUT pulse signal) from the timing of the rising edge of the IN pulse signal output by the pulse generator 211 that has been input to the input terminal 213a to the timing of the rising edge of the DELAY pulse signal that has been input to the input terminal 213b and output by the corresponding inverter circuit 212. More specifically, the edge detection circuit 213_1 outputs the first OUT pulse signal, the edge detection circuit 213_2 output the second OUT pulse signal, the edge detection circuit 213_3 outputs the third OUT pulse signal, the edge detection circuit 213_4 outputs the fourth OUT pulse signal, and the edge detection circuit 213_5 outputs the fifth OUT pulse signal, from the respective output terminals 213c.

By doing this, as shown in FIG. 32, the voltage/time converter 310 outputs as time information the first OUT pulse signal output by the edge detection circuit 213_1, the second OUT pulse signal output by the edge detection circuit 213_2, the third OUT pulse signal output by the edge detection circuit 213_3, the fourth OUT pulse signal output by the edge detection circuit 213_4, and the fifth OUT pulse signal output from the edge detection circuit 213_5, from the output terminals 310b to 310f.

As described above, each of the circuit groups in the voltage/time converter 310 operates in the same manner as the voltage/time converter 210 provided in the A/D converter 200. Therefore, each of the DELAY pulse signals in each of the circuit groups is an electrical pulse signal having a delay time with respect to the IN pulse signal that is responsive to the magnitude of the analog input signal input. Also, the pulse width of each of the OUT pulse signals output by the voltage/time converter 310 represents a time width responsive to the magnitude of the input analog input signal.

As described above, the pulse width of the first OUT pulse signal corresponds to the IN pulse signal delayed by a delay time of 10 stages, the pulse width of the second OUT pulse signal corresponds to the IN pulse signal delayed by a delay time of 20 stages, the pulse width of the third OUT pulse signal corresponds to the IN pulse signal delayed by a delay time of 30 stages, the pulse width of the fourth OUT pulse signal corresponds to the IN pulse signal delayed by a delay time of 40 stages, and the pulse width of the fifth OUT pulse signal corresponds to the IN pulse delayed by a delay time of 50 stages. Therefore, if the pulse width of the first OUT pulse signal is the one-times time responsive to the magnitude of the analog input signal, that is, is one-times the converted time D when the analog input signal is converted to a time length, each of the pulse widths of the second OUT pulse signal to the fifth OUT pulse signal are in the relationship of two-times (converted time D×2), three-times (converted time D×39, four-times (conversion time D×49 and five-times (converted time D×5).

As shown in FIG. 32, the serializer 320, based on the edges of the first OUT pulse signal to the fifth OUT signals that are input, inverts the logical values and generates one serial signal that represents as a binary value each of the five types of time information represented by the respective OUT pulse signals. More specifically, as shown in FIG. 32, at the rising edge of the first OUT pulse signal the level is made high and at the falling edge of the first OUT pulse signal the level is made low, after which the serial signal is generated in which the logical value is inverted at the falling edges of each of the second OUT pulse signal to the fifth OUT pulse signal. By doing this, one serial signal that has all of the five types of time information of the first OUT pulse signal to the fifth OUT pulse signal can be generated, that is, parallel-serial conversion can be done. Because the serializer 320 can be easily configured with general logic circuits, a detailed description regarding the specific circuit configuration will be omitted.

The E/O converter 330 converts the serial signal input from the serializer 320 to an optical pulse signal and outputs the converted optical pulse signal to the optical fiber 340. The optical pulse signal output to the optical fiber 340 by the E/O converter 330, for example, emits light when the serial signal is the high level and is extinguished when the serial signal is the low level.

The O/E converter 350 converts the optical pulse signal transferred from the E/O converter 330 via the optical fiber 340 to a serial signal once again, and outputs the converted serial signal to the deserializer 360. The serial signal output by the O/E converter 350 to the deserializer 360 is, for example, a serial signal that is high level when the optical pulse signal emits light and is low level with the optical pulse signal is extinguished.

If the time information is represented and transmitted as a pulse width of a pulse signal, offset in the edge of the pulse signal leads directly to an error in the A/D conversion. This is because the edge timing of the pulse signal is information that represents the magnitude of the analog input signal that is input. For example, if a pulse signal is transmitted by a conductive line having a large resistive component, the resistive component of the conductive line causes the rising and falling edges of the pulse signal to be damped, making it impossible to transmit the timing of the rising and falling edges of the pulse signal accurately. For this reason, in an A/D converter it is desired to avoid a change of the slope of the edges of a pulse signal as much as possible, that is, a change of the timing of the rising and falling edges of a pulse signal caused by losses occurring in transmission of the pulse signal. In the A/D converter 300, as described above, the transmission loss of the pulse signal is reduced by transmitting an optical pulse signal that is converted from a serial signal to an optical signal, thereby maintain the edge slope of the pulse signal, so that, even if the serial signal is transmitted over a long distance, error in the time information that is transmitted can be suppressed.

Example of a Method of Generating Five Types of OUT Pulse Signals from One Serial Signal

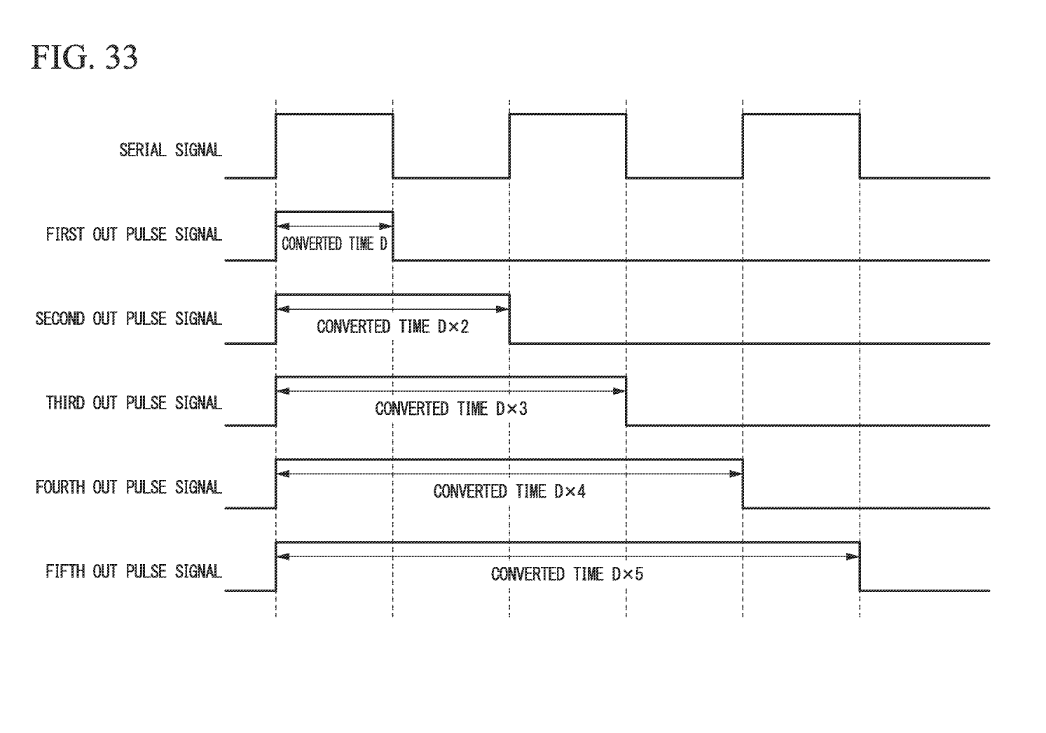

Continuing, the operation of the deserializer 360 provided in the A/D converter 300 will be described. FIG. 33 is a timing diagram showing the method of generating the electrical pulse signal in the deserializer 360 provided in the A/D converter 300, which is an A/D converter in another preferred embodiment of the present invention. FIG. 33 shows the timing of generating five types of time information (first OUT pulse signal to fifth OUT pulse signal) from one serial signal input by the deserializer 360.

When the deserializer 360 inputs at the input terminal 360a a serial signal from the O/E converter 350 such as shown in FIG. 33, and detects each of the edges of the input serial signal. The deserializer 360 then, based on the timing of the each of the detected edges, generates the five types of OUT pulse signals equivalent to the five types of OUT pulse signals that have been output by the voltage/time converter 310, and outputs the generated five types of OUT pulse signals from the respective output terminals 360b to 360f.

More specifically, the deserializer 360 generates an electrical pulse signal rising at the timing of the first rising edge of the serial signal and falling at the first falling edge thereof, that is, an electrical pulse signal representing the converted time D, and outputs this as the first OUT pulse signal from the output terminal 360b. The deserializer 360 also generates an electrical pulse signal rising at the timing of the first rising edge of the serial signal and falling at the second falling edge thereof, that is, an electrical pulse signal representing the converted time D×2 that is two-times converted time D, and outputs this as the second OUT pulse signal from the output terminal 360c. The deserializer 360 also generates an electrical pulse signal rising at the timing of the first rising edge of the serial signal and falling at the second falling edge thereof, that is, an electrical pulse signal representing the converted time D×3 that is three-times converted time D, and outputs this as the third OUT pulse signal from the output terminal 360d. The deserializer 360 also generates an electrical pulse signal rising at the timing of the first rising edge of the serial signal and falling at the three rising edge thereof, that is, an electrical pulse signal representing the converted time D×4 that is four-times converted time D, and outputs this as the fourth OUT pulse signal from the output terminal 360e. The deserializer 360 also generates an electrical pulse signal rising at the timing of the first rising edge of the serial signal and falling at the third falling edge thereof, that is, an electrical pulse signal representing the converted time D×5 that is fifth-times converted time D, and outputs this as the fifth OUT pulse signal from the output terminal 360f.

By doing this, as shown in FIG. 33, the deserializer 360 outputs the first OUT pulse signal to the corresponding time/digital converter 230_1, the second OUT pulse signal to the corresponding time/digital converter 230_2, the third OUT pulse signal to the corresponding time/digital converter 230_3, the fourth OUT pulse signal to the corresponding time/digital converter 230_4, and the fifth OUT pulse signal to the corresponding time/digital converter 230_5, such as the OUT pulse signals. Because the deserializer 360 can be easily configured from general logic circuits, a detailed description of the specific circuit constitution thereof will be omitted.

Each of the time/digital converters 230_1 to 230_5, similar to the time/digital converter 230 provided in the A/D converter 200, based on the respective OUT pulse signals input from the deserializer 360, detects the time information representing the magnitude of the converted analog input signal by the voltage/time converter 310, and converts the time intervals represented by each of the time information that has been detected to binary digital signals. The time/digital converters 230_1 to 230_5 then output the converted digital signals to the selection multiplier 370.

FIG. 32 shows a timing chart for the case of the voltage/time converter 310 outputting all of the IN pulse signals and first to fifth OUT pulse signals, that is, all of the five types of time information. However, if a plurality of analog input signals to be converted to time are successively input, the amount of time in which the voltage/time converter 310 can use in the output of time information based on the magnitudes of the input analog input signals might be the same time, regardless of the magnitude of the analog input signal. That is, the amount of time in which the voltage/time converter 310 can use for outputting time information responsive to the magnitude of one analog input signal might be limited to a pre-established signal processing period of time. For this reason, for example, if the analog input signal voltage value is small, the IN pulse signal output by the pulse generator 211 might not pass through all of the inverter circuits 212 provided in the voltage/time converter 310, thereby preventing output of all the OUT pulse signals from the first OUT pulse signal to the fifth OUT pulse signal.

Given the above, the voltage/time converter 310 is provided with a function that resets the processing of conversion of the currently input analog input signal to time information each time the signal processing time elapsed. Even if all five types of time information are not output, the voltage/time converter 310 resets the processing for each period of the signal processing time, so as to prepare for the processing for conversion to time information of the next analog input signal to be input. By doing this, the voltage/time converter 310 outputs the IN pulse signal and the OUT pulse signals up to the inverter circuit 212 to which the IN pulse signal has passed as time information, each time period of the signal processing time.

By doing this, among the time/digital converters 230_1 to 230_5, there might be the time/digital converters 230 to which an electrical pulse signal from the deserializer 360 is not input. The selection multiplier 370 selects the digital signal from among the time/digital converters 230 that input electrical pulse signals from the deserializer 360 within the signal processing time and outputs the maximum digital signal of the time/digital converters 230 converting the pulse width of this pulse signal to the selected digital signal to the divider 240.

Example of a Method of Selecting a Digital Signal Converted from Five Types of Digital Signals

Next, an example of the method of the selection multiplier 370 provided in the A/D converter 300 selecting a digital signal will be described. The relationship between the analog input signal that the voltage/time converter 310 provided in the A/D converter 300 converts to time information and the converted time D is a first-order rational function, similar to the relationship between the pixel signal (power supply Vin) that the time converter 19 provided in the endoscope system 30 shown in FIG. 20 converts to time information and the converted time D. That is, in the relationship between the pixel signal (power supply Vin) and the converted time D shown in FIG. 20, the relationship obtains in which the pixel signal (power supply Vin) is substituted by the analog input signal, and the video signal processing time is substituted by the signal processing time. The detailed description regarding the relationship between the analog input signal and the converted time D in the voltage/time converter 310 will thus be omitted.

Also in the A/D converter 300, the voltage/time converter 310, similar to the pixel signal (power supply Vin) and the converted time D as shown in FIG. 20, has five types of input/output characteristics that are related by first-order rational functions. The signal processing time of the voltage/time converter 310 is overlaid onto the input/output characteristics of the voltage/time converter 310, as shown in FIG. 20, thereby enabling division into five regions (regions M1 to M5), in accordance with the range of the magnitude of the voltage value of the analog input signal.

Also in A/D converter 300, the voltage/time converter 310 thus, in response to the voltage value of the analog input signal, outputs a different number of time information, so that the electrical pulse signals from the deserializer 360 are not input to all of the time/digital converters 230. For this reason, selection multiplier 370 does not input the digital signals from all of the time/digital converters 230.

The selection multiplier 370 receives converted digital signals in the sequence from the time/digital converters 230_1 to the time/digital converters 230_5, and selects the digital signal received last from the time/digital converters 230 within the signal processing time. That is, the selection multiplier 370 selects a digital signal having a longest time interval before conversion. The digital signal having a longest pre-conversion time interval is a digital signal with the highest A/D conversion resolution.

The method of selection of the digital signals in the selection multiplier 370 is the same as the method of selection of the digital signals in the selecting device 23 provided in the endoscope system 30. Also, the effect of the selection multiplier 370 selecting a digital signal having a large slope in the relationship between the analog input signal and the converted time D is also the same. Therefore, a detailed description of the method of selecting the digital signals in the selection multiplier 370 and the effect thereof will be omitted.

In this manner, by the selection multiplier 370 selecting a digital signal having the longest time interval before conversion, a digital signal having a good relationship between the analog input signal and the converted time D can be output to the divider 240. When this is done, the selection multiplier 370 performs multiplication processing with respect to the selected digital signal in accordance with the characteristic (multiplier) at the time of output of the time information by the voltage/time converter 310 and outputs the result to the divider 240. Because the selection multiplier 370 can be configured easily from general logic circuits, a detailed description of the specific circuit constitution will be omitted.

The divider 240 performs pre-established processing with respect to the multiplication-processed digital signal input from the selection multiplier 370, so as to output the ultimate binary digital output signal representing the magnitude of the analog input signal input to the A/D converter 300.

As noted above, by the voltage/time converter 310, the A/D converter 300 generates five types of OUT pulse signals representing the magnitude of the analog input signal that is input and, by the serializer 320, converts to one serial signal, the E/O converter 330 converting to an optical pulse signal and transmitting the signal. That is, in contrast to the A/D converter 200, in which, as shown in FIG. 27, only one type of time information (the first OUT pulse signal in the A/D converter 300) is transmitted, in the A/D converter 300, five types of time information are transmitted. Also, in the A/D converter 300, the O/E converter 350 converts the optical pulse signal to a serial signal, the deserializer 360 returns this to five types of OUT pulse signals, the time/digital converters 230_1 to 230_5 convert to a plurality of digital signals and, the selection multiplier 370 selects a digital signal having a larger slope in the relationship between the analog input signal and the converted time D, and the divider 240 outputs the ultimate binary digital output signal representing the magnitude of the analog input signal. That is, in the A/D converter 300, an ultimate digital output signal is obtained by selecting a digital signal responsive to the time information in which the slope is greatest within the signal processing time. By doing this, in the A/D converter 300, it is possible to greatly improve the resolution of the A/D-converted digital output signal and improve the accuracy of the A/D conversion.

As described above, according to a preferred embodiment of the present invention, it is possible to apply to various systems other than an endoscope system an A/D converter according to the same idea as the A/D converter applied to the endoscope system. That is, an A/D converter having a constitution that converts the magnitude of an analog signal to time information represented by a time length, and converts the time information to a digital signal can be applied to a variety of systems.

In a general system provided with A/D converters, there is a desire to improve the A/D conversion throughput in order to achieve high-speed system processing. Given this, a generally used method for improving the A/D conversion throughput is known as the interleaved method that provides a plurality of A/D converter within a system, in which an analog signal is sampled with the timing of each of the A/D converters offset a bit, the plurality of A/D converters performing A/D conversion processing in parallel, so as to improve the A/D conversion throughput. However, with general A/D converters that directly convert an analog signal to a digital signal, because it is necessary to perform continuous sampling and holding of the analog signal during the A/D conversion time period, when processing is done by the interleaved method, it is necessary to provide each A/D converter with a different sample-and-hold circuit. However, it is difficult to make the characteristics of a plurality of sample-and-hold circuits uniform, and non-uniformities in the characteristics of the sample-and-hold circuits is a cause of a worsening of the A/D conversion accuracy as a system.

Also, when, as in the endoscope system to which an A/D converter is applied in the preferred embodiment of the present invention, the position of the digital signal processing circuit (video processor 16) after the A/D conversion is distant from the analog signal generation source (image capturing unit 11), because the running of the signal lines becomes long, loss when signals are transmitted becomes large. For this reason, in the A/D converter, because emphasis is placed on A/D conversion accuracy, it can be envisioned that the influence of loss at the time of transmitting signals can be reduced by performing A/D conversion close to the analog signal generation source and by transmitting the converted digital signal. However, a digital signal after A/D conversion can thought of as having a high frequency. For this reason, when the digital signal is transmitted over a long distance, there is a risk that EMI, resonances, or the like have an adverse effect on peripheral devices.

In the A/D converter in accordance with a preferred embodiment of the present invention, an analog input signal is converted to time information at a voltage/time converter, and the converted time information is converted to a digital signal at a time/digital converter. That is, time information converted from the magnitude of an analog input signal that is input to a time width (time interval) is transmitted as an electrical pulse signal (OUT pulse signal). In the A/D converter in accordance with a preferred embodiment of the present invention, because the conversion of the magnitude of the analog input signal to time information by the voltage/time converter can be done with relatively simple processing, it is possible to increase the throughput of the processing by the voltage/time converter, and to achieve serial processing. By doing this, in the A/D converter in accordance with a preferred embodiment of the present invention, processing can be done using the interleaved method, in which only the conversion of the OUT pulse signal to a digital signal by a time/digital converter is performed in parallel. Also, because the analog input signal is only required when the voltage/time converter performs conversion to time information, it is not necessary to have a plurality of sample-and-hold circuits, such as when interleaved processing is done using general A/D converters that convert an analog signal directly to a digital signal, thereby avoiding the problem of a worsening of the conversion accuracy of the A/D conversion caused by non-uniformities in the characteristics of the sample-and-hold circuits.

Also, in an A/D converter in accordance with a preferred embodiment of the present invention, because the time width representing the magnitude of an analog input signal that is input is represented by the edge timing or pulse width of the OUT pulse signal, it is possible to suppress the frequency band of the OUT pulse signal. For this reason, in an A/D converter in accordance with a preferred embodiment of the present invention, this enables avoidance of adverse effect on peripheral devices caused by EMI, resonances, or the like, even if the OUT pulse signal is transmitted over a long distance.

While preferred embodiments of the present invention have been described and illustrated above, it should be understood that these are examples of the present invention and are not to be considered as limiting. Additions, omissions, substitutions, and other modifications can be made without departing from the scope of the present invention. Accordingly, the present invention is not to be considered as being limited by the foregoing description, and is only limited by the scope of the claims.

What is claimed is:

1. An endoscope system comprising:
an insertion section that is inserted into an object under examination, having an image capturing unit that successively outputs a pixel signal of a strength responsive to the amount of light of the pixel, and a time converter that converts the intensity of the pixel signal to time information representing a time interval by a time width and that transmits the converted time information;
a transfer section that guides the outside of the object under examination the time information transmitted from the time converter; and
an external apparatus positioned outside the object under examination, having a time interval converter that receives the time information guided by the transfer section and converts to a digital signal and outputs the intensity of the pixel signal represented by the received time information and an image processing unit that outputs an image responsive to the pixel signal that has been converted to the digital signal by the time interval converter.

2. The endoscope system according to claim 1, wherein
the insertion section further comprises a plurality of sample-and-hold circuits that sample and hold the pixel signals output from the image capturing unit and that output the sampled and holed pixel signals,
the time converter comprises a plurality of time converters each corresponding to one of the plurality of sample-and-hold circuits,
each of the plurality of sample-and-hold circuits successively repeats the sampling and holding of the pixel signals successively output from the image capturing unit,
each of the plurality of time converters converts to the time information and transmits intensities of the pixel signals sampled and held by the corresponding sample-and-hold circuit,
the time interval converter is constituted by a plurality of time interval converters each corresponding to one of the plurality of time converters,
each of the plurality of time interval converters converts to a digital signal each of the intensities of the pixel signals from the corresponding time information guided by the transfer section corresponding to one of the plurality of time converters, and
the image processing unit outputs the image based on the pixel signals that are converted to the digital signals by the plurality of time interval converters.

3. The spectroscope according to claim 1, wherein
the time converter converts the intensity of one pixel signal to the plurality of time information represented by different time intervals and transmits the result,
the time interval converter comprises a time interval converter that converts to the digital signals the plurality of time intervals of the one pixel signal represented by each of the time information guided by the transfer section, and further comprises a selecting device that selects and outputs one digital signal from the converted digital signals related to the time intervals for which conversion succeeded within a signal processing time pre-established by the time interval converter.

4. The endoscope system according to claim 3, wherein the selecting device selects a converted digital signal related to the longest one of the time intervals for which conversion succeeded within the pre-established signal processing time.

5. The endoscope system according to claim 1, wherein
the time converter comprises an inverter circuit that inverts and outputs an input signal at a time responsive to the intensity of the pixel signal, and
the input signal represents the intensity of the pixel signal as a time interval, based on the time of a pre-established number of inversions by the inverter circuit.

6. The endoscope system according to claim 5, wherein
the image processing unit divides a given signal by the digital signal converted by the time interval converter.

7. The endoscope system according to claim 6, wherein
the time converter comprises an optical transmitting unit that converts to an optical signal the timing of the start of the time interval and the timing of the end of the time interval included in the time information,
the transfer section comprises an optical waveguide that transfers the optical signal transmitted by the time converter, and
the time interval converter comprises an optical-to-electrical converter that converts the optical signal transferred by the transfer section to an electrical signal.

8. The endoscope system according to claim 7, wherein
the time interval converter comprises:
a timing detection unit that detects the timing of the start of the time interval and the timing of the end of the time interval included in the received time information, and outputs a starting signal representing the detected timing of the start of the time interval and an ending signal representing the detected timing of the end of the time interval;
a clock output unit that comprises a delay circuit and an oscillator and outputs a plurality of clocks of different phases;
a plurality of counting units that count the edges at which a clock output by the clock output unit changes from one state to another state and output the number of counted edges; and
an adder circuit that adds the counted numbers output by each of the counting units and outputs the number of the sum resulting from the addition as the digital signal, wherein
the clock output unit starts output of a plurality of clocks having different phases when a starting signal representing the timing of the start of the time interval is input, and
each of the plurality of counting units corresponds to one of the plurality of clocks having different phases, counts the edges of the corresponding clock up until the input of the ending signal representing the timing of the end of the time interval, and outputs each of the counted numbers.

9. The endoscope system according to claim 8, wherein
the oscillator can change the frequency of the clock that is output in response to an input parameter,
the time interval converter further comprises a parameter adjustment unit that outputs a parameter that controls the frequency of the clock output by the oscillator, and
the parameter adjustment unit, by adjusting the parameter, adjusts the frequency of the clock output by the oscillator and adjusts the timing of the edge of the clock that is output by the clock output unit.

10. The endoscope system according to claim 9, wherein
the parameter adjustment unit comprises:
a plurality of second delay circuits that delay and output an input signal and that are connected in series;
two second oscillators that correspond to each of the two different second delay circuits of the plurality of second delay circuits, and from the time of the input of a delayed operation starting signal representing the start of operation of the parameter adjustment unit, output a clock having a frequency responsive to the input parameter from the corresponding second delay circuit;
a phase comparator circuit that compares the timing of the edges of clocks output by the two second oscillators, and outputs phase comparison information representing a time difference between the timing of the compared edges; and
a parameter setting circuit that, based on the phase comparison information, calculates a parameter controlling the frequency of the clocks output by the second oscillators for the purpose of controlling so that the timing of the edges of the clocks output by the two compared second oscillators coincides, and outputs the calculated parameter as a parameter controlling the frequency of the clocks output by the oscillator and second oscillators.

11. The endoscope system according to claim 8, wherein
the delay circuit that, in response to an input parameter, can change the delay time by which an input signal is delayed,
the time interval converter further comprises a parameter adjustment unit that outputs a parameter that controls a delay time when the delay circuit delays and outputs an input signal, and
the parameter adjustment unit, by adjusting the parameter, adjusts the delay time when the delay circuit delays and outputs an input signal, adjusts the timing of the start of the output of the clock by the oscillator or the timing of the clock that has been output by the oscillator, and adjusts the timing of the edge of a clock output by the clock output unit.

12. The endoscope system according to claim 11, wherein
the parameter adjustment unit comprises:
a plurality of second delay circuits that are connected in series and that delay and output an input signal by a delay time responsive to an input parameter;
two second oscillators that correspond to each of the two different second delay circuits of the plurality of second delay circuits, and from the time of the input of a delayed operation starting signal representing the start of operation of the parameter adjustment unit, output clocks having the same frequency from the corresponding second delay circuit;
a phase comparator circuit that compares the timing of the edges of clocks output by the two second oscillators, and outputs phase comparison information representing a time difference between the timing of the compared edges; and
a parameter setting circuit that, based on the phase comparison information, calculates a parameter controlling the delay time of the second delay circuit for the purpose of controlling so that the timing of the edges of the clocks output by the two compared second oscillators coincide, and outputs the calculated parameter as a parameter controlling the delay circuit and the delay time of the second delay circuit.

13. The endoscope system according to claim 10, wherein
the plurality of second delay circuits connected in series comprise a part of a plurality of delay elements in a ring oscillator constituted by the delay elements connected in a ring configuration.

14. The endoscope system according to claim 13, wherein
the delay circuit and the second delay circuits are buffer circuits in which two inverting (logical negation) circuits having offset threshold voltages are connected in series.

15. The endoscope according to claim 14, wherein
if the buffer circuit is configured with the threshold voltage of the first inverter circuit stage set to be lower than the threshold voltage of the following inverter circuit stage,
the power supply voltage of the following inverter circuit stage is set to be lower than the power supply voltage of the first inverter circuit stage, and
if the buffer circuit is configured with the threshold voltage of the first inverter circuit stage is to be set to be higher than the power supply voltage of the following inverter circuit stage,
the power supply voltage of the first inverter circuit stage is set to be higher than the power supply voltage of the following inverter circuit stage.

16. The endoscope system according to claim 12, wherein
the plurality of second delay circuits connected in series comprise a part of a plurality of delay elements in a ring oscillator constituted by the delay elements connected in a ring configuration.

17. The endoscope system according to claim 16, wherein
the delay circuit and the second delay circuits are buffer circuits in which two inverting (logical negation) circuits having offset threshold voltages are connected in series.

18. The endoscope according to claim 17, wherein
if the buffer circuit is configured with the threshold voltage of the first inverter circuit stage set to be lower than the threshold voltage of the following inverter circuit stage,
the power supply voltage of the following inverter circuit stage is set to be lower than the power supply voltage of the first inverter circuit stage, and
if the buffer circuit is configured with the threshold voltage of the first inverter circuit stage is to be set to be higher than the power supply voltage of the following inverter circuit stage,
the power supply voltage of the first inverter circuit stage is set to be higher than the power supply voltage of the following inverter circuit stage.

19. An A/D converter comprising:
a transmitting unit that has a voltage/time converter converting a magnitude of an analog input signal that has been input to time information representing a time interval by a time width, outputting the results, and transmitting the time information output by the voltage/time converter;
a transfer section that guides the time information transmitted from the transmitting unit to a position distanced from the transmitting unit;
a receiving unit that receives the time information guided by the transfer section, has a time/digital converter converting to a digital signal and outputting the magnitude of the analog input signal represented by the received time information, and outputs the digital signal output by the time/digital converter; and
a signal processing unit that performs a pre-established signal processing with respect to the digital signal output by the receiving unit so as to output as an ultimate digital signal the digital signal on which signal processing has been performed, wherein
the voltage/time converter converts the analog input signal to the time information so that, when taking Vin as the analog input signal and D as the time information to which the analog input signal has been converted, the relationship between the analog input signal Vin and the time information D becomes a first-order rational function relationship represented by the equation:
D=b/(Vin−a)
where a is an arbitrary real number, and b is an arbitrary real number other than 0, and the signal processing unit performs signal processing that divides an arbitrary digital signal other than 0 by the digital signal output by the receiving unit so as to generate a digital signal having a first-order function relationship, and outputs the generated digital signal as the ultimate digital signal.

20. The A/D converter according to claim 19, wherein
the voltage/time converter converts the magnitude of one analog input signal to the plurality of time information represented by different time intervals,
the transmitting unit transmits the plurality of time information converted by the voltage/time converter,
the time/digital converter comprises a time/digital converter that converts to each of the digital signals the plurality of time intervals of one analog input signal represented by the corresponding time information guided by the transmitting unit, and
the receiving unit selects and outputs, from among the plurality of time information, one converted digital signal related to the time information for which the conversion has been completed within a signal processing time pre-established by the time/digital converter.

21. The A/D converter according to claim 20, wherein
the receiving unit selects, among from the time information for which the conversion has been completed within the pre-established signal processing time, a converted digital signal related to the time information representing the longest time interval.

22. The A/D converter according to claim 19, wherein
the voltage/time converter comprises an inverter circuit that inverts and outputs an input signal at a time responsive to the magnitude of the analog input signal, and
the input signal represents the magnitude of the analog input signal as a time interval, based on the time of a pre-established number of inversions by the inverter circuit.

23. The A/D converter according to claim 19, wherein
the transfer section comprises an optical waveguide that transfers the optical signal transmitted by the transmitting unit,
the transmitting unit converts time information that is an electrical signal and transmits the optical signal, and
the receiving unit receives the optical signal transferred by the transfer section and converts the received optical signal to the time information that is an electrical signal once again.
